(19) United States
(12) Patent Application Publication
(10) Pub. No.: US 2025/0025962 A1
(43) Pub. Date: Jan. 23, 2025

(54) Systems and Methods for Laser Fabrication

(71) Applicant: Glowforge, Inc., Seattle, WA (US)

(72) Inventors: Mark Gosselin, Seattle, WA (US); Daniel Shapiro, Seattle, WA (US); Douglas Webster, Seattle, WA (US)

(21) Appl. No.: 18/772,152

(22) Filed: Jul. 13, 2024

Related U.S. Application Data
(60) Provisional application No. 63/513,967, filed on Jul. 17, 2023.

(51) Int. Cl. B23K 26/36; B23K 26/03; B23K 26/08

(52) U.S. Cl. CPC B23K 26/36; B23K 26/032; B23K 26/083

(57) ABSTRACT

Disclosed embodiments include a CNC machine comprising: (i) a laser head; (ii) a housing defining an interior space bounded by an interior floor, interior walls, and an openable lid that has a lid camera assembly with a camera for capturing images of the interior space; (iii) a material bed configured to support material placed within the interior space; (iv) a first material passthrough opening on a first side of the housing, wherein the first material passthrough opening comprises a curtain, wherein the curtain is arranged to block laser light from exiting through the first material passthrough opening while material is inserted through the first material passthrough opening; and (v) an exhaust port configured to route fumes from within the interior space to an air filter separate from the CNC machine.

### CROSS-REFERENCE TO RELATED APPLICATIONS

This application claims priority to U.S. Provisional App. 63/513,967 titled “Systems and Methods of Laser Fabrication,” filed on Jul. 17, 2023, and currently pending. The entire contents of U.S. Provisional App. 63/513,967 are incorporated herein by reference.

### FIELD OF THE DISCLOSURE

The subject matter described herein relates generally to computer-controlled fabrication, including computer numerically controlled (CNC) machines equipped with lasers.

### BACKGROUND

Computer controlled manufacturing systems, such as “3-D printers,” computer numerically controlled milling machines, laser cutter/engravers, and the like, can be used to fabricate complicated objects where traditional manufacturing techniques like moldings or manual assembly fail. Such automated methods operate based on instructions that specify the cuts, engravings, patterns, and other actions to be performed by a CNC machine. The instructions implemented by the CNC machine to process materials can be in the form of computer files transferred to the memory of a computer controller for the CNC machine and interpreted at run-time to provide a series of steps in the manufacturing process.

### SUMMARY

Systems, methods, and articles of manufacture, including apparatuses, are provided for CNC fabrication, including but not limited to CNC machines that use a laser for CNC fabrication, sometimes referred to herein as laser CNC machines. Although many of the embodiments are described with reference to a laser CNC machine, many aspects of the disclosed embodiments are equally applicable to other types of CNC machines that may not necessarily use lasers.

Laser CNC machines according to some embodiments include (i) a laser head that houses a laser used for CNC fabrication, (ii) a housing defining an interior space of the laser CNC machine, wherein the interior space of the laser CNC machine is bounded by an interior floor, interior walls, and an openable lid, wherein the openable lid comprises a lid camera assembly comprising a camera arranged to capture images of the interior space of the laser CNC machine when the openable lid is closed, (iii) a material bed positioned above the interior floor and configured to support material placed within the interior space of the laser CNC machine, (iv) one or more material passthrough openings in the housing, where a first material passthrough opening in the housing is positioned on a first side of the housing, where the first material passthrough opening comprises at least one curtain arranged to block laser light from exiting through the first material passthrough opening while material is inserted through the first material passthrough opening, and (v) an exhaust port configured to route fumes from within the interior space of the laser CNC machine to an air filter separate from the laser CNC machine.

In some embodiments, the laser head includes features not found in prior art laser heads for use with laser CNC machines. For example, in some embodiments, the laser head includes (i) a laser enclosure housing the laser, where the laser enclosure comprises a laser enclosure top, a laser enclosure bottom, and four laser enclosure sides; and (ii) a fan enclosure housing a fan, where the fan enclosure is positioned on top of the laser enclosure top. In some such embodiments, the fan enclosure includes one or more side openings, and the fan is configured to (i) draw air from the one or more side openings of the fan enclosure, and (ii) blow the air downward through the laser enclosure top and into the laser enclosure. By contrast, some prior laser heads typically include fans that are configured to draw air from the top of the fan enclosure (rather than the side) and blow the air downward into the laser enclosure.

Using a fan configured to draw air from the side rather than the top of the fan enclosure enables some embodiments of the fan enclosure to have a solid top rather than an open top as with prior laser head fan enclosures. In some examples, the solid top of the fan enclosure includes one or more fiducial markers sufficient for use with computer vision techniques. In some examples, the laser CNC machine can use one or more cameras positioned inside of the interior space and the one or more fiducials on the top of the laser head to align the laser head and/or track the laser head during operation.

In some examples, if the fan enclosure may not itself have a solid top, a solid plate is placed on top of the fan enclosure. In some such examples, the solid plate on top of the fan enclosure includes the one or more fiducials that can be used to align the laser and/or track the laser head during operation.

Some embodiments of the laser head include a circuit board at least partially enclosed within the laser enclosure. In some such embodiments, one side of the laser enclosure includes an opening arranged to receive a cable that provides power and/or control signaling to the circuit board that is at least partially enclosed within the laser enclosure.

In some embodiments, the cable that provides power and/or control signaling to the circuit board is or at least comprises a flat, flexible cable with a metallic outer covering that covers at least a portion of the flat flexible cable. In some such embodiments, at least a portion of the flat flexible cable is configured to magnetically attach to a magnetic surface on one interior wall of the housing when the laser head moves towards the one interior wall and magnetically detach from the magnetic surface when the laser head moves away from the one interior wall. In some embodiments, to facilitate the magnetic attaching and detaching as the laser head moves toward and away from the interior wall with the magnetic surface, the flat, flexible cable is substantially rigid along a first axis (but flexible along a second axis perpendicular to the first axis) and has one or more pre-configured folds that enable the cable to flex and fold in a predictable and managed way.

Managing cable slack of the flat, flexible cable during operation of the laser CNC machine via the combination of the magnetic surface on the interior wall and the structure of the flat flexible cable (including the rigidity along one axis, the pre-configured fold(s), and the metallic outer covering) in the manner described herein provides improvements over prior approaches by keeping the cable connecting the laser head both (i) out of the way of the laser head as the laser head moves during operation and (ii) above the material bed and away from the material being machined, thereby avoiding both (a) the cable causing accidental movement of the material being machined and (b) the cable being accidentally damaged by the laser.

In some embodiments, the laser within the laser enclosure operates at a wavelength between about 400 to 500 nanometers. Some embodiments include a laser that operates at a wavelength of about 450 nanometers.

In some embodiments, the laser head additionally includes (i) a focusing lens positioned between the laser and the material bed, (ii) one or more depth sensors configured to determine a distance between the one or more depth sensors and the material placed on the material bed within the laser CNC machine, and (iii) a motor configured to move the focusing lens in a manner sufficient to focus laser light emitted from the laser onto the material placed on the material bed based on the distance determined by the one or more depth sensors. Some embodiments of the laser head may additionally include a camera arranged to capture images of, for example, the material placed on the material bed or interior floor of the laser CNC machine.

As mentioned above, the laser CNC machine, according to some embodiments, includes an openable lid. In operation, the lid can be opened so that material to be machined by the laser CNC machine can be placed on the material bed. The lid can be closed before machining the material with the laser. In some embodiments, the openable lid includes a top portion and a side portion extending downward from the top portion, and when the openable lid is closed, the side portion joins at least a portion of one side of the housing to form the interior space of the laser CNC machine. In some embodiments, the openable lid is at least partially formed from or at least includes a transparent material that both (i) passes visible light, thereby allowing a user to see inside the interior space of the laser CNC machine while the openable lid is closed, and (ii) blocks laser light emitted from the laser.

Because the laser can be dangerous while in operation, it is important for the laser CNC machine to keep the laser light emitted from the laser within the interior space of the laser CNC machine. Therefore, in some embodiments, the laser CNC machine is configured to determine whether the lid is properly closed before operating the laser and/or halt operation of the laser upon determining that the lid is not properly closed (e.g., determining that the lid has been opened while a fabrication job is being executed by the laser CNC machine).

In some embodiments, the laser CNC machine is configured to determine whether the openable lid is properly closed based on one or more (or all) of: (i) one or more images of one or more interior wall fiducials captured by the camera of the lid camera assembly, where at least one interior wall of the housing comprises the one or more interior wall fiducials, (ii) one or more measurements from one or more hall sensors on the housing, wherein the one or more hall sensors are arranged to detect one or more corresponding magnets on the openable lid, and/or (iii) one or more accelerometer measurements from a three-axis accelerometer within the lid camera assembly.

In some embodiments, the laser CNC machine is configured to deactivate the laser in response to determining that the openable lid is not properly closed and/or in response to determining that the openable lid has been opened after previously being properly closed. In operation, deactivating the laser may include (i) preventing the laser from starting a fabrication job and/or (ii) halting the operation of the laser during execution of a fabrication job.

As mentioned above, the openable lid in some embodiments includes a lid camera assembly, where the lid camera assembly includes a camera. In some embodiments, the lid camera assembly is connected to a main processor board of the laser CNC machine via a flat flexible cable assembly incorporated into the openable lid of the laser CNC machine. In some embodiments, in addition to the camera, the lid camera assembly further includes one or more (or all) of (i) one or more visible light emitting diodes (LEDs) arranged behind a diffuser, where the one or more visible LEDs are configured to emit visible light and illuminate the interior space of the laser CNC machine, and/or (ii) one or more infrared sensors outside of the diffuser and configured to detect flames within the interior space of the laser CNC machine.

In some embodiments, the diffuser contains one or more patterns (e.g., lines, stripes, circles, or similar patterns) around the lens cap over the camera. These patterns help to produce even light and avoid a bright spot around the camera that could, at least in some instances, affect the quality of the images obtained via the camera. In some instances, the one or more patterns are etched or silkscreened onto the surface of the diffuser.

In some embodiments, the lid camera assembly additionally or alternatively includes one or more ultraviolet light emitting diodes (UV LEDs) configured to emit ultraviolet light and illuminate UV-printed information on materials placed on the material bed within the interior space of the CNC machine. Illuminating the UV-printed information on the materials enables the camera of the lid camera assembly to capture images of the UV-printed information, which can be useful for identifying the material, including, for example, the type of material, a quality or grade of the material, and/or any other information about the material. In some embodiments, the lid camera assembly additionally or alternatively includes (i) one or more temperature sensors for detecting temperature levels within the laser CNC machine and/or (ii) one or more light sensors for detecting light levels within the laser CNC machine.

As mentioned above, laser CNC machines according to disclosed embodiments include a material bed positioned above the interior floor of the laser CNC machine and configured to support material placed within the interior space of the laser CNC machine.

In some embodiments, the material bed includes (i) a primary portion and (ii) at least one secondary portion. In some examples, the primary portion comprises a honeycomb structure stamped from ferritic stainless steel, and the secondary portion comprises a tab structure sufficient to facilitate (i) alignment of the material bed within the interior of the laser CNC machine and (ii) manual removal and replacement of the material bed. In some examples, the honeycomb structure of the material bed is configured to enable at least some laser light that penetrates material positioned on the material bed to pass through the material bed and hit the interior floor of the housing of the laser CNC machine.

As mentioned above, laser CNC machines according to some embodiments also include one or more material passthrough openings in the housing of the laser CNC machine. In some examples, a first material passthrough opening in the housing is positioned on a first side of the housing. In some such embodiments, the first material passthrough opening comprises at least a first curtain arranged to block laser light from exiting through the first material passthrough opening both (i) while material is inserted through the first material passthrough opening and (ii) while no material is inserted through the first material passthrough opening. In some embodiments, the first curtain includes an array of resilient elements. In some examples, the resilient elements comprise silicone fingers.

In some examples, the array of resilient elements is arranged in a plurality of rows of resilient elements, where the resilient elements in each row are staggered relative to the resilient elements in adjacent row(s). In some examples, the array of resilient elements includes resilient elements having different dimensions. In some examples, the array of resilient elements is arranged in a plurality of rows of resilient elements, where the resilient elements include resilient elements having at least two different dimensions, and where the resilient elements in each row are staggered relative to the resilient elements in adjacent row(s).

In some embodiments, the laser CNC machine is additionally configured to pair with an external air filter. Some embodiments additionally include the external air filter. In some examples, the laser CNC machine is configured to pair with the external air filter via a pairing protocol that includes, among other aspects, the laser CNC machine transmitting an air pressure sequence via an exhaust port connected to the external air filter. In some examples, the air pressure sequence includes an exhaust fan at the laser CNC machine turning on and off, and/or perhaps blowing air at high and/or low velocities in a pattern that is detectable by an air flow sensor at the external air filter or some other type of sensor that is sufficient to detect changes in air flow and/or air pressure. In operation, using such an air pressure sequence signaling scheme allows the laser CNC machine and the external air filter to confirm, among other states, that (i) the external air filter is properly connected to the laser CNC machine, and/or (ii) the pairing is occurring between a laser CNC machine and an external air filter that are physically connected to each other.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected to each other and can exchange data and/or commands or other instructions or the like via one or more connections, including, for example, a connection over a network (e.g. the Internet, a wireless wide area network, a local area network, a wide area network, a wired network, or the like), via a direct connection between one or more of the multiple computing systems, and/or the like.

The details of one or more variations of the subject matter described herein are set forth in the accompanying drawings and the description below. Other features and advantages of the subject matter described herein will be apparent from the description and drawings, and from the claims. While certain features of the currently disclosed subject matter may be described for illustrative purposes in relation to performing material edge detection to aid automated manufacturing processes such as a computer numerically controlled fabrication process, it should be readily understood that such features are not intended to be limiting.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations.

FIG. 1A depicts a perspective view of an example of a laser CNC machine consistent with some disclosed embodiments.

FIG. 1B depicts a perspective view of an example of a laser CNC machine with a door that opens to reveal a material passthrough opening in one side of the laser CNC machine according to some disclosed embodiments.

FIG. 1C depicts a top view of an example of a laser CNC machine consistent with some disclosed embodiments.

FIG. 1D depicts an elevational view of an example laser CNC machine consistent with some disclosed embodiments.

FIG. 1E depicts a top view of an example of a laser CNC machine consistent with some disclosed embodiments.

FIG. 2 depicts a system diagram illustrating an example processing system including a laser CNC machine with an externally-connected air filter consistent with some disclosed embodiments.

FIG. 3A depicts an exploded view of an example laser head for use with an example laser CNC machine consistent with some disclosed embodiments.

FIG. 3B shows an example laser head enclosure affixed to a carriage and configured to house a laser head, such as the laser head of FIG. 3A, according to some embodiments.

FIG. 3C shows a perspective view of an example carriage that facilitates movement of a laser head, such as the laser head of FIG. 3A, along a dual rail gantry configuration according to some embodiments.

FIG. 3D shows a side view of the carriage of FIG. 3C according to some embodiments.

FIG. 3E shows the carriage of FIGS. 3C and 3D implemented with a dual rail gantry configuration according to some embodiments.

FIG. 3F shows a front facing view of an individual port on the carriage of FIGS. 3C-E arranged to accommodate one rail of the dual rail gantry configuration according to some embodiments.

FIG. 4 depicts an example fan configuration for use with the example laser head depicted in FIG. 3A.

FIG. 5 depicts aspects of an example laser head with a height measurement assembly consistent with some disclosed embodiments.

FIG. 6A depicts an interior view of an example laser CNC machine with an example flat flexible cable configured to magnetically attach to and detach from a magnetic surface on one interior wall of the housing consistent with some disclosed embodiments.

FIG. 6B depicts an example embodiment of some aspects of the openable lid depicted in FIG. 6A.

FIG. 6C depicts a cutaway top view of the interior of the housing of the example laser CNC machine shown in FIG. 6A, and in particular, the interior of the housing of the laser CNC machine behind the exhaust vent on the rear interior wall of the laser CNC machine according to some embodiments.

FIG. 7A depicts an exploded view of an example lid camera assembly according to some disclosed embodiments.

FIG. 7B depicts aspects of the example lid camera assembly of FIG. 7A according to some disclosed embodiments.

FIG. 8A depicts an interior view of an example laser CNC machine with an example material bed disposed therein according to some disclosed embodiments.

FIG. 8B depicts the example material bed of FIG. 8A removed from the laser CNC machine.

FIG. 9A depicts aspects of an example laser CNC machine with a door that opens to reveal a material passthrough opening in one side of the laser CNC machine according to some disclosed embodiments.

FIG. 9B depicts aspects of the example laser CNC machine of FIG. 9A with the door opened to reveal the material passthrough opening in the side of the laser CNC machine according to some disclosed embodiments.

FIG. 10A depicts an exploded view of an example curtain configured to block laser light from exiting through the example material passthrough opening depicted in FIG. 9B according to some disclosed embodiments.

FIG. 10B depicts an overhead view of a portion of the example curtain depicted in FIG. 10A that shows an example arrangement of resilient members configured to block laser light according to some disclosed embodiments.

FIG. 10C depicts an overhead view of a portion of the example curtain depicted in FIG. 10A that shows an example alternative arrangement of resilient members configured to block laser light according to some disclosed embodiments.

FIG. 11 depicts aspects of an example method performed by a laser CNC machine for pairing the laser CNC machine with an external air filter according to some disclosed embodiments.

FIG. 12 depicts aspects of an example method performed by an external air filter for pairing a laser CNC machine with the external air filter according to some disclosed embodiments.

FIG. 13 depicts a block diagram illustrating a computing system consistent with implementations of the current subject matter.

When practical, similar reference numbers denote similar structures, features, or elements.

### DETAILED DESCRIPTION

Laser CNC machines according to some embodiments disclosed herein include (i) a laser head that houses a laser used for CNC fabrication, (ii) a housing defining an interior space of the laser CNC machine, wherein the interior space of the laser CNC machine is bounded by an interior floor, interior walls, and an openable lid, wherein the openable lid includes a lid camera assembly comprising a camera arranged to capture images of the interior space of the laser CNC machine when the openable lid is closed, (iii) a material bed positioned above the interior floor and configured to support material placed within the interior space of the laser CNC machine, (iv) one or more material passthrough openings in the housing, where a first material passthrough opening in the housing is positioned on a first side of the housing, where the first material passthrough opening comprises at least one curtain arranged to block laser light from exiting through the first material passthrough opening while material is inserted through the first material passthrough opening, and (v) an exhaust port configured to route fumes from within the interior space of the laser CNC machine to an air filter separate from the laser CNC machine. Aspects of these features are described in further detail herein with reference to the figures.

### A. Example Laser CNC Machines and Systems

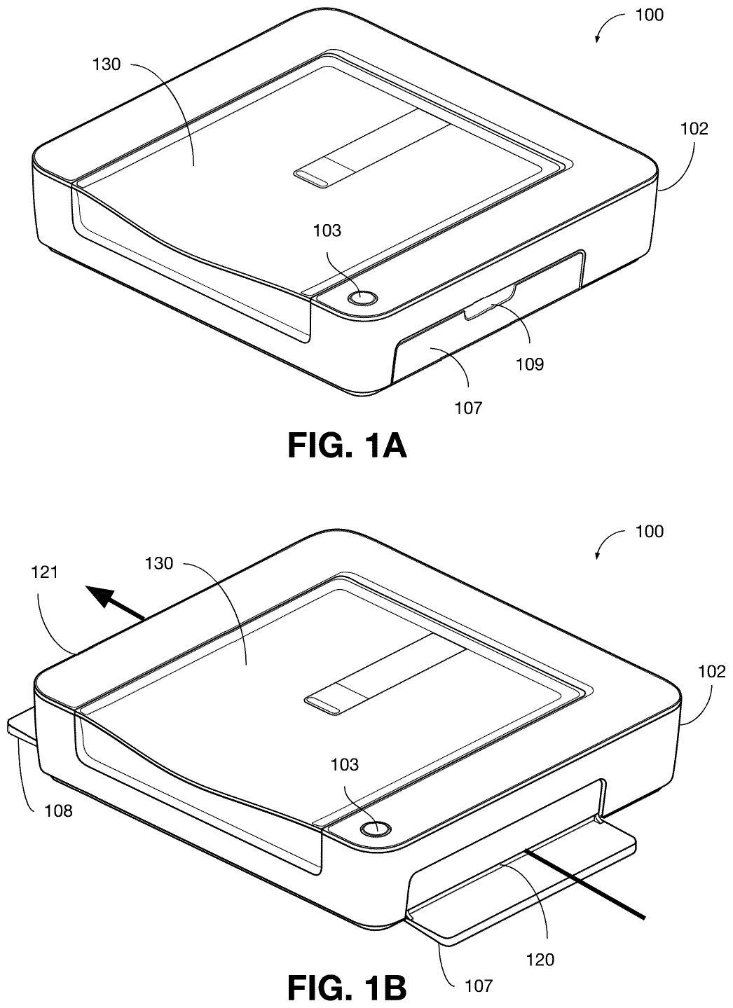

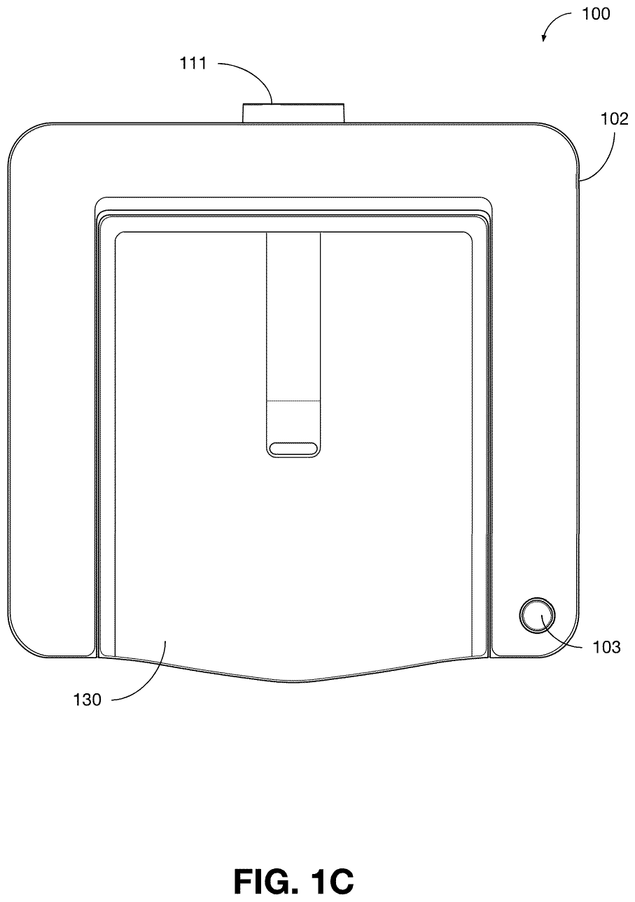

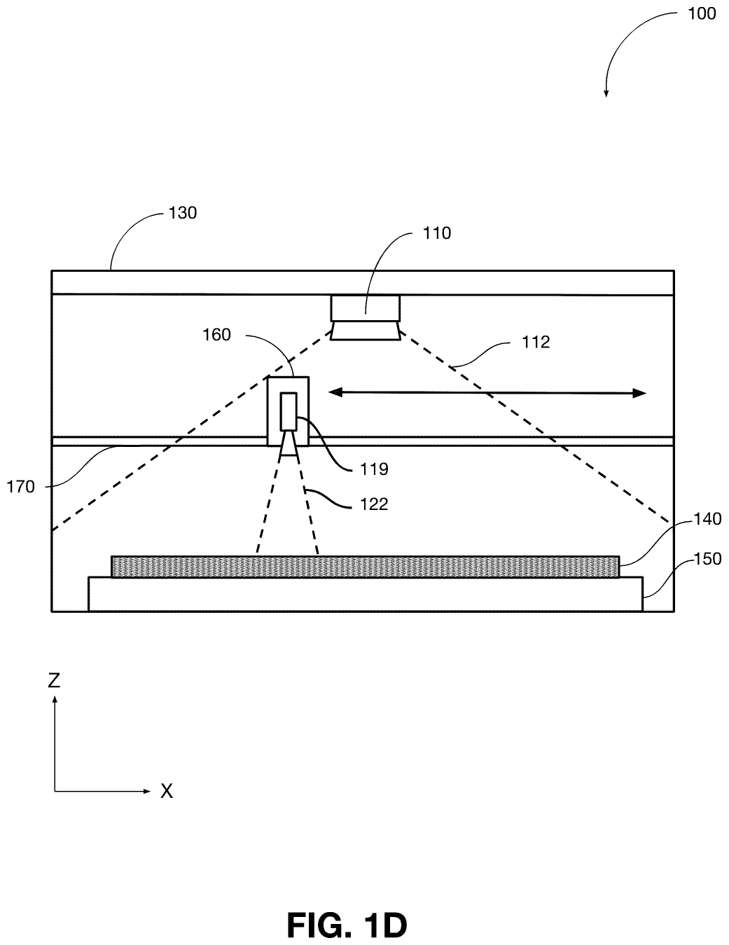

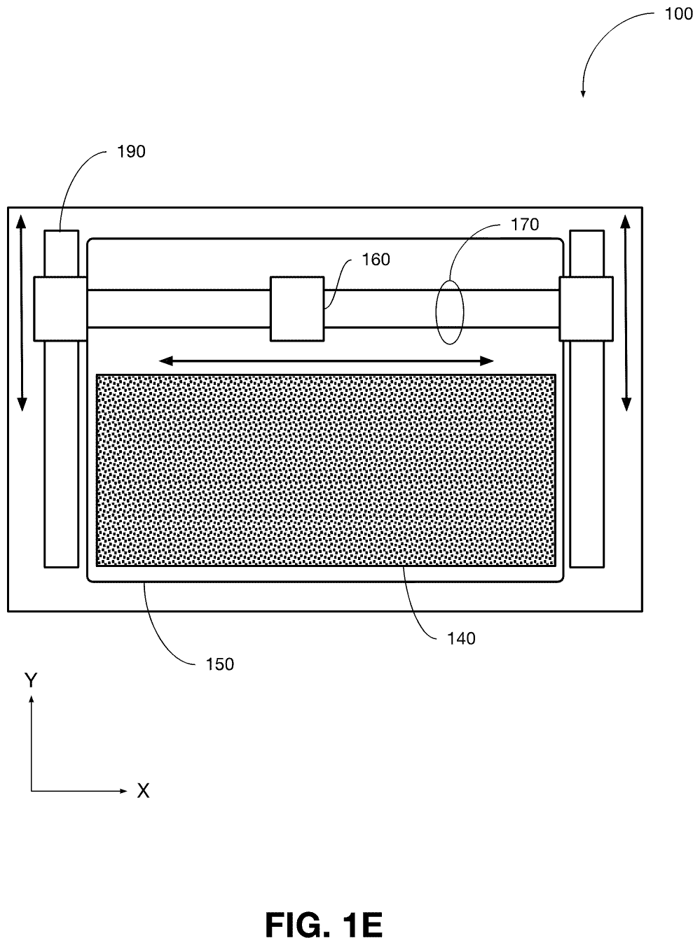

FIG. 1A-1E depict aspects of an example laser CNC machine 100 according to some embodiments.

FIGS. 1A-1B depict a perspective view of an example laser CNC machine 100 consistent with some disclosed embodiments, and FIG. 1C depicts a top view of an example of the laser CNC machine shown in FIGS. 1A-1B. The laser CNC machine 100 includes a housing 102, a lid 130, passthrough doors 107, 108 with finger slots 109 to facilitate opening the passthrough doors 107, 108, passthrough slots 120, 121, user interface button 103, and an exhaust port 111. In some embodiments, the lid 130 is raised for access to the interior space of the laser CNC machine 100 to facilitate placing material inside the laser CNC machine 100 and for access to interior components of the machine. In some embodiments, the passthrough doors 107, 108 and passthrough slot 120, 121 are used to facilitate placing material that is too large to fit through the lid opening. In some embodiments, a portion of the bottom of the housing 102 can be removed such that the laser CNC machine 100 can be placed onto a material that is too large to fit through the lid opening and the passthrough slots. In alternative embodiments, the passthrough doors 107, 108 and passthrough slots 120, 121 are not included in the laser CNC machine 100. Additional aspects of the laser CNC machine 100 are shown in U.S. application Ser. No. 29/870,642, titled “Desktop Fabricator,” filed on Feb. 1, 2023, the entire contents of which are incorporated herein by reference.

FIG. 1D depicts an elevational view of an example laser CNC machine 100 consistent with some disclosed embodiments, and FIG. 1E depicts a top view of an example of the laser CNC machine 100 shown in FIG. 1D consistent with some disclosed embodiments.

The example laser CNC machine 100 shown in FIGS. 1D and 1E includes (i) a first lid camera 110 on the lid 130 of the laser CNC machine 100 and positioned to capture an image of the entire material bed 150 and (ii) a second head camera 119 on the laser head 160 and positioned to capture an image of a portion of the material bed 150. Other example configurations may have more or fewer cameras than the example configuration shown in FIGS. 1D and 1E. For example, in some embodiments, the laser CNC machine 100 may include the lid camera 110 on the lid 130 but not the head camera 119 on the laser head 160. In other embodiments, the laser CNC machine 100 may alternatively include the head camera 119 on the laser head 160 but not the lid camera 110 on the lid 130. In yet other embodiments, the laser CNC machine 100 may include a camera affixed to an internal wall of the housing 102.

In operation, the laser CNC machine 100 uses a laser to perform various forms of subtractive processing including, for example, cutting, engraving, and/or the like. While some features are described herein in the context of a laser CNC machine, this is by no means intended to be limiting. Many of the features described below can be implemented with other types of CNC machines.

Laser CNC machines are subject to particularly challenging design constraints. For example, a laser CNC machine is subject to regulatory guidelines that restrict the egress of electromagnetic energy from the unit when operating, making it challenging for light to enter or escape the unit safely, for example to view or record an image of the material being processed by the laser CNC machine. The beam of the laser CNC machine must be routed from the laser emitter to the area to be processed, potentially requiring a series of optical elements such as lenses and mirrors. The beam of the laser CNC machine is easily misdirected, with a small angular deflection of any component relating to the beam path potentially resulting in the beam escaping the intended path, potentially with undesirable consequences. A laser beam may be capable of causing material destruction if uncontrolled. Further, a laser CNC machine may require high voltage and/or radio frequency power supplies to drive the laser itself.

Liquid cooling is common in laser CNC machines to cool the laser, requiring fluid flow considerations. Airflow is important in laser CNC machine designs, as air may become contaminated with byproducts of the laser's interaction with the material such as smoke, which may in turn damage portions of the machine, for example, by fouling optical systems that are used both for focusing and controlling the laser and monitoring the status of fabrication jobs.

The air exhausted from the laser CNC machine may contain undesirable byproducts such as, for example, smoke that must be routed or filtered. In some instances, the laser CNC machine may need to be designed to prevent such byproducts from escaping through an unintended opening, for example by sealing components that may be opened. Unlike most machining tools, the kerf—the amount of material removed during the operation—is both small and variable depending on the material being processed, the power of the laser, the speed of the laser, and other factors, making it difficult to predict the final size of the object.

Also, unlike many other machining tools, the output of the laser CNC machine can be very highly dependent on the speed of operation; a momentary slowing can destroy the workpiece by depositing too much laser energy. In many machining tools, operating parameters such as tool rotational speed and volume of material removed are easy to continuously predict, measure, and calculate, while laser CNC machines are more sensitive to material and other conditions. In many machining tools, fluids are used as coolant and lubricant; in laser CNC machines, the cutting mechanism does not require physical contact with the material being effected, and air or other gasses may be used to aid the cutting process in a different manner, by facilitating combustion or clearing debris, for example.

Referring again to FIGS. 1A-1E, the example laser CNC machine 100 includes a housing 102 surrounding an enclosure or interior area defined by the housing. The housing 102 includes walls, a bottom, and one or more openings to allow access to an interior space of the laser CNC machine 100. The laser CNC machine 100 additionally includes a material bed 150 that is disposed at least partially within the interior space of the housing of the laser CNC machine 100. In operation, the material bed 150 includes a top surface on which the material 140 to be machined generally rests.

In some embodiments, at least a portion of the housing is formed from injection-molded plastic. However, other suitable materials could be used for the housing that are (i) opaque, to help prevent laser light from existing the interior of the housing, (ii) flame retardant, to help prevent the housing from catching on fire from laser light and/or heat generated by the laser, and (iii) ultraviolet light resistant, to help prevent damage to the housing from ultra-violet laser light.

The example laser CNC machine 100 additionally includes an openable barrier as part of the housing to allow access between an exterior of the laser CNC machine 100 and an interior space of the laser CNC machine 100. The openable barrier can include, for example, one or more doors, hatches, flaps, lids, and the like that can actuate between an open position and a closed position. The openable barrier can attenuate the transmission of light between the interior space and the exterior when in the closed position. Optionally, the openable barrier can be transparent to one or more wavelengths of light or be comprised of portions of varying light attenuation ability. The example laser CNC machine 100 depicted in FIGS. 1A-1E includes at least one openable barrier in the form of a lid 130 that can be opened so that material 140 can be placed on the material bed 150 on the bottom of the enclosure, and then closed while the laser CNC machine 100 is machining the material 140 with the laser. Additionally, as shown in FIGS. 1A, 1B, the laser CNC machine 100 includes two passthrough doors 107, 108 that can be opened so that the material 140 (e.g., material 140 that is too large to fit through the lid 130) can be slid into the laser CNC machine 100 (e.g., through passthrough slot 120), onto the material bed 150 on the bottom of the enclosure, and out of the laser CNC machine 100 (e.g., through passthrough slot 121).

Various example implementations discussed herein refer to a lid or an openable lid and door or passthrough door. It will be understood that absent explicit disclaimers of other possible configurations of the operable barrier or some other reason why a lid cannot be interpreted generically to mean any kind of openable barrier, the use of the term lid is not intended to be limiting. One example of an openable barrier can be a front door that is normally vertical when in the closed position and can open horizontally or vertically to allow additional access. There can also be vents, ducts, or other access points to the interior space or to components of the laser CNC machine 100. These access points can be for access to power, air, water, data, etc. Any of these access points can be monitored by cameras, position sensors, switches, etc. If they are accessed unexpectedly, the laser CNC machine 100 can execute actions to maintain the safety of the user and the system, for example, a controlled shutdown. In some implementations, the laser CNC machine 100 can be completely open (i.e., not having a lid 130, or walls). Any of the features described herein can also be present in an open configuration, where applicable.

The laser CNC machine 100 can have one or more heads including, for example, the laser head 160, which can be operated to focus a laser onto the material 140 resting on the material bed 150. In operation, the laser head 160 is configured to steer a beam of electromagnetic energy to a desired location on the material 140 resting on the material bed 150. For instance, the laser head 160 may be mobile including by translating and/or rotating to locate a beam of electromagnetic energy from a source configured to generate and/or emit the electromagnetic energy. Alternatively, the laser head 160 may be stationary and the beam of electromagnetic energy may be located by translating and/or rotating one or more optical components configured to route the electromagnetic energy from the laser head 160. It should be appreciated that the laser CNC machine 100 may include multiple heads that operate independently or in unison to locate the beam of electromagnetic energy.

In some implementations of the current subject matter, the laser head 160 can be configured to include a combination of optical, electronic, and/or mechanical components that can, in response to commands, cause a laser beam or electromagnetic energy to be delivered to cut, score, or engrave the material 140. As used herein, a cut is created when the electromagnetic energy cuts through the material 140 whereas a score is created when the electromagnetic energy effects a shallow line that penetrates the material 140 to a certain depth but does not cut through the material 140. The source (e.g., an emitter and/or the like) generating the electromagnetic energy may be part of the laser head 160 or separate from the laser head 160. The laser CNC machine 100 can also execute operation of a motion plan for causing movement of the laser head 160 in implementations where the laser head 160 is configured to be mobile.

In some example embodiments, the laser CNC machine 100 may accept a user drawing, acting as a source file that describes the designs the user wants to create or the cuts that a user wishes to make. Examples of source files include .STL files that define a three-dimensional object that can be fabricated with a 3D printer or carved with a milling machine, .SVG files that define a set of vector shapes that can be used to cut or draw on material, .JPG files that define a bitmap that can be engraved on a surface, and CAD files or other drawing files that can be interpreted to describe the object or operations. Other examples of source files include PDF files, DXF files, and/or the like.

A source file may be converted into a machine file (e.g., by a computer program and/or the like) that can be interpreted by the laser CNC machine 100 to take certain actions. The machine file may describe the idealized motion of the laser CNC machine 100 to achieve a desired outcome. As one example, if the source file specifies a rectangle, then the machine file can instruct the laser CNC machine 100 to translate the laser head 160 (and/or one or more optical elements) to deliver the electromagnetic energy to effect the rectangle in the material 140. The machine file can omit some information (e.g., the dimensions of the rectangle and/or the like) and/or add information (e.g., an instruction to move the laser head 160 from its home position to a corner of the rectangle to begin fabrication). The instructions can even depart from the directly expressed intent of the user.

Once the machine file has been created, a motion plan for the laser CNC machine 100 can be generated. As used herein, a “motion plan” may contain the data that determines the actions of components of the laser CNC machine 100 at different points in time. The motion plan may be generated on the laser CNC machine 100 itself or at least partially on another computing system. The motion plan may include a stream of data that describes, for example, electrical pulses that indicate exactly how motors should turn, a voltage that indicates the desired output power of a laser, a pulse train that specifies the rotational speed of a mill bit, etc. Unlike the source files and the machine files such as G-code, the motion plan may be defined by the presence of a temporal element, either explicit or inferred, indicating the time or time offset at which each action should occur. This allows for one of the key functions of a motion plan, coordinated motion, wherein multiple actuators coordinate to have a single, pre-planned affect.

The motion plan renders the abstract, idealized machine file as a practical series of electrical and mechanical tasks. For example, a machine file might include the instruction to “move one inch to the right at a maximum speed of one inch per second, while maintaining a constant number of revolutions per second of a cutting tool.” The motion plan may therefore take into consideration that the motors cannot accelerate instantly, and instead must “spin up” at the start of motion and “spin down” at the end of motion. The motion plan would then specify pulses (e.g., sent to stepper motors or other apparatus for moving the head or other parts of laser CNC machine 100) occurring slowly at first, then faster, then more slowly again near the end of the motion.

The machine file is converted to the motion plan by the motion controller/planner. Physically, the motion controller can be a general or special purpose computing device, such as a high-performance microcontroller or single board computer coupled to a Digital Signal Processor (DSP). The job of the motion controller is to take the vector machine code and convert it into electrical signals that will be used to drive the motors on the laser CNC machine 100, taking into account the exact state of the laser CNC machine 100 at that moment and physical limitations of the machine. The signals can be step and direction pulses fed to stepper motors or location signals fed to servomotors among other possibilities, which create the motion and actions of the laser CNC machine 100, including the operation of elements like actuation of the laser head 160, moderation of heating and cooling, and other operations. In some embodiments, a compressed file of electrical signals can be decompressed and then directly output to the motors. These electrical signals can include binary instructions similar to 1's and 0's to indicate the electrical power that is applied to each input of each motor over time to effect the desired motion.

In some embodiments, the motion plan may take into account the detailed physics of the laser CNC machine 100 itself, and translates the idealized machine file into implementable steps. For example, a particular laser CNC machine 100 might have a heavier head, and require more gradual acceleration. This limitation is modeled in the motion planner and affects the motion plan. Different models of the laser CNC machine 100 may require precise tuning of the motion plan based on its measured attributes (e.g., motor torque) and observed behavior (e.g. belt skips when accelerating too quickly). The laser CNC machine 100 can also tune the motion plan on a per-machine basis to account for variations from machine to machine.

The motion plan can be generated and fed to the output devices in real-time, or nearly so. The motion plan can also be pre-computed and written to a file instead of streamed to the laser CNC machine 100, and then read back from the file and transmitted to the laser CNC machine 100 at a later time. Transmission of instructions to the laser CNC machine 100, for example, portions of the machine file or motion plan, can be streamed as a whole or in batches from the computing system storing the motion plan. Batches can be stored and managed separately, allowing pre-computation or additional optimization to be performed on only part of the motion plan. In some implementations, a file of electrical signals, which may be compressed to preserve space and decompressed to facilitate use, can be directly output to the motors. The electrical signals can include binary instructions similar to 1's and 0's to indicate actuation of the motor.

Electromagnetic energy effecting one or more changes in the material 140 that is at least partially contained within the interior space of the laser CNC machine 100 may therefore be delivered by moving the laser head 160. In one implementation, the position and orientation of the optical elements inside the laser head 160 can be varied to adjust the position, angle, or focal point of a laser beam. For example, mirrors can be shifted or rotated, lenses translated, etc. The laser head 160 can be mounted on a translation rail or joining assembly 170 such as, for example, the joining assembly consisting of a fixed shaft and drive shaft described in U.S. application Ser. No. 17/511,000, titled “Mechanical System For High Positional Computer Numerically Controlled Applications,” filed on Oct. 26, 2021, and published as U.S. Pub. 2023/0128807 on Apr. 27, 2023, which is incorporated by reference in its entirety, that is used to move the laser head 160 throughout the enclosure. In some implementations the motion of the laser head 160 can be linear, for example on an x-axis, a y-axis, or a z-axis. In other implementations, the laser head 160 can combine motions along any combination of directions in a rectilinear, cylindrical, or spherical coordinate system.

A working area for the laser CNC machine 100 can be defined by the limits within which the laser head 160, whether stationary or mobile, can cause delivery of a machining action, or delivery of a machining medium, for example electromagnetic energy. The working area can be inside the interior space defined by the housing of the laser CNC machine 100. It should be understood that the working area can be a generally three-dimensional volume and not a fixed surface. For example, if the range of travel of a vertically oriented laser cutter is a 10″×10″ square entirely over the material bed 150, and the laser from the laser beam comes out of the laser cutter at a height of 4″ above the material bed of the laser CNC machine, that 400 in³ volume can be considered to be the working area.

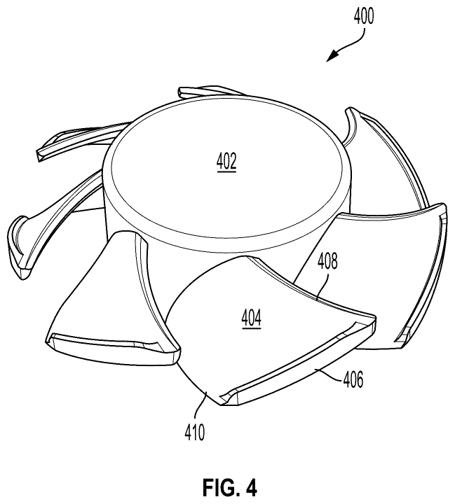

The working area can be defined by the extents of positions in which material 140 can be worked by the laser CNC machine 100. As such, the boundaries of the working area may not necessarily be defined or limited by the range of travel of any one component. For example, if the laser head 160 could turn at an angle (e.g., using an angle adapter as shown in FIG. 4C in U.S. application Ser. No. 17/511,000, which is incorporated by reference in its entirety), then the working area could extend in some direction beyond the travel of the laser head 160. By this definition, the working area can also include any surface, or portion thereof, of any material 140 placed in the laser CNC machine 100 that is at least partially within the working area, if that surface can be worked by the laser CNC machine 100. Similarly, for oversized material, which may extend even outside the laser CNC machine 100 (e.g., extend outside through one or more passthrough slots 120, 121), only part of the material 140 might be in the working area at any one time.

The joining assembly 170 can be any sort of translating mechanism that enables movement of the laser head 160 in the X-Y direction, for example a single rail with a motor that slides the laser head 160 along the joining assembly 170, a combination of two rails that move the laser head 160, a combination of circular plates and rails, a robotic arm with joints, etc.

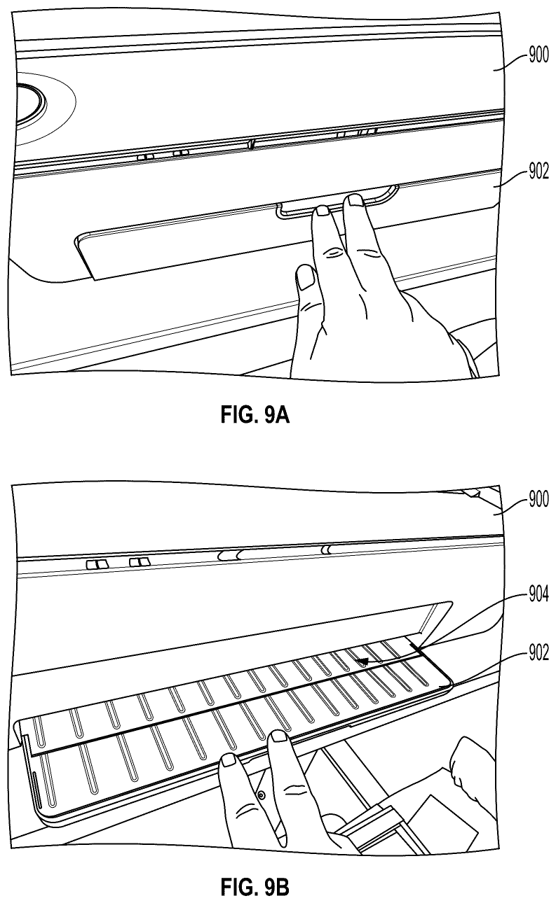

Components of the laser CNC machine 100 can be substantially enclosed in a housing 102 such as a case or other enclosure. The housing 102 can include, for example, windows, apertures, flanges, footings, vents, etc. The housing 102 can also contain, for example, the laser head 160, optical turning systems, cameras 110, 119, the material bed 150, etc. To manufacture the housing 102, or any of its constituent parts, an injection-molding process can be performed. The injection-molding process can be performed to create a rigid case in a number of designs. The injection molding process may utilize materials with useful properties, such as strengthening additives that enable the injection molded case to retain its shape when heated, or absorptive or reflective elements, coated on the surface or dispersed throughout the material for example, that dissipate or shield the case from laser energy. As an example, one design for the housing 102 can include a horizontal slot in the front of the case and a corresponding horizontal slot in the rear of the case. In another example (e.g., in FIG. 1B), the case can include a horizontal slot on one side of the case (e.g., passthrough slot 120) and a corresponding horizontal slot on the other side of the case (e.g., passthrough slot 121). These slots can allow oversized material to be passed through the laser CNC machine 100. These slots, sometimes referred to as material passthrough openings, are shown and described further with reference to FIGS. 1B, 9A and 9B.

Some embodiments additionally include an interlock system that interfaces with, for example, the openable barrier, such as the openable lid 130 or other openable barrier(s). Interlocks are required by many regulatory regimes under certain circumstances. In operation, the interlock can detect a state of opening of the openable barrier, for example, whether the openable lid 130 is open or closed. In some implementations, an interlock can prevent (or enable) some or all functions of the laser CNC machine 100 while an openable barrier, such as the openable lid 130, is in the open state (e.g., not in a closed state).

The reverse can be true as well, meaning that some functions of the laser CNC machine 100 can be prevented (or enabled) while in a closed state. There can also be interlocks in series where, for example, the laser CNC machine 100 will not operate unless both the openable lid 130 and the front door are both closed. In some examples, the detection of a change in state of the interlock (e.g., the interlock moving from an open to a closed state or vice-versa) may trigger certain operations within the laser CNC machine 100. For example, upon detection that the interlock is moving from an open state to a closed state, a procedure (e.g., calibration procedure, material edge detection procedure, etc.) of the laser CNC machine may be initiated. Furthermore, some components of the laser CNC machine 100 can be tied to states of other components of the laser CNC machine, such as not allowing the openable lid 130 to open while the laser is on, a movable component moving, a motor running, sensors detecting a certain gas, and/or the like. The interlock can prevent emission of electromagnetic energy from the laser head 160 when detecting that the openable lid 130 is not in the closed position.

Some embodiments include one or more cameras mounted inside the laser CNC machine 100 to acquire image data during operation of the laser CNC machine 100. Image data refers to all data gathered from a camera or image sensor, including still images, streams of images, video, audio, metadata such as shutter speed and aperture settings, settings or data from or pertaining to a flash or other auxiliary information, graphic overlays of data superimposed upon the image such as GPS coordinates, in any format, including but not limited to raw sensor data such as a .DNG file, processed image data such as a .JPG file, and data resulting from the analysis of image data processed on the camera unit such as direction and velocity from an optical mouse sensor. For example, there can be one or more cameras mounted such that they gather image data (also referred to as ‘view’ or ‘image’) from an interior portion of the laser CNC machine 100.

The viewing can occur when the openable lid 130 is in a closed position or in an open position or independently of the position of the openable lid 130. In one implementation, one or more cameras, for example a camera mounted to the interior surface of the openable lid 130 or elsewhere within the case or enclosure, can view the interior portion when the openable lid 130 to the laser CNC machine 100 is in a closed position. In particular, in some embodiments, the one or more cameras can image the material 140 while the laser CNC machine 100 is closed and, for example, while machining the material 140.

In some implementations, one or more cameras can be mounted within the interior space and opposite the working area. In other implementations, there can be one or more cameras attached to the openable lid 130 (e.g., lid camera 110 on lid 130 as shown in FIG. 1D). One or more cameras can also be capable of motion such as translation to a plurality of positions, rotation, and/or tilting along one or more axes. One or more cameras mounted to a translatable support, which can be any mechanical system that can be commanded to move (movement being understood to include rotation) the one or more cameras or a mechanism such as a mirror that can redirect the view of the one or more cameras, to different locations and view different regions of the laser CNC machine. The laser head 160 is a special case of the translatable support, where the laser head 160 is limited by the track 190 and the joining assembly 170 that constrain its motion.

Lenses can be chosen for wide angle coverage, for extreme depth of field so that both near and far objects may be in focus, or many other considerations. The one or more cameras may be placed to additionally capture the user so as to document the building process, or placed in a location where the user can move the camera, for example on the underside of the openable lid 130 where opening the laser CNC machine 100 causes the lid camera 110 to point at the user. Here, for example, the single lid camera 110 described above can take an image when the lid 130 is not in the closed position. Such an image can include an object, such as a user, that is outside the laser CNC machine 100. One or more cameras can additionally or alternatively be mounted on movable locations like the laser head 160 or openable lid 130 with the intention of using video or multiple still images taken while the one or more cameras are moving to assemble a larger image, for example scanning the one or more cameras across the material 140 to get an image of the material 140 in its totality so that the analysis of image data may span more than one image.

As shown in FIG. 1D, a lid camera 110, or multiple lid cameras, can be mounted to the openable lid 130. In particular, as shown in FIG. 1D, the lid camera 110 can be mounted to the underside of the openable lid 130. The lid camera 110 can be a camera with a wide field of view 112 that can image a first portion of the material 140. This can include a large fraction of the material 140 and the material bed 150 or even all of the material 140 and material bed 150. The lid camera 110 can also image the position of the laser head 160, if the laser head 160 is within the field of view of the lid camera 110.

Mounting the lid camera 110 on the underside of the openable lid 130 allows for the user to be in view when the openable lid 130 is open. This can, for example, provide images of the user loading or unloading the material 140, or retrieving a finished project. Here, a number of sub-images, possibly acquired at a number of different locations, can be assembled, potentially along with other data like a source file such as an SVG or digitally rendered text, to provide a final image. When the openable lid 130 is closed, the lid camera 110 rotates down with the lid 130 and brings the material 140 into view.

Also as shown in FIG. 1D, some embodiments include a head camera 119, or multiple head cameras, mounted to the laser head 160. In some examples, the head camera 119 can have a narrower field of view 122 and take higher resolution images of a smaller area, of the material 140 and the material bed, than the lid camera 110. One use of the head camera 119 can be to image the cut made in the material 140. In some circumstances, the head camera 119 can identify the location of the material 140 more precisely than possible with the lid camera 110.

Other locations for cameras can include, for example, on an optical system guiding a laser for laser cutting, on the laser itself, inside a housing surrounding the laser head 160, underneath or inside of the material bed 150, in an air filter or associated ducting, etc. Cameras can also be mounted outside the laser CNC machine 100 to view users or view external features of the laser CNC machine 100.

Multiple cameras can also work in concert to provide a view of an object or material 140 from multiple locations, angles, resolutions, etc. For example, the lid camera 110 can identify the approximate location of a feature in the laser CNC machine 100. The laser CNC machine 100 can then instruct the laser head 160 to move to that location so that the head camera 119 can image the feature in more detail.

While the examples herein are primarily drawn to a laser CNC machine, the use of the cameras for machine vision in this application is not limited to only that specific type of CNC machine 100. For example, if the CNC machine were a lathe, a lid camera 110 can be mounted nearby to view the rotating material 140 and the head, and the head camera located near the cutting tool. Similarly, if the CNC machine were a 3D printer, the head camera can be mounted on the head that deposits material for forming the desired piece.

In some embodiments, an image recognition program can identify conditions in the interior portion of the laser CNC machine 100 from the acquired image data. The conditions that can be identified include positions and properties of the material 140, the positions of components of the laser CNC machine 100, errors in operation, etc. Based in part on the acquired image data, instructions for the laser CNC machine 100 can be created or updated. The instructions can, for example, act to counteract or mitigate an undesirable condition identified from the image data. The instructions can include changing the output of the laser head 160. For example, the laser can be instructed to reduce or increase power or turn off. Also, the updated instructions can include different parameters for motion plan calculation, or making changes to an existing motion plan, which could change the motion of the laser head 160 or the gantry 180.

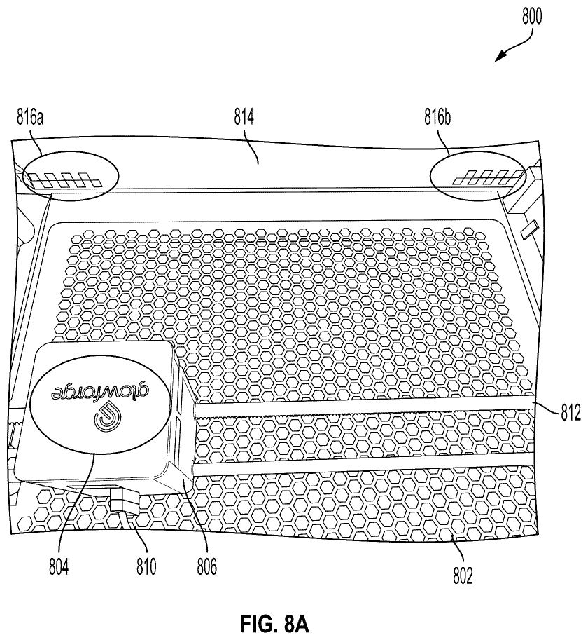

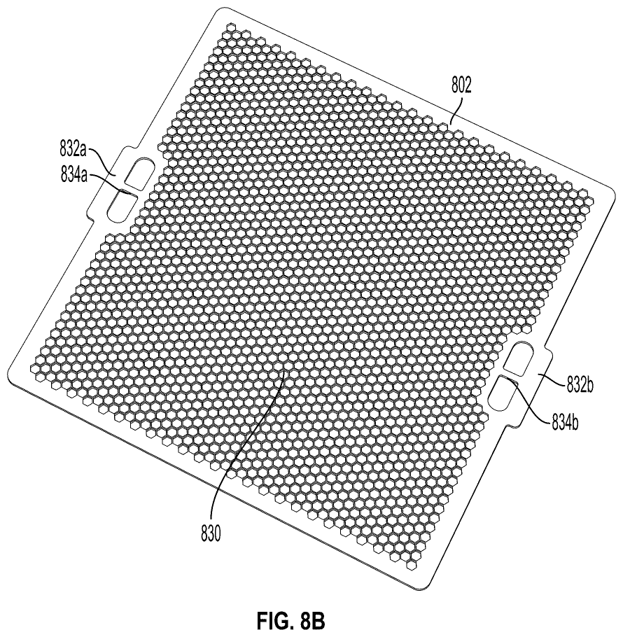

For example, if the image indicates that a recent cut was offset from its desired location by a certain amount, for example due to a part moving out of alignment, the motion plan can be calculated with an equal and opposite offset to counteract the problem, for example for a second subsequent operation or for all future operations. The laser CNC machine 100 can execute the instructions to create the motion plan or otherwise effect the changes described above. In some implementations, the movable component can be the laser head 160, a moveable gantry, and/or the like. In some examples, an identifiable mark may be disposed on the moveable component to facilitate tracking changes in the position of the moveable component. For example, as shown in FIG. 8A, the fiducial marker 804 placed at the top of the laser head 806 may be used for such tracking information. The image data can update software controlling operation of the laser CNC machine 100 with a position of the laser head 160 and/or a movable gantry with their position and/or any higher order derivative thereof.

Because the type of image data required can vary, and/or because of possible limitations as to the field of view of any individual camera, some embodiments include multiple cameras placed throughout the laser CNC machine 100 to provide the needed image data. Camera choice and placement can be optimized for many use cases. Cameras closer to the material 140 can be used for detail at the expense of a wide field of view. Multiple cameras may be placed adjacently so that images produced by the multiple cameras can be analyzed by a computer (or computing system) to achieve higher resolution or wider coverage jointly than was possible for any image individually. Alternatively, and/or additionally, images produced by multiple cameras may be used for stereovision, which is a process that includes comparing features found in two or more images to determine the distance between the cameras and the feature. Stereovision may be one example of a technique used to determine the height (or thickness) of the material 140 at various locations across the material 140.

Some embodiments include multipoint distortion correction techniques implemented via such a stereovision technique (or aspects thereof) in connection with measuring the height (or thickness) of the material above the material bed. Aspects of multipoint distortion correction are disclosed and described in U.S. Provisional App. 63/299,460, titled “Multipoint Distortion Correction,” filed on Jan. 14, 2022, and now expired. Additional aspects of multipoint distortion correction are described in U.S. application Ser. No. 18/155,049, titled “Height Measurement Techniques and Uses Thereof,” filed on Jan. 16, 2023, and currently pending. The entire contents of Apps. 63/299,460 and Ser. No. 18/155,049 are incorporated herein by reference.

The manipulation and improvement of images can include, for example, stitching of images to create a larger image, adding images to increase brightness, differencing images to isolate changes (such as moving objects or changing lighting), multiplying or dividing images, averaging images, rotating images, scaling images, sharpening images, and so on, in any combination. Further, the system may record additional data to assist in the manipulation and improvement of images, such as recordings from ambient light sensors and location of movable components. Specifically, stitching can include taking one or more sub-images from one or more cameras and combining them to form a larger image. Some portions of the images can overlap as a result of the stitching process. Other images may need to be rotated, trimmed, or otherwise manipulated to provide a consistent and seamless larger image as a result of the stitching. Lighting artifacts such as glare, reflection, and the like, can be reduced or eliminated by any of the above methods.

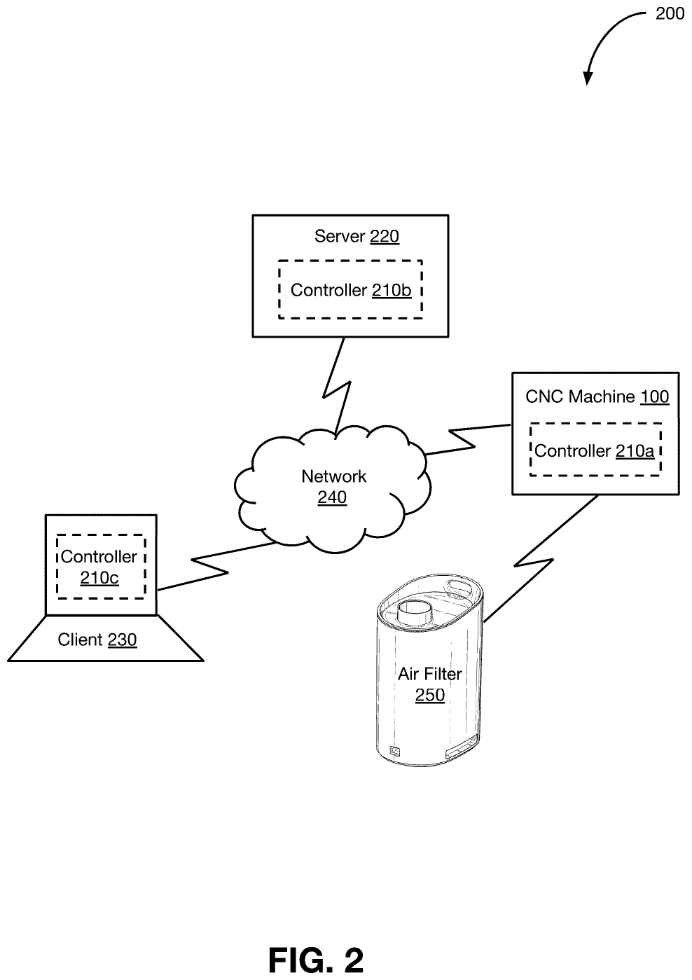

In some embodiments, the laser CNC machine 100 may be part of a CNC processing system. To further illustrate, FIG. 2 depicts a system diagram illustrating an example CNC processing system 200 including a laser CNC machine 100 with an externally-connected air filter 250 consistent with some disclosed embodiments. Some embodiments may not include the external air filter 250.

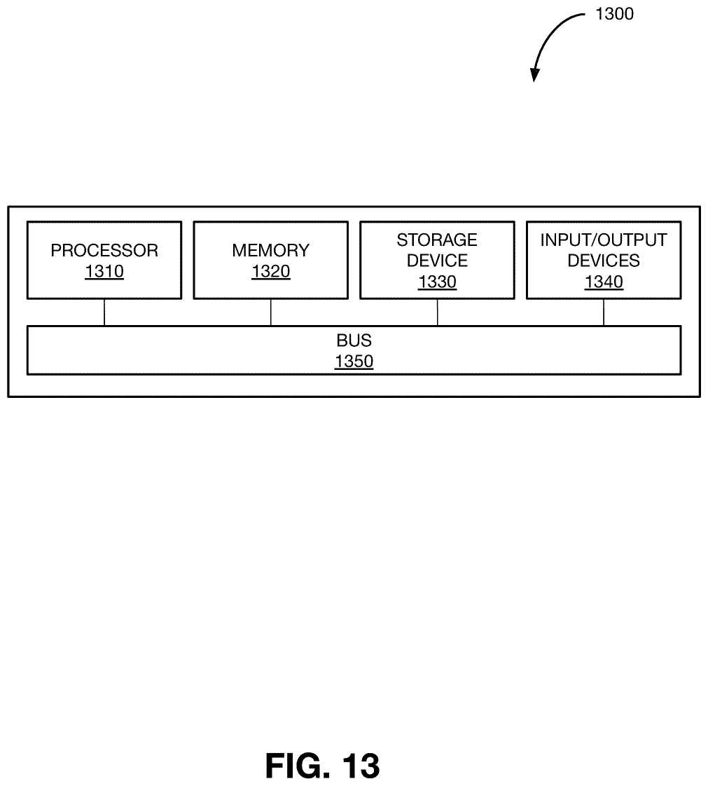

As shown in FIG. 2, the example CNC processing system 200 includes the laser CNC machine 100 and a controller 210 configured to control the operations of the laser CNC machine 100. In some embodiments, the controller is implemented as a computing system, such as the computing system shown and described with reference to FIG. 13.

For example, FIG. 13 depicts a block diagram illustrating a computing system 1300, consistent with implementations of the current subject matter. The computing system 1300 may implement the controller at the controller 210 and/or any components therein.

As shown in FIG. 13, the computing system 1300 can include a processor 1310, a memory 1320, a storage device 1330, an input/output device 1340, and a system bus 1350. The processor 1310, the memory 1320, the storage device 1330, and the input/output device 1340 can be interconnected via the system bus 1350. The processor 1310 is capable of processing instructions for execution within the computing system 1300. Such executed instructions can implement one or more components of, for example, the controller 210. In some implementations of the current subject matter, the processor 1310 can be a single-threaded processor. Alternatively, the processor 1310 can be a multi-threaded processor. The processor 1310 is capable of processing instructions stored in the memory 1320 and/or on the storage device 1330 to control at least some of the operations of the laser CNC machine 100.

The memory 1320 is a computer readable medium such as volatile or non-volatile that stores information within the computing system 1300. The memory 1320 can store data structures representing configuration object databases, for example. The storage device 1330 is capable of providing persistent storage for the computing system 1300. The storage device 1330 can be a solid-state drive, a floppy disk device, a hard disk device, an optical disk device, or a tape device, or other suitable persistent storage means. The input/output device 1340 provides input/output operations for the computing system 1300. In some implementations of the current subject matter, the input/output device 1340 can provide input/output operations for a network device. For example, the input/output device 1340 can include Ethernet ports or other networking ports to communicate with one or more wired and/or wireless networks (e.g., a local area network (LAN), a wide area network (WAN), the Internet).

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitory, such as for example as would a non-transient solid-state memory or a magnetic hard drive or any equivalent storage medium. The machine-readable medium can alternatively or additionally store such machine instructions in a transient manner, such as for example as would a processor cache or other random-access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

As shown in FIG. 2, the controller 210 may be deployed at one or more locations. For example, as shown in FIG. 2, a first controller 210a may be deployed at (e.g., integrated with) the laser CNC machine 100. Alternatively and/or additionally, a second controller 210b may be deployed at a server device 220 and/or a third controller 210c may be deployed at a client device 230. In some embodiments, the server device 220 and the client device 230 are communicatively coupled with the laser CNC machine 100 via the network 240.

Accordingly, one or more functionalities of the controller 210, including those associated with analyzing the material 140 to identify one or more features and characteristics of the material 140 such as one or more edges of the material 140, may be performed by the laser CNC machine 100, the server device 220, and/or the client device 230. Regardless of whether performed at the laser CNC machine 100, the server device 220, and/or the client device 230, analysis of the material 140 in some embodiments is performed as part of a fabrication or fabrication process in which the laser CNC machine 100 processes, for example, the material 140 to achieve one or more designs.

As shown in FIG. 2, the laser CNC machine 100 is communicatively coupled with the server device 220 and/or the client device 230 via the network 240. Similarly, the client device 230 and the server device 220 are also communicatively coupled via the network 240. The network 240 may be any type of wired network and/or wireless network including, for example, a local area network (LAN), a virtual local area network (VLAN), a wide area network (WAN), a public land mobile network (PLMN), the Internet, and/or the like. In some examples, the client device 230 and the server device 220 include one or more processor-based computing devices such as, for example, a smartphone, a tablet computer, a laptop computer, a desktop computer, a workstation, a wearable apparatus, an Internet-of-Things (IoT) appliance, and/or the like. In operation, the client device 230 and the server device 220 include computer software and hardware configured to provide one or more functionalities of the controller 210 such that the functionalities of the controller 210 are accessible, via the network 240, to the laser CNC machine 100.

In some embodiments, the controller 210 is configured to analyze the material 140 to identify one or more features and characteristics of the material 140. For example, the controller 210 may perform edge detection in order to identify one or more edges of the material 140. Edge detection may be performed to identify one or more portions of the material 140 that are obscured by another material. Alternatively, and/or additionally, edge detection may be performed to identify one or more portions of the material 140 subjected to previous processing. For instance, a previously engraved region of the material 140 or an area of the material 140 with damage from previous processing (e.g., burns, fraying, and/or the like) may be treated as an edge. Thus, as used herein, an edge of the material 140 may include a boundary between a first portion of the material 140 suitable for placement of a design to a second portion of the material 140 unsuitable for the placement of a design. One example of such a boundary may include an area of the material 140 where a transition from a presence of the material 140 to an absence of the material 140 and/or a presence of a different material occurs. Another example may include an area of the material 140 where a transition from an unprocessed and/or an undamaged portion of the material 140 to a processed and/or damaged portion of the material 140.

In some instances, an edge may be present around an outer perimeter of the material 140 as well as in areas where portions of the material 140 are absent due to a hole or cutout in the material 140, a natural cut feature of the material 140, and/or the like. In cases where the material 140 is a mixed material combining, for example, a first material and a second material, an edge may be present where the first material transitions to the second material. An edge may also be present where the material 140 is partially obscured by another material not intended for processing including, for example, one or more weights, stickers, magnets, pins, tape, and/or the like. For example, in cases where the other material obscuring the material 140 is not intended for processing, the portions of the material 140 obscured may be removed such that the resulting preview of the material 140 includes one or more cutouts corresponding to the other material. The preview of the material 140 obscured by another material not intended for processing may therefore include edges introduced by the other material. Contrastingly, when the material 140 is obscured by another material that is intended for processing, the preview of the material 140 may include the portion of the other material disposed on the material 140 but not the portion of the other material not disposed on the material 140. The preview of the material 140 obscured by another material intended for processing may thus include the edges of the material 140 obscured by the other material.

In some implementations of the current subject matter, the controller 210 may perform edge detection automatically, for example, upon detecting that the openable lid 130 of the laser CNC machine 100 is in the closed position. For example, the controller 210 may receive one or more triggers indicating the openable lid 130 is in the closed position. In one example, a sensor tied to the openable lid 130 produces a trigger when the openable lid 130 is closed that is detected by, for example, controller 210a that is deployed at the laser CNC machine 100. In another example, the controller 210 may receive a message transmitted from the laser CNC machine 100 or the controller 210a component of the laser CNC machine 100 indicating that the openable lid 130 is in the closed position. The message may be sent, for example, to the controller 210b and/or 210c via the network 240. In some instances, performing edge detection automatically may expedite subsequent calibrations of the laser CNC machine 100 including, for example, an autofocus technique to adjust the power of electromagnetic energy delivered to the material 140, a scanning technique to detect variations in the height (and/or thickness) of the material 140, and/or the like. Some embodiments that employ multipoint distortion correction procedures may include using scanning techniques (or aspects thereof) in connection with measuring the height (or thickness) of the material 140 above the material bed 150.

In some cases, the controller 210 may perform edge detection to detect changes in a position of the material 140 on the material bed 150. The controller 210 may also automatically adjust a prior placement of one or more designs on the material 140 in order to accommodate any detected changes in the position of the material 140 on the material bed 150.

As noted, edge detection may be performed in order to expedite the calibration of the laser CNC machine 100. For example, once the material 140 has been placed on the material bed 150 and the openable lid 130 is in the closed position, the controller 210 may automatically perform edge detection to identify the bounds of the material 140 such that an autofocus technique may be performed to calibrate the power of the electromagnetic energy delivered to the material 140. In some examples, height measurement may be performed as part of the edge detection procedures. Additionally and/or alternatively height measurement may be performed after the edge detection procedures have completed. With autofocus, a z-axis lens (e.g., in the laser head 160) may be used to focus the beam of electromagnetic energy delivered by the laser head 160 in accordance with the height (or thickness) of the material 140. In some examples, multipoint autofocus techniques in which the power of the electromagnetic energy is adjusted to account for variations in the height (or thickness) of the material 140 may require measuring the height (or thickness) of the material 140 at multiple locations across the material 140. In operation, and as described further herein, height maps associated with an image of a material determined according to the multipoint distortion correction techniques disclosed herein can be used to alter, modify, or otherwise control aspects of focusing the laser onto the material during laser processing of the material and perhaps other aspects of motion plans associated with implementing a design on a material.

Thus, knowing where the edges of the material 140 are located may improve user experience at least because autofocus techniques (and other calibration techniques) may be performed within the one or more edges of the material 140 where the material 140 is present but not outside of the one or more edges of the material 140 where the material 140 is absent. In some cases, the edges of the material 140 may be located with some user inputs adjusting the edges detected by the controller 210. However, in other cases, the edges of the material 140 may be located without requiring user input to indicate where the material 140 is present and not present.

The calibration of the laser CNC machine 100 may also be performed before the user places a design on the material 140. Precise placement of a design on a material 140 may be challenging without an understanding of the accurate location of the edges of the material 140. For example, the placement of one or more designs on the material 140 may result in an incorrect outcome if the designs are placed beyond the one or more edges of the material 140. In another example, design margins may be established to compensate for an inaccurate understanding of the edge locations, which may result in under-utilization of the material 140.

Edge detection may also improve the efficiency and outcome of material height measurement techniques in which height measurement techniques may be performed to determine the height (and/or thickness) of the material 140 at a single point or multiple points across the material, and the resulting measurement is used to adjust the focal point of the electromagnetic energy (e.g., focus the laser power) applied to the surface of the material and/or calibrate the power of the electromagnetic energy (e.g., calibrate the laser power) as well as for correcting distortions that may be present in the image captured by the lid camera 110 (e.g., barrel distortion and/or the like). In some cases, the material height measurement technique may also be used to determine certain features and characteristics of the material 140, such as warpage and/or the like, for generating a model of the material 140.

Aspects of edge detection are disclosed and described in U.S. Provisional App. 63/227,479, titled “Edge Detection for Computer Numerically Controlled Fabrication,” filed on Jul. 30, 2021, and now expired. Additional aspects of edge detection are described in both (i) U.S. application Ser. No. 17/668,988, titled “Edge Detection for Computer Numerically Controlled Fabrication,” filed on Feb. 10, 2022, and currently pending, and (ii) U.S. application Ser. No. 18/155,049, titled “Height Measurement Techniques and Uses Thereof,” filed on Jan. 16, 2023, and currently pending. The entire contents of Apps. 63/227,479; Ser. Nos. 17/668,988; and 18/155,049 are incorporated herein by reference.

### B. Example Laser Head Configurations

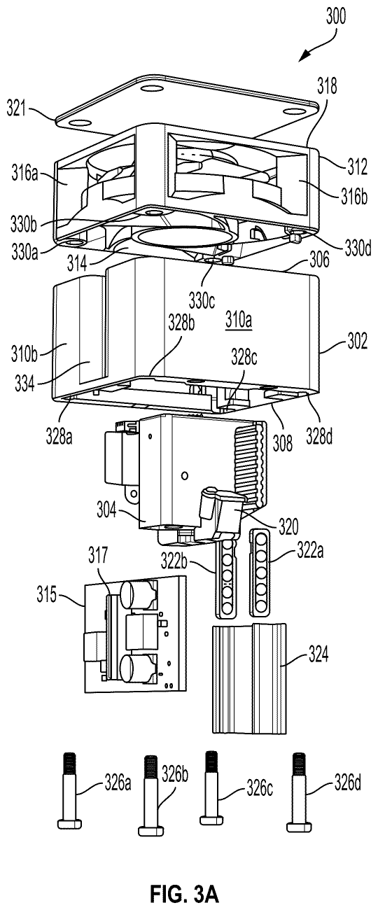

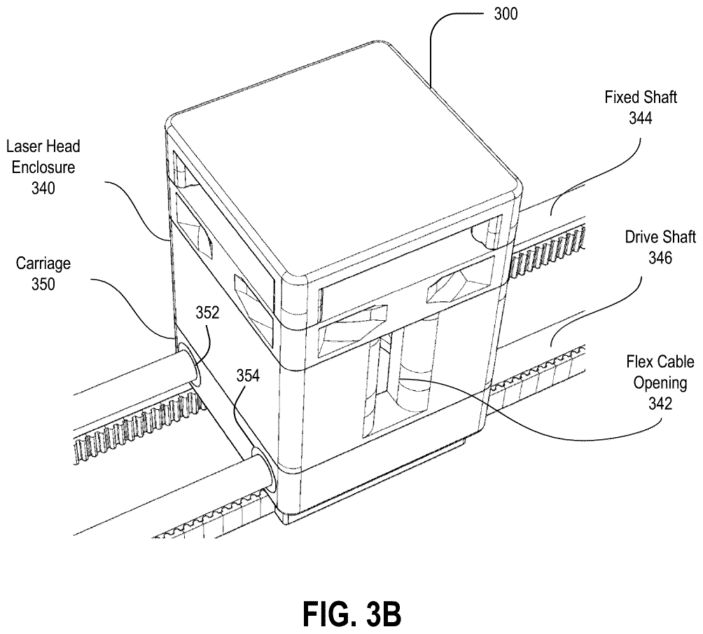

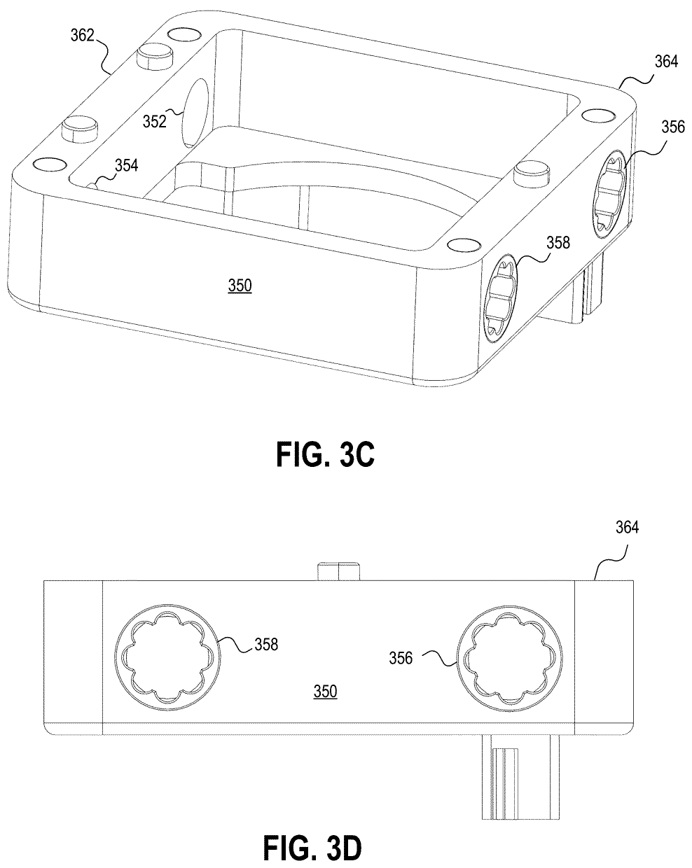

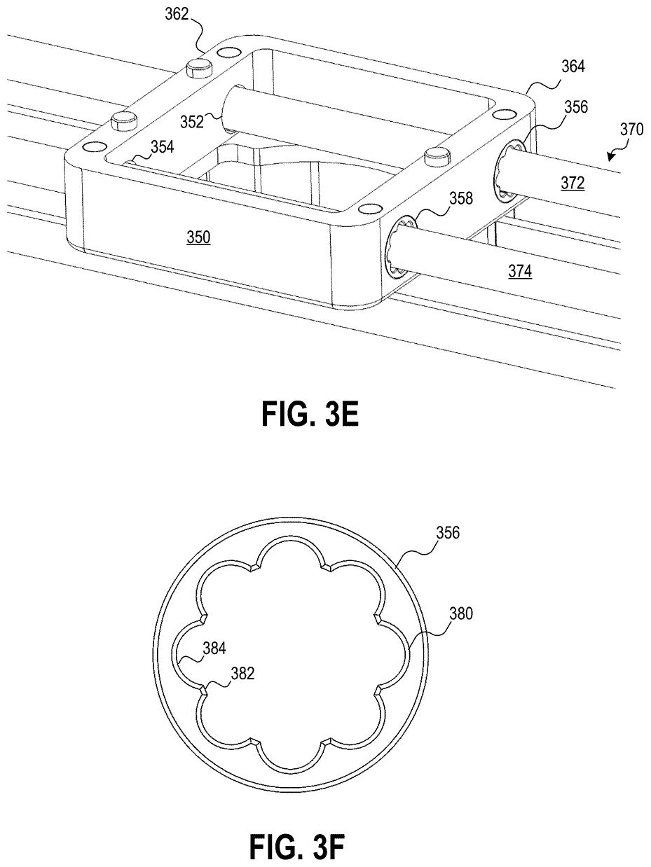

FIG. 3A depicts an exploded view of a laser head 300 for use with an example laser CNC machine consistent with some disclosed embodiments.

The laser head 300 includes a (i) laser enclosure 302 housing the laser 304, where the laser enclosure comprises a laser enclosure top 306, a laser enclosure bottom 308, and four laser enclosure sides, including 310a and 310b; and (ii) a fan enclosure 312 housing a fan 314, where the fan enclosure 312 is positioned on top of the laser enclosure top 306. The fan enclosure 312 comprises one or more side openings 316a, 316b. In operation, the fan 314 is configured to draw air from the one or more side openings 316a, 316b, and blow the air downward through the laser enclosure top 306 and into the laser enclosure 302.

FIG. 4 depicts example fan 400 configuration for use with the example laser head 300 depicted in FIG. 3A. Fan 314 depicted in FIG. 3A is similar to or the same as example fan 400.

The example fan 400 includes a center hub 402 with a plurality of fan blades extending therefrom, including fan blade 404. Each of the fan blades is the same as or substantially similar to fan blade 404.

Fan blade 404 includes a leading edge 408, a trailing edge 410, and a tip 406. Like each of the fan blades extending from the center hub 402, the arrangement of the leading edge 408, trailing edge 410, and tip 406 is configured to pull air from the side of the fan 400 and force the air downward.

Returning to FIG. 3A, in some embodiments, the fan enclosure comprises 312 a solid top 318. Some embodiments may additionally or alternatively include a solid plate 321 on top of the fan enclosure 312. In some embodiments, the solid top 318 of the fan enclosure 312 includes one or more fiducial markers sufficient for use with computer vision techniques. In embodiments with a solid plate 321 on top of the fan enclosure 312, the solid plate 321 additionally or alternatively includes the one or more fiducial markers sufficient for use with computer vision techniques. For example, a camera on the openable lid of the laser CNC machine can use the one or more fiducial markers for several purposes including but not limited to (i) calibrating the position and/or movement of the laser head 300, (ii) monitoring the position of the laser head 300 during a fabrication job, and/or (iii) controlling the positioning of the laser head 300.

To avoid the presence of screw holes or other attaching mechanisms from being visible from the top of the laser head 300 (which might make the laser head more aesthetically pleasing and/or might interfere with computer vision techniques), some embodiments include a plurality of bolts 326a-d (or similar attaching mechanisms) that are routed through the bottom of the laser enclosure 302 and the fan enclosure 312 to attach the solid plate 321 to the top of the fan enclosure 312 from the underside of the solid plate 321. For example, bolt 326a is routed through hole 328a of the laser enclosure 302 and hole 330a of the fan enclosure 312. Similarly, bolt 326b is routed through holes 328b and 330b, bolt 326c is routed through holes 328c and 330c, and bolt 326d is routed through holes 328d and 330d. Other attachment methods that result in a smooth top without visible screw holes of other attaching mechanisms on the top of the laser head 300 could be used as well. In other embodiments, the bolts 326a-d may instead attach within the fan enclosure 312, and the solid plate 321 may be glued or similarly attached to the top of the fan enclosure 312.

For example, FIG. 8A depicts an interior view 800 of an example laser CNC machine with an example material bed 802 disposed therein according to some disclosed embodiments. The interior view 800 shows an example fiducial marker 804 on the top of a laser head 806.

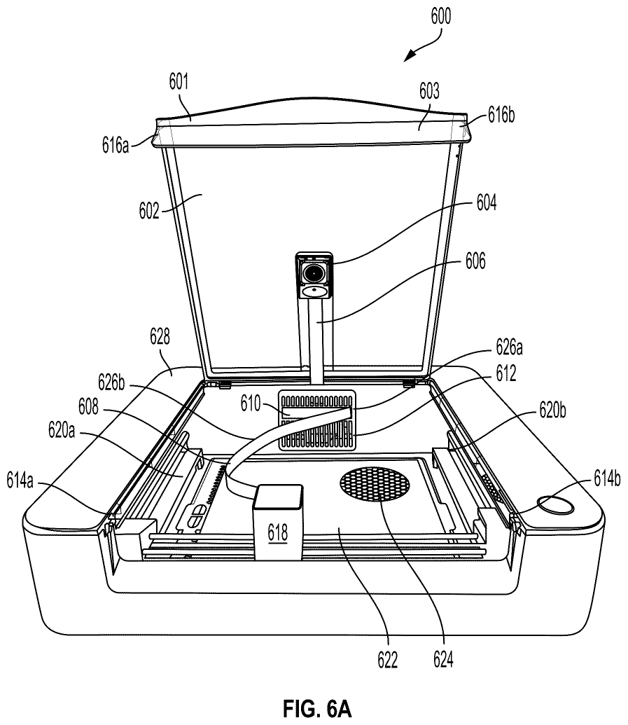

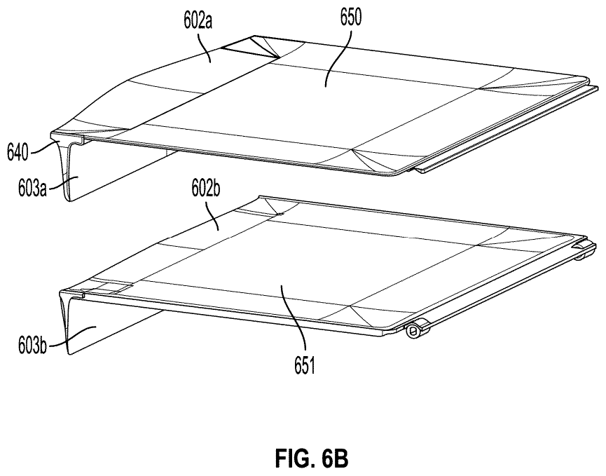

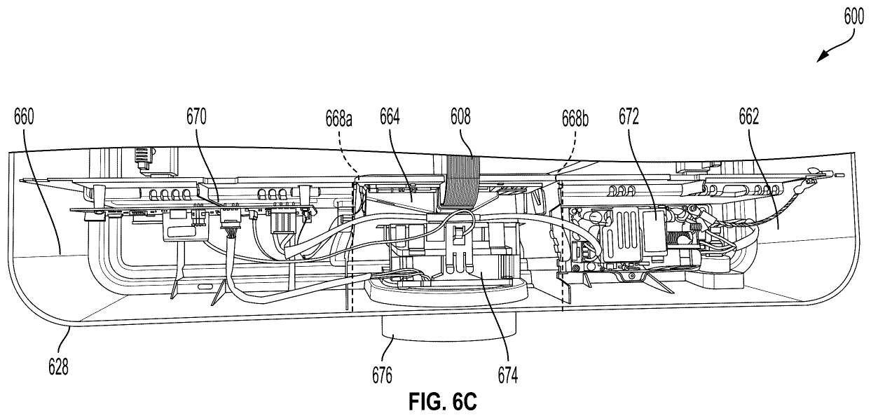

In some embodiments that include a lid camera (e.g., lid camera 110 (FIG. 1D), which may be housed in lid camera assembly 604 (FIG. 6A), or similar), the laser CNC machine is configured to monitor and/or control the position of the laser head 806 before and/or during operation based at least in part on images of the fiducial marker 804 captured by the lid camera.

FIGS. 3B through 3F show further aspects and features of the laser head 300 depicted in FIG. 3A.

For example, FIG. 3B shows a laser head enclosure 340 affixed to a carriage 350 and configured to house a laser head 300, according to some embodiments. Laser head enclosure 340 is positioned on top of the carriage 350 and includes an opening 342 for attaching a flex cable (e.g., cable 608 shown in FIG. 6A) to the laser head 300. In other embodiments, the laser head enclosure 340 may be positioned differently relative to the carriage 350, such as below the carriage 350, on one side of the carriage 350, on an angle adapter mounted on the carriage 350 (e.g., see FIG. 4C in U.S. application Ser. No. 17/511,000, titled “Mechanical System For High Positional Computer Numerically Controlled Applications,” filed on Oct. 26, 2021, and published as U.S. Pub. 2023/0128807 on Apr. 27, 2023, which is incorporated by reference in its entirety), among other configurations.

The carriage 350 includes openings (e.g., opening 352 and opening 354) that enable the carriage 350 to travel along a dual rail gantry system that includes two shafts. In some embodiments, the two shafts include a fixed shaft 344 and a drive shaft 346.

FIG. 3C shows a perspective view of the carriage 350 that facilitates movement of the laser head 300 (FIGS. 3A & 3B), along a dual rail gantry configuration according to some embodiments. The perspective view in FIG. 3C shows openings 352 and 354 at a first end 362 of the carriage 350 and openings 356 and 358 at a second end 364 of the carriage 350.

FIG. 3D shows a side view of the carriage 350 according to some embodiments. The side view in FIG. 3D shows the second end 364 of the carriage with opening 358 and opening 356.

FIG. 3E shows the carriage 350 implemented with a dual rail gantry configuration 370 according to some embodiments. The dual rail gantry configuration 370 includes a first rail 372 and a second rail 374. In some embodiments, the first rail 372 is similar to or the same as the fixed shaft 344 (FIG. 3B) and the second rail 374 is similar to or the same as drive shaft 346 (FIG. 3B). As shown in FIG. 3E, opening 352 and opening 356 allow the carriage 350 to travel along the first rail 372, while opening 354 and opening 358 allow the carriage 350 to travel along the second rail 374, thereby enabling the carriage 350 to move along the dual rail gantry configuration 370.

Subtractive CNC machines like the disclosed laser CNC machines can create substantial effluence. For example, in some instances, executing a fabrication job (e.g., cutting, etching, etc. with the laser) generates effluence (e.g., debris from the laser cutting/etching process) which can, in some scenarios, build up on the surface of interior components of the laser CNC machine. In some situations, the effluent generated when executing a fabrication job can build up on the surface of the first rail 372 and the second rail 374 of the dual rail gantry configuration 370.

When effluent builds up on the surface of one or both of the rails of the dual rail gantry configuration 370, the effluent can impede the travel of the carriage 350 along the dual rail gantry configuration 370. For example, effluent build up can slow the travel of the carriage 350, cause misalignment of the carriage 350 (thereby reducing the precision of the laser CNC machine's fabrication abilities), or in some cases, even prevent the carriage 350 from moving altogether. As a result, current systems typically require a user to regularly and frequently clean the gantry rails to maintain smooth operation and precise positioning and alignment of the laser head.

To ameliorate the deleterious effects of effluent build up on the rails of the dual rail gantry configuration 370, some embodiments implement a self-cleaning process that cleans effluent from the rails during operation. The self-cleaning process is implemented via the openings 352, 354, 356, and 358 on the carriage 350, each of which may be configured with a plurality of alternating teeth and grooves. In some embodiments, all four openings are configured with the alternating tooth and groove arrangement. In other embodiments, fewer than all four openings (e.g., two or three of the four) are configured with the alternating tooth and groove arrangement The alternating teeth and grooves are arranged to remove or push aside effluent from the surface of the first rail 372 and the second rail 374 as the carriage 350 moves back and forth along the first rail 372 and the second rail 374. Even if the self-cleaning process does not remove all the effluent from the first and second rails, the tooth and groove configuration of the openings 352, 354, 356, and 358 enables the carriage 350 to travel along the first rail 372 and the second rail 374 despite the presence of effluent on the surfaces of the first rail 372 and the second rail 374, at least as compared to configurations where the openings 352, 354, 356, and 358 lack the alternating tooth and groove arrangement.

FIG. 3F shows a close up view of opening 356 on carriage 350. Opening 356 is configured to accommodate the first rail 372 as shown in FIG. 3E. The opening 356 includes a self-cleaning arrangement 380 with alternating teeth 382 and grooves 384. In operation, the teeth 382 cut through the effluent build-up and funnel the effluent build-up into the grooves 384. The alternating tooth and groove arrangement 380 results in a “grooved” or “slotted” configuration for the opening 356. In some embodiments, opening 352, opening 354, and opening 358 are configured similarly to or the same as opening 356, and thus, the alternating tooth and groove arrangement 380 of openings 352, 354, and 358 performs the same or similar functions as the alternating tooth and groove arrangement 380 of opening 356.

In operation, the tooth and groove arrangement 380 of opening 356 removes effluent from the surface of the first rail 372 as the carriage 350 travels along the dual rail gantry configuration 370. While the carriage 350 moves along the dual rail gantry configuration 370, the teeth 382 (i) remove (e.g., cuts through and/or scrapes off) effluent built up on the surface of the first rail 372 and (ii) funnel the removed effluent to the grooves 384.

The alternating tooth and groove arrangement 380 of FIG. 3F includes eight alternating teeth 382 and grooves 384 as an example. In the example configuration, all of the teeth 382 have a uniform or substantially uniform shape, and all the grooves 384 likewise have a uniform or substantially uniform shape. However, other configurations of the alternating tooth and groove arrangement 380 may have (i) more or fewer than eight teeth 382 and eight grooves 384, (ii) teeth 382 having (a) a different dimension or shape or (b) several different dimensions and/or shapes, and/or (iii) grooves 384 having (a) a different dimension or shape or (b) several different dimensions and/or shapes. In other examples, the alternating tooth and groove arrangement 380 may have any number of teeth and grooves in any shape or dimension or combination of shapes and dimensions suitable for removing and/or pushing aside effluent that may build up on the rails 372 and/or 374 in the manner described herein.

i. Example Height Measurement Assembly

Returning to FIG. 3A, in some embodiments, the laser head 300 also includes a height measurement assembly 320 configured to measure distances between the height measurement assembly 320 and material placed on the material bed of the laser CNC machine in connection with focusing the laser beam emitted from the laser 304 onto the material placed on the material bed. The example configuration in FIG. 3A depicts the height measurement assembly 320 positioned close to the laser 304. In other embodiments, the height measurement assembly 320 could be positioned in a different location on or within the laser head 300.

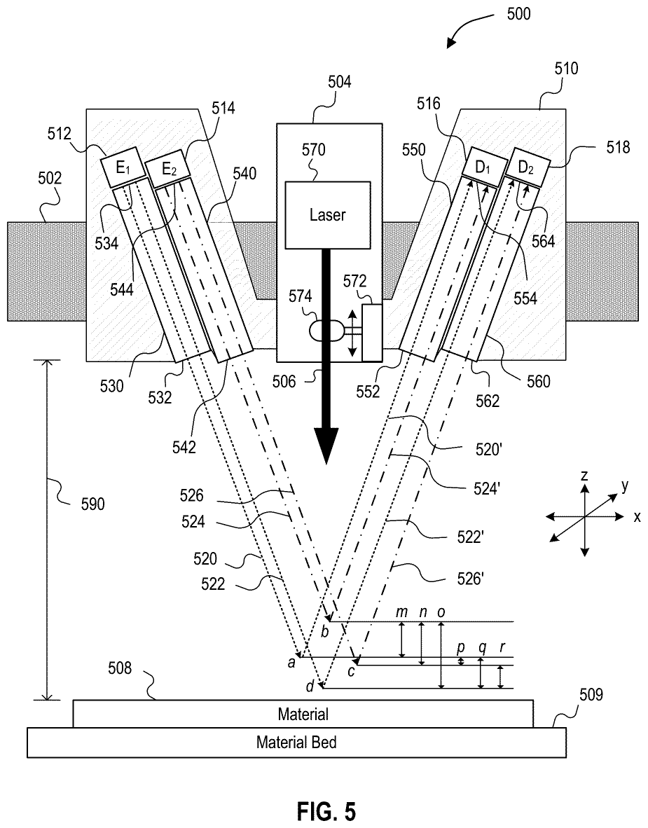

FIG. 5 depicts aspects of a laser head 500 with a height measurement assembly 510 consistent with some disclosed embodiments. The height measurement assembly 510 shown in FIG. 5 may be similar to or the same as the height measurement assembly 320 shown in FIG. 3A.

The height measurement systems and methods disclosed herein can be used independently or in combination with any of the material edge detection, calibration, and multipoint distortion correction techniques disclosed and described in (i) U.S. Provisional App. 63/299,460, titled “Multipoint Distortion Correction,” filed on Jan. 14, 2022, and (ii) U.S. application Ser. No. 18/155,049, titled “Height Measurement Techniques and Uses Thereof,” filed on Jan. 16, 2023. The entire contents of Apps. 63/299,460 and Ser. No. 18/155,049 are incorporated herein by reference.

In operation, the laser CNC machines disclosed and described herein are capable of processing many different types of materials (e.g., paper, leather, acrylic, wood, metal, etc.). Additionally, the materials processed by the laser CNC machines may have different thicknesses.

In some scenarios, the material 508 to be processed is placed on a material bed 509 within the laser CNC machine or on the bottom of the laser CNC machine (with the laser CNC machine's material bed 509 removed), and the laser CNC machine moves a downward-firing laser 570 (e.g., the laser 570 is fired along the z-axis shown in FIG. 5) over the material 508 (and/or moves the material 508 under the laser 570) to process the material.

In other scenarios, the material 508 may be held by or otherwise affixed to an arm, jig, or similar mechanism, and the laser CNC machine moves a horizontally-firing laser (e.g., the laser is fired along the x-axis shown in FIG. 5) over the material 508 (and/or moves the material relative to the laser) to process the material. For example, in some embodiments, the material 508 may be placed on a rotary jig that rotates the material 508 while the laser beam is applied to the material 508 as the material is rotated on the jig. In some such embodiments, e.g., when the material 508 is curved and the laser 507 is not positioned at the peak of the curve of the material 508, an overhead camera (e.g., lid camera 110 (FIG. 1D), which may be housed in lid camera assembly 604 (FIG. 6A), or similar) may not be able to accurately measure the distance from the laser 570 to the material 508.

Regardless of the arrangement of the material 508 relative to the laser 570 and regardless of whether the laser 570 is moved relative to the material 508 or the material 508 is moved relative to the laser 570, it is advantageous to know the distance between the surface of the material 508 and laser head 500 (and/or the optical assembly 504 within the laser head 500, and thus, the laser 570) so that the laser beam 506 emitted via the laser 570 in the laser head 500 can be properly focused onto the surface of the material to provide clean, accurate, and consistent processing of the material.

The measurement assembly embodiments disclosed herein provide increased accuracy of distance measurements over a wider measurement range as compared to previous and otherwise known techniques.

One known technique used in additive manufacturing for measuring the distance between an injection nozzle and a bed uses a measuring apparatus, coupled to the injection nozzle, containing two emitters, one detector, and a comparator. In operation, the method uses the emitters, the detector, and the comparator to determine whether the injection nozzle is at a predetermined distance from the bed by (i) changing the distance between the measuring apparatus and the bed (either by moving the measuring apparatus or by moving the bed), (ii) comparing the intensity of the two light signals (i.e., from each of the two emitters) measured at the detector, and (iii) concluding that the injection nozzle is at the predetermined distance from the bed when the intensities of the light signals (i.e., the two light signals from the two emitters) measured by the detector are the same.

Although the method is simple to implement, the method is limited in that (i) it only works over very small distances (e.g., between about 2.5 to 3.5 mm, as determined by the geometric arrangement of the emitters and detector and the manner in which the light tends to spread over distance), (ii) it only works with a single type of material (because of differences in reflectivity between different materials), and (iii) it requires a sweep (e.g., a vertical sweep) of the measuring apparatus to find a single point where the comparator indicates that the two light intensity measurements are identical. Also, the method merely confirms when the material is at a single, fixed predetermined distance (determined by the specific geometric arrangement of the emitters and the detector). The method does not and cannot measure different distances or confirm whether the distance between the measuring apparatus and the bed is any distance other than that single, fixed predetermined distance.

Additionally, measurement systems implemented with low-cost light emitters (e.g., LEDs) can suffer from inaccurate distance measurements and limitations on the maximum measured distance, which is particularly challenging for some applications (e.g., laser cutting/etching) that require an accuracy of about a few hundred microns, or even an accuracy of +/−100 μm. Obtaining an accuracy of a few hundred microns is particularly challenging when lasers are not being used to perform the measurement. A conventional system may have a maximum distance between the measurement system and material of ˜10 mm (+/−0.5 mm), whereas it is often desirable to have the maximum distance much larger than 10 mm (e.g., to match the focal length of a laser).

Some example embodiments disclosed herein both overcome the limitations of prior art approaches (including the above method used for additive manufacturing) and provide further advantages.

For example, the measurement assembly embodiments are useful for newer laser CNC machines that employ non-pumped solid state laser diodes (e.g., blue wavelength lasers (˜400-500 nm lasers)) to process materials as compared to laser CNC machines that typically use carbon dioxide lasers In operation, the depth of focus (sometimes referred to as focus tolerance) of laser CNC machines employing non-pumped solid state laser diodes is much shorter. The smaller depth of focus for some non-pumped solid-state lasers compared to carbon dioxide lasers means that laser CNC machines employing such non-pumped solid state lasers need more precise control of the focusing of the laser as compared to laser CNC machines employing carbon dioxide lasers. More precise control of the focusing of the laser in turn requires more precise distance measurements between the laser head and the surface of the material to be processed by the laser beam so that the laser beam can be precisely focused onto the surface of the material, e.g., focused within several hundred microns, or even focused within about +/−100 μm.

To overcome the limitations of prior approaches and provide the improved measurement capabilities suitable for use with laser CNC machines, some measurement assembly embodiments include, among other features, high aspect ratio masks that are (i) placed in front of detectors, (ii) placed after emitters, or (iii) perhaps placed both after the emitters and before the detectors. In some embodiments, the emitters 512, 514 and detectors 516, 518 are arranged within the measurement assembly 510. Within the measurement assembly 510, the emitters and detectors are angled toward each other so that light emitted from the emitters 512, 514 will reflect off the surface of the material 508 at angles suitable for the detectors 516, 518 to detect the reflected light, and in particular, angles suitable for the detectors 516, 518 to be able to detect changes in the intensity of the reflected light as a function of the distance between the material 508 and the measurement assembly 510 housing the emitters 512, 514 and detectors 516, 518. As described further below, the interior surfaces of the high aspect ratio masks in some embodiments may be threaded, textured, and/or coated with anti-reflective coatings to reduce or even eliminate internal reflections that may scatter the light, thereby improving the accuracy of the light intensity measurements compared to measurement approaches that do not implement similarly-configured masks.

These and other improvements enable the emitters 512, 514 and detectors 516, 518 in the embodiments disclosed herein to be placed and arranged in geometric configurations that provide an increased operating range as compared to prior approaches, thereby enabling the example measurement assembly 510 configurations disclosed herein to measure greater distances with more accuracy than prior techniques.

In another example, the measurement system geometry (i.e., the arrangement of the emitters and detectors) can be defined such that two different emitter/detector pairs are designed to provide the same intensity measurements. This arrangement can be used for redundancy purposes and/or to detect system drift over time (e.g., due to aging, temperature, etc.). For example, this arrangement can be used to verify accurate construction of the height detection system, to extend the range of the height detection system, to detect edges of the material to be machined, or to detect system drift over time.

For example, some embodiments with two different emitter/detector pairs designed to provide the same intensity measurements can be used to verify accurate configuration and/or calibration of the measurement system. Some such embodiments include (i) obtaining a first measurement (e.g., a light intensity measurement and/or a height measurement) via the first emitter/detector pair, (ii) obtaining a second measurement (e.g., a light intensity measurement and/or a height measurement) via the second emitter/detector pair, and (iii) comparing the first measurement and the second measurement to determine whether the first and second measurements are the same (or at least within a threshold difference of each other), thereby indicating that the measurement system is accurately configured and/or calibrated. Some such embodiments include proceeding with measuring the distance between the measurement assembly (described below) and the surface of the material after verifying that the measurement system is accurately configured/calibrated.

As mentioned earlier, FIG. 5 depicts aspects of a laser head 500 with a height measurement assembly 510 consistent with some disclosed embodiments. The laser head 500 is attached to a gantry 502. The gantry 502 may be affixed to a joining assembly 170 (FIG. 1E) and/or joining assembly 812 (FIG. 8A).

The laser head 500 includes (i) an optical assembly 504 that is configured to focus a laser beam 506 onto a surface of a material 508, and (ii) a measurement assembly 510 that is used in connection with determining the distance 590 between the optical assembly 504 and the surface of the material 508 onto which the laser beam 506 is focused. In some embodiments, the laser 570 that emits the laser beam 506 comprises a blue laser system operating at one or more wavelengths between about 400-500 nm. In some embodiments, the laser 570 that emits the laser beam 506 comprises a blue laser system operating between 400 and 500 nm (e.g., at approximately 450 nm).

When the laser CNC machine is configured to apply a downward-firing laser 570 onto a material 508 as shown in FIG. 5, the distance 590 is the “height” of the optical assembly 504 above the material 508. In embodiments where the laser CNC machine is configured with a sideways firing laser onto a material (not shown), the distance is not strictly a “height.” However, the same distance measurement techniques for determining the distance 590 in the overhead firing configurations shown in FIG. 5 are equally applicable to sideways firing configurations.

The example laser head 500 in FIG. 5 is similar in many respects to any or all of the laser head 160 (FIGS. 1D & 1E), laser head 300 (FIG. 3A), laser head 618 (FIG. 6A), and laser head 806 (FIG. 8A). In operation, laser head 500 may be implemented with any of the laser CNC machine embodiments disclosed and/or described herein and/or other type of laser CNC machine now known or later developed that would benefit from being able to determine one or more distances between a laser head and a material to be processed by the laser CNC machine.

In some embodiments, one or more controllers may be associated with operating the laser CNC machine equipped with the laser head 500. The one or more controllers may include any one or more of (i) one or more controllers of the laser CNC machine, (ii) one or more controllers of a computing device configured to control and/or operate the laser CNC machine (e.g., a smartphone, tablet computer, laptop/desktop computer, or any other computing device suitable for controlling and/or operating the laser CNC machine, and/or (iii) one or more controllers of a server system (e.g., a local or remote server system, cloud server system, or any other type of server system suitable for controlling and/or operating the laser CNC machine. For example, the one or more controllers may include any of the controllers, individually or in combination, associated with the laser CNC processing system 200 shown and described with reference to FIG. 2, including any one or more (or all) of controller 210a, 210b, and/or 210c). As described with reference to FIG. 13, in some embodiments, a controller includes one or more processors.

In some embodiments, a laser CNC machine equipped with the laser head 500 is configured to position the laser beam 506 at locations in the x-y plane along the surface of the material 508 by moving the laser head 500 back-and-forth in the x-axis along the gantry 502 and by moving the gantry 502 back-and-forth in the y-axis. At individual x-y positions over the surface of the material 508, a laser CNC machine equipped with laser head 500 is additionally configured to focus the laser beam 506 in the z-direction by using a focusing sub-system 572. In some embodiments, the focusing sub-system 572 is configured to move a lens 574 up and down in the z-axis, thereby adjusting the focal point of the laser beam 506 onto the surface of the material 508. Some embodiments of the focusing sub-system 572 may additionally or alternatively include moving the laser 570 up and down in the z-axis, or perhaps moving the entire optical assembly 504 up and down in the z-axis to facilitate focusing of the laser beam 506 onto the surface of the material 508. In some embodiments, the focusing sub-system 572 employs one or more stepper motors configured to move the lens 574 up and down in the z-axis to adjust the focal point of the laser beam 506 onto the surface of the material 508.

In other embodiments, rather than moving the laser head 500 over the material 508, the material 508 may instead be moved under the laser head 500 while the laser head 500 remains substantially fixed in place. In other alternative embodiments, a laser CNC machine may be configured to control the position of the laser beam 506 in one or more of the x, y, and/or z directions, and the laser CNC machine may be configured to move the material 508 in one or more of the x, y, and/or z directions.

The example measurement assembly 510 shown in FIG. 5 includes a first emitter 512, a second emitter 514, a first detector 516 and a second detector 518. The emitters 512 and 514 are configured to emit light (e.g., infrared light or any other suitable type of light), and the detectors 516 and 518 are configured to detect the light emitted by the emitters 512 and 514. In some embodiments the emitters comprise LED emitters configured to emit infrared light at wavelengths between about 700 nm to 1 mm.

Although the example measurement assembly 510 shows two emitters and two detectors arranged in a particular configuration, other configurations comprising one or more emitters and one or more detectors arranged so that the one or more detectors are configured to measure the intensity of light emitted from the one or more emitters that is reflected off the surface of the material 508 are possible as well.

ii. Emitter and Detector Mask Configurations

As mentioned above, to improve the operating range of the measurement system, thereby enabling more accurate measurement of greater distances, in some embodiments the measurement assembly 510 additionally includes (i) one or more masks positioned after the one or more emitters, and/or (ii) one or more masks positioned before the one or more detectors.

The example shown in FIG. 5 includes four bore-shaped masks 530, 540, 550, and 560. Each mask includes a first opening at one end of the bore, a second opening at the opposite end of the bore, and an interior space between the first opening and the second opening. The interior space has an interior surface and a length. In some scenarios, the length of the interior space of each bore-shaped mask is at least twice the diameter of at least one of the first opening or the second opening. In some embodiments, the length of the interior space of the bore is between about five to six times as long as the diameter of at least one of the first opening or the second opening. In some configurations, each of the four bore-shaped masks 530, 540, 550, and 560 are between about 5-6 mm long with 1 mm diameter openings at each end.

For example, mask 530 includes a first opening 532, a second opening 534, and an interior space between the first opening 532 and the second opening 534. Mask 540 includes a first opening 542, a second opening 544, and an interior space between the first opening 542 and the second opening 544. Mask 550 includes a first opening 552, a second opening 554, and an interior space between the first opening 552 and the second opening 554. And mask 560 includes a first opening 562, a second opening 564, and an interior space between the first opening 562 and the second opening 564.

Mask 530 for emitter 512 and mask 540 for emitter 514 are sometimes referred to herein as “emitter” masks. Each of these emitter masks are positioned between their respective emitter and the surface of the material 508, and in operation, each of the emitter masks is configured to control the divergence of light emitted from their respective emitters.

Similarly, mask 550 for detector 516 and mask 560 for detector 518 are sometimes referred to herein as “detector” masks. Each of these detector masks are positioned between their respective detector and the surface of the material 508, and in operation, each detector mask is configured to direct, to its respective detector, light that has been emitted from one or more of the emitters and reflected by the surface of the material 508.

In some instances, the first openings 532, 542, 552, and 562 of the masks 530, 540, 550, and 560 are covered with a transparent material that passes light of the wavelength(s) emitted by the emitters 512 and 514 but prevents debris (e.g., debris from the laser cutting/etching process) from entering the interior spaces of the masks 530, 540, 550, and 560, thereby protecting the emitters and detectors from dust and debris. In some embodiments, the transparent material may comprise a lens or similar element arranged to focus the light emitted from the emitter (for “emitter” masks) or focus light reflected from the surface of the material onto the detector (for “detector” masks).

For the masks 530, 540, 550, and 560, the interior surface of an individual mask may take any suitable shape, such a cylindrical shape, a rectangular shape, hexagonal shape, octangular shape, or any other suitably-shaped elongate interior space that allows light to propagate within the interior space between the first and second openings of the mask. In some instances, at least a portion of the interior surface of an individual mask includes one or more of an anti-reflective coating, a threaded pattern, a brushed surface, and/or other geometry or coating that prevents or at least reduces internal reflections of light within the interior space of the mask.

In some embodiments, for an individual mask of the set of masks 530, 540, 550, and 560, at least one of the first opening or the second opening of the mask comprises one or more physical features configured to affect propagation of light between the interior space of the mask and at least one of the first opening or the second opening. For example, the one or more physical features may include any one or more of (i) a rough surface, (ii) a threaded surface, (iii) an engraved surface, or (iv) a light trap configuration.

In some embodiments, masks 530 and 540 for emitters 512 and 514, respectively, may be configured differently than masks 550 and 560 for detectors 516 and 518, respectively. However, in other embodiments, the “emitter” masks 530 and 540 may be configured the same as or similar to the “detector” masks 550 and 560. In some embodiments, the measurement assembly 510 may include one or more of the “emitter” masks but not any “detector” masks. In other embodiments, the measurement assembly 510 may include one or more “detector” masks but not any “emitter” masks.

In some configurations, emitter/detector pair 512/516 may be configured to measure the same intensity level as emitter/detector pair 514/518 when a piece of flat (or substantially flat) material is placed under the emitter/detector pairs to reflect the light emitted from the emitters back to the detectors for measurement. To verify the accuracy of the configuration and/or calibration of the measurement assembly 510 components, some such embodiments include (i) obtaining a first light intensity measurement via the first emitter/detector pair 512/516, (ii) obtaining a second light intensity measurement via the second emitter/detector pair 514/518, and (iii) comparing the first measurement and the second measurement to determine whether the first and second measurements are the same (or at least within a threshold difference of each other), thereby indicating that the components of the measurement assembly 510 are accurately configured and/or calibrated.

In some instances, rather than being configured to measure the same intensity levels, the first emitter/detector pair 512/516 and the second emitter/detector pair 514/518 may be configured to measure intensity levels that have a known difference when a piece of flat (or substantially flat) material is placed under the emitter/detector pairs to reflect the light emitted from the emitters back to the detectors for measurement. To verify the accuracy of the configuration and/or calibration of the measurement assembly 510 components in such embodiments, some such embodiments include (i) obtaining a first light intensity measurement via the first emitter/detector pair 512/516, (ii) obtaining a second light intensity measurement (via the second emitter/detector pair 514/518, and (iii) comparing the first measurement and the second measurement to determine whether the first and second measurements are within the known difference of each (or at least within a threshold difference of the known difference of each other), thereby indicating that the components of the measurement assembly 510 are accurately configured and/or calibrated.

Some embodiments that are configured for verifying accurate configuration and/or calibration of the measurement assembly 510 components include proceeding with measuring the distance 590 between the measurement assembly 510 and the surface of the material 508 after (and perhaps only after) verifying that the components of the measurement assembly 510 are accurately configured and/or calibrated.

iii. Fixed and Adjustable Measurement Assembly Configurations

In some example embodiments, the measurement assembly 510 is configured in a fixed position on the laser head 500 (regardless of whether the laser head 500 is configured to move relative to the material 508, or whether the laser head 500 is fixed and the material 508 is moved relative to the laser head 500). In other embodiments, the measurement assembly 510 is moveable within the laser head 500. For example, in some configurations, regardless of whether the laser head 500 is fixed or moveable, the measurement assembly 510 is movable within the laser head 500, e.g., movable up and down along the z-axis.

In some embodiments, the measurement assembly 510 and the optical assembly 504 are mounted to the laser head 500 and configured to move together as a single physical structure, i.e., the optical assembly 504 and the measurement assembly 510 do not move independently of each other. Embodiments where the measurement assembly 510 and optical assembly 504 are configured to move together can provide better distance measurement accuracy (and thus better laser fabrication results) as compared to alternative embodiments where the measurement assembly 510 and the optical assembly 504 may move independently of each other.

Embodiments where the measurement assembly 510 (e.g., the laser head 500 with the measurement assembly 510 and the optical assembly 504) is moveable up and down in the z-axis are advantageous in scenarios where the laser CNC machine needs to process a particularly thick or particularly thin material.

For example, when a thicker-than-typical material is placed within the laser CNC machine for processing, the top of the thicker-than-typical material will be closer to the laser head 500 than the top of a material with a more typical thickness. In such scenarios, moving the measurement assembly 510 (and the emitters and detectors therein) further away from the surface of such thicker-than-typical material may facilitate a more accurate distance measurement between the optical assembly 504 and the surface of the material 508 by effectively placing the surface of the material within the operating range of the measurement assembly 510, or by placing the surface of the material within a more accurate region of the operating range of the measurement assembly 510.

Similarly, when a thinner-than-typical material is placed within the laser CNC machine for processing, the top of the thinner-than-typical material will be further from the laser head 500 than the top of a material with a more typical thickness. In such scenarios, moving the measurement assembly 510 (and the emitters and detectors therein) closer to the surface of such thinner-than-typical material may facilitate a more accurate distance measurement between the optical assembly 504 and the surface of the material 508.

Because the relationship between the position of the optical assembly 504 and the measurement assembly 510 is known (including in scenarios where the measurement assembly 510 may be moved up and down), the distance measured between the measurement assembly 510 and the surface of the material 508 can be used to determine the distance between the optical assembly 504 and the surface of the material 508, even when the measurement assembly 510 may have been moved up or down in the z-axis to facilitate more accurate distance measurements for thicker-than-typical and/or thinner-than-typical materials.

Embodiments where the measurement assembly 510 is moveable up and down in the z-axis also enable verification and/or confirmation of distance measurements. For example, in some scenarios, the one or more controllers may be configured to determine a first distance measurement between the optical assembly 504 and the surface of the material 508 when the measurement assembly 510 is at a first position along the z-axis. Then, after the measurement assembly 510 has been moved to a second position along the z-axis, the one or more controllers may be configured to determine a second distance measurement between the optical assembly 504 and the surface of the material 508 while the measurement assembly 510 is at the second position along the z-axis. Because the difference between the first position along the z-axis and the second position along the z-axis is known, the one or more controllers can compare the first and second distance measurements (or perhaps the difference between the two distance measurements) with the difference between the first and second positions along the z-axis to verify and/or confirm the accuracy of the distance measurements. In some scenarios, the one or more controllers may be configured to obtain a set of several distance measurements with the measurement assembly 510 placed at several different positions along the z-axis, and then use that set of distance measurements to verify and/or confirm a final distance measurement between the optical assembly 504 and the surface of the material 508.

iv. Determining Material Types

In some embodiments, the one or more controllers associated with the laser CNC machine are configured to determine (e.g., via the one or more processors of the controllers) a material type of the material 508 to be processed by the laser CNC machine. Determining the material type of the material 508 can be advantageous for laser CNC machines that are configured to process different types of materials. For example, because different materials may tend to more or less reflective than other materials (e.g., wood vs. metal vs. acrylic vs. glass), or may tend to reflect some wavelengths of light more or less than other wavelengths of light, it can be beneficial to know the type of material 508 to be processed in connection with measuring the intensity of light reflected from the surface of the material 508 for the purpose of determining the distance 590 to the surface of the material 508.

In operation, the material type of the material 508 can be determined in any of several different ways, or any combination of such several different ways.

For example, in some embodiments, the one or more controllers associated with the laser CNC machine may determine the material type of the material 508 based on one or more user inputs comprising the material type. In some such embodiments, the material type of the material 508 may be received via one or more user inputs (e.g., on a user interface) at the laser CNC machine or connected controller device, such as a smartphone, tablet, laptop, and/or desktop computer or similar computing device.

In some scenarios, the one or more controllers associated with the laser CNC machine may additionally or alternatively determine the material type of the material 508 based on an image of the material 508 obtained from a camera, where the image includes an identifier associated with the material, e.g., a Quick Response (QR) code, a stock keeping unit (SKU) code, a barcode, and/or other identifier that can be determined from a camera image and used to lookup or otherwise ascertain information about the material 508 to be processed. For example, in some embodiments, a camera associated with the laser CNC machine (e.g., a camera on the inside of the lid of the laser CNC machine (e.g., lid camera 110 (FIG. 1D), which may be housed in lid camera assembly 604 (FIG. 6A); a camera on the inside housing of the laser CNC machine; a camera of a smartphone or tablet computer configured to control the laser CNC machine; or any other suitable camera) may obtain an image of the material to the processed by the laser CNC machine, where the image includes the identifier associated with the material.

In still further scenarios, the one or more controllers associated with the laser CNC machine may additionally or alternatively determine the material type of the material 508 via one or more sensors (e.g., a camera) that identifies the color, transparency, and/or reflectivity of the material 508. In some embodiments, an image of the material 508 may be provided to an artificial intelligence/machine learning classifier that has been (i) trained with images of materials having different colors, transparencies, and/or reflectivity measurements and (ii) configured to classify one or more of the color, transparency, and/or reflectivity of a material shown in an image.

In further scenarios, the one or more controllers associated with the laser CNC machine may additionally or alternatively determine the material type of the material 508 by taking several light intensity measurements at different heights (e.g., by moving the measurement assembly 510 up and down along the z-axis as described above), and applying a reflectivity variable to the measurements until the results from one or more (or all) of the emitter/detector pairs fall within an acceptable range.

In still further scenarios, the one or more controllers associated with the laser CNC machine may additionally or alternatively determine the material type of the material 508 by taking one or more intensity measurements from the emitter/detector pairs and comparing the values of the intensity measurements with stored values for various materials. And then, the one or more controllers can determine the material type based on the best “curve fit” between the measured intensity values and the stored values for the different materials, which in turn, enables the one or more controllers in some scenarios to also determine the distance between the measurement assembly 510 and the surface of the material 508, and by extension, the distance between the optical assembly 504 and the surface of the material 508.

After determining the material type of the material 508 to be processed, the one or more controllers are configured to determine a distance 590 between the optical assembly 504 and the surface of the material 508 to be processed by the laser CNC machine based on (a) one or more measurements at the one or more detectors 516 and 518 of the intensity of the light emitted from the one or more emitters 512 and 514 and reflected off the surface of the material 508 to be processed, and (b) one or more measurement parameters associated with the determined material type of the material 508. In some embodiments the measurement parameters associated with the determined material type may include one or more of (i) a reflectivity of the material type, (ii) an intensity response curve (described further below) associated with the material type, and/or (iii) a weight or other factor associated with the material type that can be used to weight or otherwise adjust an intensity response curve or an intensity measurement based on the material type.

Some embodiments include using a reflectivity adjustment factor corresponding to the material type, where different material types have different reflectivity adjustment factors. In operation, a set of reflectivity adjustment factors can be stored on the laser CNC machine or stored at a network-connected computing device/system for use in connection with height measurement. In scenarios where the reflectivity adjustment factors are stored on a network-connected computing device/system, the reflectivity adjustment factors may be obtained from the network-connected computing device/system for use in connection with the height measurement techniques described herein.

After identifying the material type, depending on the particular implementation, the reflectivity adjustment factor(s) can be applied to the emitters and/or detector hardware (e.g., a hardware-based adjustment) and/or the reflectivity adjustment factor(s) can be applied to the light intensity measurements obtained from the detectors (e.g., a software-based adjustment). The reflectivity adjustment factor(s) for some materials and/or implementations may be linear or nonlinear.

Some embodiments additionally include the one or more controllers associated with the laser CNC machine controlling the focusing of the laser beam 506 onto the surface of the material 508 based at least in part on the determined distance 590 between the optical assembly 504 and the surface of the material 508. In some embodiments, the one or more controllers are configured to control focusing of the laser beam 506 onto the surface of the material 508 based at least in part on the determined distance 590 between the optical assembly 504 and the surface of the material 508 while at least one of (i) the optical assembly 504 is moving relative to the surface of the material 508 and/or (ii) the surface of the material 508 is moving relative to the optical assembly 504.

In some embodiments, the one or more controllers are configured to control focusing of the laser beam 506 onto the surface of the material 508 based at least in part on the determined distance 590 between the optical assembly 504 and the surface of the material 508 without moving the measurement assembly 510 or the one or more emitters 512, 514 or the one or more detectors 516, 518 of the measurement assembly 510.

In some configurations, controlling the focusing of the laser beam 506 includes moving the optical assembly 504 closer to (or further from) the material 508 (or perhaps moving the material 508 closer to or further from the optical assembly 504). In some configurations, controlling the focusing of the laser beam 506 additionally or alternatively includes moving a lens 574 (or perhaps an array of lenses in some configurations) to focus the laser beam 506 onto the surface of the material 508.

v. Measuring the Distance Between the Optical Assembly and the Material

Using the distance 590 between the optical assembly 504 and the surface of the material 508 to control the focusing of the laser beam 506 onto the surface of the material 508 first requires determining the distance 590.

As mentioned above, one or more controllers associated with the laser CNC machine are configured to use one or more light intensity measurements from the measurement assembly 510 to determine the distance 590 between the optical assembly 504 and the surface of the material 508.

In operation, the detectors 516 and 518 are arranged to measure the intensity of light emitted by the emitters 512 and 514 that is reflected by the surface of the material 508. For example, and as shown in FIG. 5, detector 516 measures the intensity of (i) light 520′ which corresponds to the light 520 emitted by emitter 512 and reflected by the surface of the material 508 and (ii) light 524′ which corresponds to the light 524 emitted by emitter 514 and reflected by the surface of the material 508. Similarly, detector 518 measures the intensity of (i) light 522′ which corresponds to the light 522 emitted by emitter 512 and reflected by the surface of the material 508 and (ii) light 526′ which corresponds to the light 526 emitted by emitter 514 and reflected by the surface of the material 508.

Accordingly, in some embodiments, the one or more controllers are configured to determine the distance 590 between the optical assembly 504 and the surface of the material 508 to be processed by the laser CNC machine based on (a) one or more measurements of the intensity of the light emitted from the one or more emitters 512, 514 and reflected off the surface of the material 508 to be processed by the laser CNC machine, and (b) one or more measurement parameters associated with the determined material type by a process that includes the following steps in any combination or order of operation.

Using the detector 516, the one or more controllers obtain (i) one or more first intensity measurements of light 520′, which corresponds to light 520 emitted by emitter 512 and reflected off the surface of the material 508, and (ii) one or more second intensity measurements of light 524′, which corresponds to light 524 emitted by emitter 514 and reflected off the surface of the material 508. And using the detector 518, the one or more controllers obtain (i) one or more intensity measurements of light 522′, which corresponds to light 522 emitted by emitter 512 and reflected off the surface of the material 508, and (ii) one or more fourth intensity measurements of light 526′, which corresponds to light 526 emitted by emitter 514 and reflected off the surface of the material 508.

The one or more controllers determine the distance 590 between the optical assembly 504 and the surface of the material 508 to be processed by the laser CNC machine based on (i) the determined material type, (ii) the one or more first intensity measurements, (iii) the one or more second intensity measurements, (iv) the one or more third intensity measurements, and (v) the one or more fourth intensity measurements.

In some configurations, to enable the detectors 516 and 518 to distinguish between light originating from emitter 512 and light originating from emitter 514, the emitters 512 and 514 may be configured to emit light at different, non-overlapping time frames. For example, emitter 512 may be configured to emit light during a first timeframe during which emitter 514 is configured to not emit light, and emitter 514 may be configured to emit light during a second time frame during which emitter 512 is configured to not emit light. Some scenarios include switching the emitters 512 and 514 on and off in an alternating fashion so that the light detected by the detectors 516 and 518 during the first time frame corresponds to light emitted from emitter 512, while light detected by the detectors 516 and 518 during the second time frame corresponds to light emitted from emitter 514.

In other examples, to enable the detectors 516 and 518 to distinguish between light originating from emitter 512 and light originating from emitter 514, emitter 512 is configured to emit light having a different wavelength than the light emitted from emitter 514. For example, in some embodiments, emitter 512 is configured to emit light at a first wavelength and emitter 514 is configured to emit light at a second wavelength. And in such examples, detector 516 may comprise two individual detectors, where one detector is configured with a filter configured to pass the first wavelength and block the second wavelength, and where the other detector is configured to pass the second wavelength and block the first wavelength. Detector 518 may be similarly configured. For example, detector 518 may similarly include two detectors where one detector is configured with a filter configured to pass the first wavelength and block the second wavelength, and where the other detector is configured to pass the second wavelength and block the first wavelength.

In still other examples, the emitter 512 may be additionally or alternatively configured to emit light with a different on/off keying pattern than light emitted by emitter 514. For example, in some embodiments, emitter 512 is configured to emit light at a first on/off frequency and/or pattern and emitter 514 is configured to emit light at a second on/off keying frequency and/or pattern. And in such examples, detector 516 may include or be connected to circuitry that is configured to distinguish between (a) the first on/off keying frequency and/or pattern of light emitted by the first emitter 512 and (b) the second on/off keying frequency and/or pattern of light emitted by the second emitter 514.

Other methods or approaches sufficient for distinguishing between light emitted from different light sources could be used as well.

In some embodiments, the one or more controllers are configured to use a set of intensity response curves for each emitter-detector pair in connection with determining the distance 590 between the optical assembly 504 and the surface of the material 508. For example, in some embodiments, the one or more controllers may rely on (i) a first intensity response curve for emitter 512 and detector 516, (ii) a second intensity response curve for emitter 512 and detector 518, (iii) a third intensity response curve for emitter 514 and detector 516, and (iv) a fourth intensity response curve for emitter 514 and detector 518.

In some embodiments, the one or more controllers may use different sets of intensity response curves for different material types. For example, when the type of material 508 is wood, the one or more controllers may use a set of intensity response curves for wood to determine the distance 590 between the optical assembly 504 and material 508. But when the type of material 508 is glass, the one or more controllers may use a different set of intensity response curves for glass to determine the distance 590.

In other embodiments, the one or more controllers may use a common set of intensity response curves for some (or all) material types, but then adjust the response curves using material-specific weights or similar adjustment factors particular to different material types. In other embodiments, rather than adjusting the response curves based on the material type, the one or more controllers may instead use the common intensity response curves but then weight or otherwise adjust the values of the intensity measurements obtained from the emitters based on material-specific adjustment factors.

In some embodiments, the emitter masks 530, 540 and/or the detector masks 550, 560 are arranged so that individual straight-line paths of rays traced from the individual emitters will intersect individual straight-line paths of rays traced from the individual detectors at different points that are different distances from the optical assembly 504. In some configurations, these intersection points correspond to the maximum intensity of an individual emitter-detector intensity response curve.

For example, in FIG. 5, point “a” corresponds to the intersection where a straight-line ray extending from emitter 512 intersects with a straight-line ray extending from detector 516. The distance between the optical assembly 504 and point “a” is known because of the known geometric arrangement of the emitter mask 530 relative to the detector mask 550 within the measurement assembly 510 and the position of the optical assembly 504 relative to the measurement assembly 510 (and by extension, the position of the optical assembly 504 relative to the emitter mask 530 and the detector mask 550).

The intensity of the light 520′ measured by the detector 516 (corresponding to the light 520 emitted by emitter 512 and reflected by the surface of the material 508) is the strongest at point “a.” Intensity measurements of light 520′ that are lower than the highest intensity on the intensity response curve (corresponding to point “a”) correspond to positions of the material 508 that are different than point “a” (i.e., positions where the material 508 is closer to the optical assembly 504 than point “a” and positions where the material 508 is further from the optical assembly 504 than point “a”).

Just like point “a” corresponds to the highest intensity on the intensity response curve for the emitter-detector pair of emitter 512 and detector 516 in the manner described above, (i) point “b” corresponds to the highest intensity on the intensity response curve for the emitter-detector pair of emitter 514 and detector 516, (ii) point “c” corresponds to the highest intensity on the intensity response curve for the emitter-detector pair of emitter 514 and detector 518, and (iii) point “d” corresponds to the highest intensity on the intensity response curve for the emitter-detector pair of emitter 512 and detector 518.

In some embodiments, the emitter masks 530, 540 and detector masks 550, 560 are positioned geometrically with respect to each other within the measurement assembly 510 so that the intersection points (a, b, c, and d) are at different distances. Because the intersection points (a, b, c, and d) are at different distances, the differences between the corresponding intensity response curves are also known. These intensity response curve differences are shown in FIG. 5 as differences m, n, o, p, q, and r, where (i) difference m corresponds to the difference between intensity response curves a and b, (ii) difference n corresponds to the difference between intensity response curves b and c, (iii) difference o corresponds to the difference between intensity response curves b and d, (iv) difference p corresponds to the difference between intensity response curves a and c, (v) difference q corresponds to the difference between intensity response curves a and d, and (vi) difference r corresponds to the difference between intensity response curves c and d. Each distance where the material surface might be detected yields a unique signature of the signs and magnitudes of the differences m, n, o, p, q, and r. A lookup table of these unique signatures creates a mapping between the intensity response curves and distances to the material surface.

In some embodiments, the one or more controllers are configured to determine the distance 590 between the optical assembly 504 and the surface of the material 508 by obtaining intensity measurements of the reflected light 520′, 522′, 524′, and 526′ at detectors 516 and 518, and then comparing those intensity measurements with the set of intensity response curves for each of the emitter-detector pairs. By using the known intersection points a, b, c, and d of the intensity response curves (and their corresponding distance differences m, n, o, p, q, and r), the one or more controllers can estimate (e.g., via interpolation and/or table lookup) the distance 590 between the optical assembly 504 and the surface of the material 508 based on the set of intensity measurements. Some embodiments with more than four emitter-detector pairs (not shown) are able to collect more data points for interpolation, and thus create a finer-grained mapping, thereby providing greater accuracy.

In some configurations, the laser head 500 can be moved over different areas of the material 508 to determine the distance between the optical assembly 504 and the material 508 at different points on the surface of the material 508.

For example, in some configurations, the laser head 500 is movable in two dimensions (e.g., the x-axis and the y-axis) over the surface of the material 508. In other configurations, the laser head 500 is moveable in one dimension (e.g., the x-axis) over the surface of the material 508, and material 508 is moved in another dimension (e.g., the y-axis). In other configurations, the laser head 500 may stay in a fixed location/position, and the material 508 is moved in two dimensions (e.g., the x-axis and the y-axis). In still further configurations, the laser head 500 is moveable in two dimensions (e.g., the x-axis and the y-axis), and the material 508 is moved in one or two dimensions (e.g., the laser head 500 can be adjacent to the surface of the material 508, and the material can be rotated so as to cause the surface of the material to move relative to the laser head 500).

In some embodiments, the laser head 500 can be moved over the surface of the material 508 to generate a height map (or similar data structure) corresponding to the material. Such a height map (or similar data structure) can be useful when processing non-flat materials, materials having irregular shapes, materials that may have cut-out portions, or other scenarios where knowing the height of the material at many points along the surface of the material is advantageous for use in focusing the laser beam 506 onto the surface of the material 508.

### C. Example Flat Flex Cable for Laser Head Configurations

Returning to FIG. 3A, in some embodiments, the example laser head 300 also includes a circuit board 315 comprising circuitry for monitoring and/or controlling aspects of operating the laser head 300 and the components thereof. Some embodiments additionally include a heat sink 324 attached to the laser 304 via one or more heat sink mounts 322a and 322b. Air forced downward from the fan 314 and into the laser enclosure 302 flows across the heat sink 324 to cool the laser 304 during operation.

The circuit board 315 is equipped with a cable connector 317 that is configured to connect the circuit board 315 to a cable via an opening 334 in one side 310b of the laser enclosure 302. In operation, the cable provides power and control signaling to the circuit board 315 of the laser head 300 to facilitate the monitoring and/or controlling of the laser head 300.

In some embodiments, the cable providing power and control signaling to the circuit board 315 of the laser head 300 includes a flat flexible cable comprising a metallic outer cover covering at least a portion of the flat flexible cable. In operation, at least a portion of the flat flexible cable is configured to (i) magnetically attach to a magnetic surface (e.g., magnetic surface 610 shown in FIG. 6A) on one interior wall of the housing when the laser head moves towards the one interior wall and (ii) magnetically detach from the magnetic surface when the laser head moves away from the one interior wall.

For example, FIG. 6A depicts an interior view of an example laser CNC machine 600 with the lid open with an example flat flexible cable 608 configured to magnetically attach to and detach from a magnetic surface 610 on one interior wall of the housing consistent with some disclosed embodiments. In some embodiments, the magnetic surface 610 is positioned at an incline or slant in a recess within the exhaust vent 612 such that the recess depth is greater at the end where the magnetic surface 610 exits the interior wall of the CNC machine.

In FIG. 6A, the laser head 618 moves from side-to-side along the x-axis via a joining assembly (not shown in FIG. 6A), and the joining assembly moves from front-to-back along the y-axis via rails 620a and 620b, thereby enabling the laser CNC machine to position the laser head 618 and focus the laser at points within an x-y plane over the material 622 laying on the material bed 624. An exhaust vent 612 on the rear interior wall of the laser CNC machine includes a magnetic surface 610 that is configured to help manage cable slack of the flat flexible cable 608. However, in other embodiments, the magnetic surface 610 may be located in a different location (e.g., on a different interior wall) of the laser CNC machine.

As the laser head 618 moves closer to the rear interior wall of the laser CNC machine, the flat flexible cable 608 magnetically attaches to the magnetic surface 610. And as the laser head 618 moves away from the rear interior wall of the laser CNC machine, the flat flexible cable 608 magnetically detaches from the magnetic surface 610. To facilitate the magnetic attaching and detaching of the flat flexible cable 608 to and from the magnetic surface 610 as the laser head 618 moves toward and away from the interior wall of the laser CNC machine, the flat flexible cable 608 is rigid along a first axis (but flexible along a second axis perpendicular to the first axis) and has one or more pre-configured folds that enable the cable to flex and fold in a predictable and managed way.

For example, in FIG. 6A, the flat flexible cable 608 is rigid along the y-axis but flexible along the x-axis. Similarly, flat flexible cable 608 has (i) a first pre-configured fold 626a near where the flat flexible cable 608 exits from the interior wall of the laser CNC machine, where the pre-configured fold 626a tends to cause the flat flexible cable 608 to fold toward the magnetic surface 610, and a (ii) a second pre-configured fold 626b that tends to cause the flat flexible cable 608 to fold back onto itself.

Managing cable slack of the flat flexible cable 608 during operation of the laser CNC machine via the combination of the magnetic surface 610 on the interior wall and the structure of the flat flexible cable 608 (including the rigidity along one axis, the pre-configured folds 626a, 626b, and the metallic outer covering) in the manner described herein provides improvements over prior approaches by keeping the flat flexible cable 608 both (i) out of the way of the laser head 618 as the laser head moves during operation and (ii) above the material bed 624 and away from the material 622 being machined, thereby avoiding both (a) the flat flexible cable 608 causing accidental movement of the material 622 being machined and (b) the flat flexible cable 608 being accidentally damaged by the laser beam emitted from the laser head 618.

### D. Example Lid Camera Assembly Configurations

As mentioned previously, FIG. 6A depicts an interior view of an example laser CNC machine 600. As shown in the FIG. 6A, the laser CNC machine includes an openable lid 601 that is open to reveal an interior view of the laser CNC machine 600.

In operation, the openable lid 601 can be opened so that the material 622 to be machined by the laser CNC machine can be placed on the material bed 624. The openable lid 601 can be closed before machining the material 622 with the laser via the laser head 618.

In some embodiments, the openable lid 601 includes a top portion 602 and a side portion 603 extending downward from the top portion 602. In some embodiments, the openable lid 601 has an orange or tangerine color that blocks laser light emitted from the laser. Other aspects of the laser CNC machine are shown in U.S. application Ser. No. 29/870,642, titled “Desktop Fabricator,” filed on Feb. 1, 2023, and currently pending. The entire contents of U.S. application Ser. No. 29/870,642 are incorporated herein by reference.

For example, for laser CNC machines that use lasers having blue wavelengths, the openable lid 601 may be formed from at least two layers. The openable lid 601 has many features similar to the protective lid described in U.S. application Ser. No. 17/967,850, titled “Enclosure with Selective Wavelength Transmissivity for Computer Numerically Controlled Fabrication,” filed on Oct. 17, 2022, and currently pending. The entire contents of U.S. application Ser. No. 17/967,850 are incorporated herein by reference

FIG. 6B shows an example embodiment of some aspects of the openable lid 601 depicted in FIG. 6A. The openable lid 601 embodiment shown in FIG. 6B is formed from two layers, including a top layer 650 and a bottom layer 651. The top layer 650 (FIG. 6B) includes an outer portion 602a (FIG. 6B) of the top portion 602 (FIG. 6A) and an outer portion 603a (FIG. 6B) of the side portion 603 (FIG. 6A). The bottom layer 651 (FIG. 6B) includes an inner portion 602b (FIG. 6B) of the top portion 602 (FIG. 6A) and an inner portion 603b (FIG. 6B) of the side portion 603 (FIG. 6A).

In some embodiments, the top layer 650 may be formed from a clear-colored transparent material, the bottom layer 651 may be formed from a clear-colored transparent material, and an orange-colored transparent material layer may be disposed between the top layer 650 and the bottom layer 651 to block the laser light emitted by the laser during operation of the laser CNC machine. Implementing the orange-colored transparent material layer between a clear-colored transparent top layer 650 and a clear-colored transparent bottom layer 651 in some embodiments allows the top to appear to “glow” while the laser is in operation.

The top layer 650 includes a lip 640 that facilitates opening and closing the openable lid 601. In some instances, the shape of the lip 640 may make placing material into the laser CNC machine more inviting, rather than the feeling of placing material into a box which would have a more claustrophobic feeling for the material.

In the example depicted in FIG. 6B, the top layer 650 comprises a 1-3 millimeter thick layer of an orange-colored transparent material capable of filtering out blue wavelengths, and the bottom layer 651 is formed from a transparent material having a color different from the orange color of the top layer 650. For example, the bottom layer 651 may comprise a 1-3 millimeter thick layer of a blue-colored transparent material that at least in part offsets the orange color of the top layer 650 so achieve a desired visual appearance of the openable lid 601. In some embodiments, the openable lid 601 has many features similar to the protective lid described in U.S. application Ser. No. 17/967,850, titled “Enclosure with Selective Wavelength Transmissivity for Computer Numerically Controlled Fabrication,” filed on Oct. 17, 2022, and currently pending. The entire contents of U.S. application Ser. No. 17/967,850 are incorporated herein by reference.

When the openable lid 601 is closed, the side portion 603 joins at least a portion of one side of the housing to form the interior space of the laser CNC machine. In some embodiments, the openable lid 601 is at least partially formed from or at least includes a transparent material that both (i) passes visible light, thereby allowing a user to see inside the interior space of the laser CNC machine while the openable lid 601 is closed, and (ii) blocks laser light emitted from the laser.

As mentioned above, the openable lid 601 in some embodiments includes a lid camera assembly 604 that houses a camera. In some embodiments, the lid camera assembly 604 is connected to a main processor board of the laser CNC machine via a flat flex cable assembly 606 incorporated into the openable lid 601 of the laser CNC machine.

FIG. 6C depicts a cutaway top view of the interior of the housing of the example laser CNC machine 600 shown in FIG. 6A, and in particular, the interior of the housing 628 of the laser CNC machine 600 behind the exhaust vent 612 on the rear interior wall of the laser CNC machine 600 according to some embodiments.

The interior of the housing 628 of the laser CNC machine 600 behind the exhaust vent 612 on the rear interior wall of the laser CNC machine 600 includes (i) a control compartment 660, (ii) power compartment 662, and (iii) an exhaust compartment (sometimes referred to as an exhaust chamber) 664. The exhaust compartment is connected to an exhaust port 676 on the rear of the laser CNC machine 600. FIG. 6C shows a portion of the flat flexible cable 608 shown and described in more detail with reference to FIG. 6A.

A first interior barrier 668a separates the control compartment 660 from the exhaust compartment 664, and a second interior barrier 668b separates the power compartment 662 from the exhaust compartment 664. The interior barriers 8a, 668b keep debris that passes through the exhaust compartment 664 from getting into the control compartment 660 and the power compartment 662 so as to avoid exhaust and/or debris from damaging or otherwise affecting the operation of the components contained in the control compartment 660 and the power compartment 662.

In some embodiments, the control compartment 660 includes a control module 670 which includes (i) one or more printed circuit boards, (ii) one or more processors, (iii) tangible, non-transitory computer-readable memory, (iv) one or more network interfaces (e.g., wired and/or wireless), and/or (v) one or more sensors configured to monitor the operation of the laser CNC machine and/or the operation of the control module 670 and/or control compartment 660. In some embodiments, the one or more sensors include, for example, an infrared sensor facing through an opening on the back panel of the interior wall of the laser CNC machine.

In some embodiment, the power compartment 662 includes power module 672 which includes (i) one or more printed circuit boards, (ii) one or more power supplies, and/or (iii) one or more sensors configured to monitor, among other functions, operational aspects of the power module 672 and/or power compartment 662.

In some embodiments, the exhaust compartment 664 includes an exhaust module 674 which includes (i) one or more fans, and (ii) one or more sensors configured to monitor, among other functions, operational aspects of the exhaust module 674 and/or exhaust compartment 664. In some embodiments, the one or more sensors in the exhaust compartment 664 include, for example, (i) one or more flow rate sensors configured to measure air flow rate of exhaust flowing through the exhaust compartment 664, (ii) one or more current sensors configured to measure current drawn by the one or more fans in the exhaust compartment 664, and/or (iii) one or more temperature sensors configured to measure the temperature of exhaust gas flowing through the exhaust compartment 664.

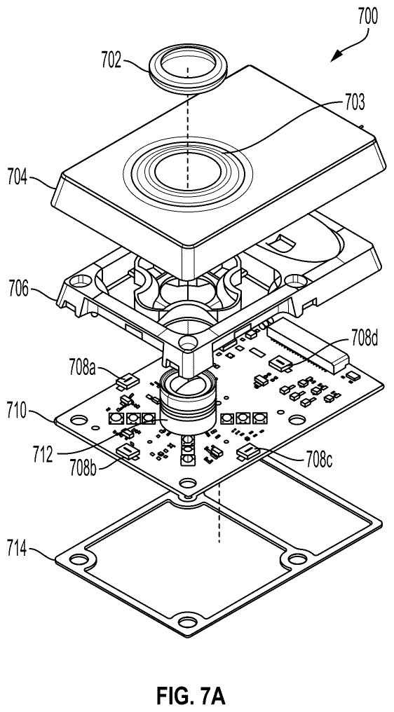

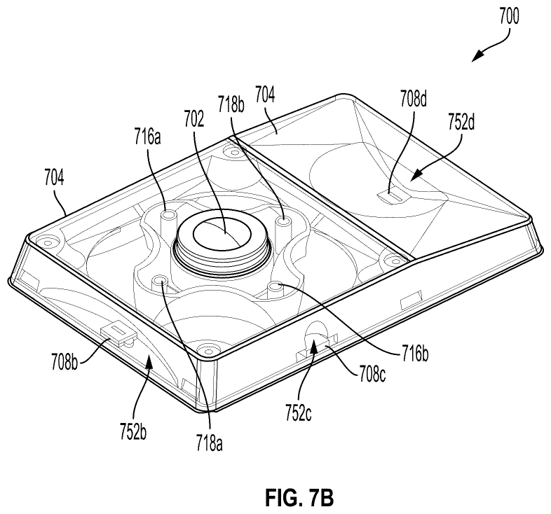

FIG. 7A depicts an exploded view of an example lid camera assembly 700 according to some disclosed embodiments. FIG. 7B depicts aspects of the example lid camera assembly 700 of FIG. 7A according to some disclosed embodiments. The lid camera assembly 700 shown in FIGS. 7A and 7B is similar to or the same as lid camera assembly 604 (FIG. 6A).

The lid camera assembly 700 includes a lens cap 702, a diffuser 704, a reflector 706, a printed circuit board 710, a camera 712, and a gasket 714. In some embodiments, the camera 712 is mounted on the printed circuit board 710.

In some embodiments, the lens cap 702 provides protection for the lens of the camera 712 from dust, debris, and other elements that may result from the cutting/etching process. In some embodiments, the lens cap 702 includes a lens (e.g., fisheye lens) that alters the view (e.g., provides a wide-angle view) for the camera 712. In some embodiments, the camera 712 comprises a fisheye lens that provides a wide-angle view. A wide-angle view is required in some embodiments so that the camera 712 within the lid camera assembly 700 can obtain an image of the entire material bed when the openable lid 601 (FIG. 6A) is closed and pointing downward onto the material bed inside of the laser CNC machine.

In some embodiments where the camera 712 or lens cap 702 includes a fisheye lens, the image obtained by the camera 712 may need to be “dewarped” to obtain a more natural-looking image of the material bed (and the material placed thereon). In operation, the images obtained by the camera 712 via the fisheye lens are “dewarped” via software image processing. To perform the dewarping, the camera 712 in some embodiments is calibrated at the factory during manufacture and/or quality control and inspection prior to shipping the laser CNC machine to a wholesaler, retailer, or end consumer. After calibrating the camera 712, the calibration information can be stored locally in memory on the laser CNC machine and/or in a cloud computing system. The calibration information in some instances can be used to facilitate the software dewarping image processing function.

Some embodiments may additionally or alternatively include field calibration of the camera 712. In such embodiments, the field calibration can be based on one or more fiducials appearing on the inside surface of the laser CNC machine, such as fiducials 816a and 816b (FIG. 8A). In operation, images of the fiducials 816a, 816b captured by the camera 712 through the fisheye lens of the lens cap 702 can be compared to one or more reference images of the fiducials 816a, 816b (e.g., reference images taken during a calibration procedure at the factory that are stored locally or stored in a cloud computing system and retrieved for comparison). The translation required to convert the images of the fiducials 816a, 816b captured by the camera 712 through the fisheye lens to be a close approximation of the reference images of the fiducials 816a, 816b can be used for dewarping other images captured by the camera 712 via the fisheye lens of the lens cap 702. Having a field-calibration capability may be useful in scenarios where (i) the lens cap 702 supports the removal and installation of different lenses, perhaps for different applications, (ii) the lens cap 702 can be removed for cleaning and then replaced afterwards.

After calibration (in the factory and/or in the field), images obtained by the camera 712 via the fisheye lens can be used for a variety of purposes, including but not limited to, for example: (i) identifying materials placed in the laser CNC machine by, for example, (a) reading a visible QR code, bar code, or other information from the surface of the material, (b) reading a UV QR code, bar code, or other information from the surface of the material after illuminating the material with one or more UV lights (e.g., UV LEDs); (ii) implementing designs on the surface of materials placed on the material bed in the laser CNC machine; (iii) monitoring the laser during operation; (iv) determining the status of one or more elements of the laser CNC machine such as, for example, (a) determining if the head is in properly mounted; (b) determining if the lid is closed; (c) determining if the material bed is in place, (d) and so forth; and/or (v) any other function for where it would be useful to have good quality images of the material placed within the laser CNC machine.

In some embodiments, one or more infrared sensors 708a, 708b, 708c, and 708d are also mounted on the printed circuit board 710. In operation, the infrared sensors 708a, 708b, 708c, and 708d are configured to detect flames (or other anomalies) within the interior space of the laser CNC machine.

In embodiments that include infrared sensors 708a-d, the infrared sensors 708a-d are mounted on the printed circuit board 710, but outside of the diffuser 704. For example, FIG. 7B shows the infrared sensors 708b, 708c, and 708d located in openings 752b, 752c, and 752d, respectively. In the example depicted in FIG. 7B, the diffuser 704 does not obscure the openings 752b, 752c, and 752d so that the infrared sensors 708b, 708c, and 708d located in openings 752b, 752c, and 752d, respectively, are likewise not obscured by the diffuser 704.

In some embodiments, upon detecting flames (or other anomalies) via the infrared sensors 708a-d, the laser CNC machine is configured to (i) at least temporarily halt operation of the laser and/or (ii) alert a user to the detected flames (or other anomalies).

Some embodiments additionally or alternatively include one or more visible light emitting diodes (LEDs) 716a, 716b arranged behind the diffuser 704. In operation, the one or more visible LEDs 716a-b are configured to emit visible light and illuminate the interior space of the laser CNC machine. In some embodiments, the visible light LEDs 716a, 716b are configured to selectively operate in both (i) a normal intensity mode when the openable lid 601 (FIG. 6A) is closed during operation of the laser, and (ii) a low intensity mode when one or both of (a) the openable lid 601 (FIG. 6A) is opened or (b) the laser CNC machine has entered a sleep mode. In some embodiments, the visible light LEDs 716a, 716b may be configured to selectively operate in additional modes such as, for example, additional operational modes, error modes, and the like.

With respect to the sleep mode, in some embodiments, the laser CNC machine is configured to enter into the sleep mode after some period of inactivity. While the laser CNC machine is in the sleep mode, the laser CNC machine is configured to exit the sleep mode in response to detecting any of (i) opening the openable lid 601 (FIG. 6A), (ii) press of a user interface button 103 (FIGS. 1A-1C) on the laser CNC machine, and/or (iii) receipt of a command, such as a command from a controller (e.g., any of controllers 210a-c shown in FIG. 2), a voice command (e.g., received from a microphone on the laser CNC machine or from a microphone on a network connected device such as a client device 230 shown in FIG. 2 or a network connected microphone), or any other type of command.

In some embodiments, the diffuser 704 contains one or more patterns 703 (e.g., lines, stripes, circles, or similar patterns) around the lens cap 702 over the camera 712. The patterns 703 on the diffuser 704 are arranged to help produce even light from the LEDs 716a-b and avoid bright spots around the camera 712 that could, at least in some instances, affect the quality of the images obtained via the camera 712. In some embodiments, the one or more patterns 703 (e.g., lines, stripes, circles, or similar patterns) around the lens cap 702 over the camera 712 include patterns silkscreened onto the surface of the diffuser 704.

In some embodiments, the lid camera assembly 700 additionally or alternatively includes one or more ultraviolet light emitting diodes (UV LEDs) 718a, 718b configured to emit ultraviolet light and illuminate UV-printed information on materials placed on the material bed within the interior space of the laser CNC machine, as mentioned previously.

In some embodiments, the lid camera assembly 700 additionally or alternatively includes (i) one or more temperature sensors and/or (ii) one or more light sensors.

In some embodiments, the temperature sensors can be used to monitor the operating temperature of the interior of the laser CNC machine, and in some instances, temporarily pause execution of a project when the measured temperature exceeds a threshold temperature level for some duration of time. After the temperature has fallen to below the threshold temperature level and remained below the threshold level for some duration of the time, the laser CNC machine can resume execution of the project.

Some embodiments include using sensor data from several sensors to determine whether to temporarily pause execution of a project. For example, in some embodiments, the laser CNC machine may decide to pause execution of a project based on sensor data from any one or more (or all) of (i) one or more temperature sensors, (ii) one or more infrared sensors, (iii) one or more air sensors, and/or (iv) other sensors.

For example, temperature sensors can determine the current temperature inside of the laser CNC machine, the current operating temperature of the laser, the current temperature of the laser head heat sink, and the temperature of the exhaust generated by the laser CNC machine. Infrared sensors can detect fire or other sources of heat. Air sensors can detect certain fumes or particulates indicative of dangerous operation. Cameras can similarly detect fire or other potentially unsafe operating conditions. In some embodiments, the laser CNC machine is configured to use sensor fusion techniques to determine whether to temporarily pause execution of a project based on sensor data from any one or more of the above-listed sensors.

Temporarily pausing execution of a project (which includes pausing operation of the laser) and allowing the interior of the laser CNC machine to cool down before resuming execution of the project can help to prevent damage to the laser that can be caused by prolonged operation at elevated temperature levels or other dangerous conditions, e.g., fire, excess smoke or fumes, or other conditions that might pose an unsafe operating scenario or potentially cause damage to the laser and other components of the laser CNC machine. Preventing damage to the laser and other components of the laser CNC machine helps both with extending the usable operating life of the laser CNC machine and avoiding a scenario where a damaged laser or other components poses a potential safety risk to end users.

Some embodiments of the lid camera assembly 700 may additionally or alternatively include one or more infrared (IR) and/or other wireless transmitters and receivers that can be used to interface with other components that may use IR communications, such as sensors, controllers, or other IR and/or other wireless-equipped components.

### E. Example Safety Mechanisms and Features

Because lasers can be dangerous while in operation, it is important for the laser CNC machine to keep the laser light emitted from the laser inside the interior space of the laser CNC machine and directed at the material for processing. Therefore, some embodiments include safety mechanisms and features including, for example, one or more (or all) of: (i) determining whether the openable lid is properly closed before and/or during operation of the laser, and preventing, halting, or otherwise disabling operation of the laser after determining that the openable lid is not properly closed; (ii) implementing one or more safety curtains at one or more material passthrough openings in the housing of the laser CNC machine, where the one or more safety curtains are arranged to block laser light from exiting through the one or more material passthrough openings both (a) while material is inserted through the one or more material passthrough openings and (b) while no material is inserted through the first material passthrough opening; (iii) using a material bed that is arranged allow laser light that penetrates the material positioned on the material bed to pass through the material bed and hit the interior floor of the housing of the laser CNC machine rather than reflecting back towards the laser head or elsewhere in the interior space of the laser CNC machine; and/or (iv) determining whether the laser head is properly mounted before and/or during operation of the laser, and preventing, halting, or otherwise disabling operation of the laser after determining that the head is not properly mounted.

i. Deactivating the Laser Based on Determining that the Lid is not Properly Closed

In some embodiments, the laser CNC machine is configured to determine whether the openable lid 601 is properly closed based at least in part on one or more of: (i) one or more images of one or more interior wall fiducials 816a, 816b (FIG. 8A) captured by the camera 712 (FIG. 7A) of the lid camera assembly 700 (FIG. 7A), where at least one interior wall 814 (FIG. 8A) of the housing comprises the one or more interior wall fiducials 816a, 816b (FIG. 8A), (ii) one or more measurements from one or more hall sensors 614a, 614b (FIG. 6A) on the housing 628 (FIG. 6A), where the one or more hall sensors 614a, 614b (FIG. 6A), are arranged to detect one or more corresponding magnets 616a, 616b (FIG. 6A) on the openable lid 601 (FIG. 6A), and/or (iii) one or more accelerometer measurements from a three-axis accelerometer in the lid camera assembly 604 (FIG. 6A), such as a three-axis accelerometer mounted on the printed circuit board 710 (FIG. 7A) of the lid camera assembly 700 (FIG. 7A).

In some embodiments, the laser CNC machine is configured to deactivate the laser in response to determining that the openable lid 601 is not properly closed. In operation, deactivating the laser may include (i) preventing the laser from starting a fabrication job and/or (ii) halting the operating of the laser during execution of a fabrication job.

For example, with reference to FIG. 8A, some embodiments include one or more interior wall fiducials 816a, 816b located on an interior wall 814 of the laser CNC machine. In the example shown in FIG. 8A, the interior wall fiducials 816a, 816b are positioned on the interior wall opposite the exhaust vent 612 on the rear interior wall of the laser CNC machine that includes the magnetic surface 610 configured to help manage cable slack of the flat flexible cable 608 (FIGS. 6A, 6C). However, in other embodiments, the interior wall fiducials 816a, 816b may be on any other interior wall or fixed component of the laser CNC machine.

In some embodiments that include the laser CNC machine determining whether the openable lid 601 is properly closed based on one or more images of one or more interior wall fiducials 816a, 816b (FIG. 8A) captured by the camera 712 (FIG. 7A) of the lid camera assembly 700 (FIG. 7A), the laser CNC machine is configured to compare data from an image of the one or more interior wall fiducials 816a, 816b (FIG. 8A) captured by the camera 712 (FIG. 7A) with data from one or more reference images. The one or more references images correspond to one or more images of the one or more interior wall fiducials 816a, 816b (FIG. 8A) captured by the camera 712 (FIG. 7A) when the openable lid 601 (FIG. 6A) is properly closed. The reference images may be captured in a controlled environment such as, for example during a manufacturing process or a quality assurance procedure, and/or it may be captured in the field during a calibration procedure. In either case, the reference images may be stored locally on the laser CNC machine and/or stored remotely on a cloud server for retrieval by a controller associated with the laser CNC machine for comparison purposes.

In some embodiments, the one or more reference images comprise at least one image captured during manufacture of the laser CNC machine, or perhaps shortly after manufacture of the laser CNC machine. For example, the one or more reference images in some instances include at least one image of the one or more interior wall fiducials 816a, 816b taken by the camera 712 (FIG. 7A) within the lid camera assembly 700 (FIG. 7A), 604 (FIG. 6A) while the openable lid 601 (FIG. 6A) is properly closed before the laser CNC machine is shipped from the laser CNC machine manufacturing factory. In such a scenario, one or more reference images may be acquired during any one or more of (i) manufacture of the laser CNC machine, (ii) quality control inspection of the laser CNC machine, and/or (iii) any other time before the laser CNC machine is shipped from the manufacturer to a wholesaler, retailer, or end consumer.

In some embodiments, the one or more reference images additionally or alternatively include at least one image of the one or more interior wall fiducials 816a, 816b taken by the camera 712 (FIG. 7A) within the lid camera assembly 700 (FIG. 7A), 604 (FIG. 6A) while the openable lid 601 (FIG. 6A) is properly closed after an end consumer has received the laser CNC machine. In such a scenario, one or more reference images may be acquired during any one or more of (i) an initial calibration procedure performed by the end consumer when first setting up the laser CNC machine, (ii) a startup procedure performed by the end consumer after powering on the laser CNC machine, and/or (iii) any other time during operation of the laser CNC machine.

In some examples, the one or more reference images include (i) at least one reference image captured before the manufacturer ships the laser CNC machine to the wholesaler, retailer, and/or end consumer and (ii) at least one reference image captured after the end consumer has received the laser CNC machine, e.g., during an initial calibration and setup process.

Regardless of when, where, or how the one or more reference images are initially obtained, by comparing the captured image with the one or more reference images, the laser CNC machine can confirm whether the openable lid 601 is properly closed based on the extent to which the interior wall fiducials 816a, 816b on the captured image align with the interior wall fiducials 816a, 816b in the reference image.

For example, if the interior wall fiducials 816a, 816b appearing in the captured image align with the interior wall fiducials 816a, 816b appearing in the reference image to within a threshold amount, then the laser CNC machine can conclude that the openable lid 601 is properly closed. But if the interior wall fiducials 816a, 816b appearing in the captured image are out of alignment with the interior wall fiducials 816a, 816b appearing in the reference image by more than some threshold amount, then the laser CNC machine can conclude that the openable lid 601 is not properly closed.

In some embodiments, the laser CNC machine can additionally or alternatively use the one or more fiducial markers 804 on the laser head 806 (FIG. 8A) to confirm that the openable lid 601 is properly closed. In operation, the laser CNC machine can use the fiducial marker(s) 804 on the laser head 806 to determine whether the openable lid 601 is properly closed in much the same way that the laser CNC machine can use the interior wall fiducials 816a, 816b to determine whether the openable lid 601 is properly closed. For example, the laser CNC machine can compare data from one or more captured images of the fiducial marker(s) 804 on the laser head 806 with data from one or more reference images of the fiducial marker(s) 804 taken when the openable lid 601 was properly closed. If the fiducial marker(s) 804 appearing in the captured image align with the fiducial marker(s) 804 appearing in the reference image to within a threshold amount, then the laser CNC machine can conclude that the openable lid 601 is properly closed. But if the fiducial marker(s) 804 appearing in the captured image are out of alignment with the fiducial marker(s) 804 appearing in the reference image by more than some threshold amount, then the laser CNC machine can conclude that the openable lid 601 is not properly closed.

Some embodiments may additionally or alternatively use other methods to confirm that the openable lid 601 is properly closed instead of or in addition to comparing a captured image of the interior wall fiducials 816a, 816b (and/or fiducial marker(s) 804 on the laser head 806) with the reference image of the interior wall fiducials 816a, 816b (and/or fiducial marker(s) 804 on the laser head 806) described above.

For example, some embodiments may additionally or alternatively determine whether the openable lid 601 is properly closed based at least in part on one or more measurements from one or more hall sensors 614a, 614b (FIG. 6A) on the housing 628 (FIG. 6A), where the one or more hall sensors 614a, 614b (FIG. 6A), are arranged to detect one or more corresponding magnets 616a, 616b (FIG. 6A) on the openable lid 601 (FIG. 6A).

The example shown in FIG. 6A depicts two hall sensors 614a, 614b on two opposite sides of the housing of the laser CNC machine, e.g., the left and right sides. Other embodiments may include only a single hall sensor on one side of the laser CNC machine. Still other embodiments may include two or more hall sensors on each of the left and/or right sides of the laser CNC machine housing. Other embodiments may additionally or alternatively include hall sensors on the front and/or back sides of the laser CNC machine.

In operation, the hall sensors 614a, 614b are configured to detect the presence of corresponding magnets (or magnetic material) 616a, 616b within the openable lid 601. For example, in some embodiments, the laser CNC machine can conclude that the openable lid 601 is properly closed when hall sensor 614a detects the presence of magnet 616a and hall sensor 614b detects the presence of magnet 616b. When the hall sensors 614a, 614b detect the presence of the corresponding magnets 616a, 616b in the openable lid 601, the laser CNC machine can conclude that the openable lid 601 is closed. And when the hall sensors 614a, 614b fail to detect the presence of the corresponding magnets 616a, 616b in the openable lid 601, the laser CNC machine can conclude that the openable lid 601 is not closed.

Further, some embodiments may additionally or alternatively determine whether the openable lid 601 is properly closed based at least in part on one or more accelerometer measurements from a three-axis accelerometer in the lid camera assembly 604 (FIG. 6A), such as a three-axis accelerometer mounted on the printed circuit board 710 (FIG. 7A) of the lid camera assembly 700 (FIG. 7A).

For example, a three-axis accelerometer in the lid camera assembly 604 can detect its orientation in space. Measurements from a three-axis accelerometer within the lid camera assembly 604 can indicate whether the lid camera assembly 604 is facing downward (thus suggesting that the openable lid 601 is closed) and whether the lid camera assembly is not facing downward (thus suggesting that the openable lid 601 is not closed).

In some embodiments, the laser CNC machine is configured to determine whether the openable lid 601 is properly closed based on a combination of several measurements. For example, some embodiments may include determining that the openable lid 601 is properly closed based on a combination of (i) determining that the hall sensors 614a, 614b detect the corresponding magnets 616a, 616b in the openable lid 601, (ii) the interior wall fiducials 816a, 816b appearing in the captured image align with the interior wall fiducials 816a, 816b appearing in the reference image to within the threshold amount, (iii) one or more fiducial markers 804 on the laser head 806 (FIG. 8A), and (iv) one or more three-axis accelerometer measurements suggesting that the openable lid 601 is closed. Determining that the openable lid 601 is properly closed based on a combination of measurements can help improve safety by providing multiple checkpoints to confirm that openable lid 601 is properly closed.

ii. Safety Curtains to Block Laser Light at Material Passthrough Openings

Another safety feature of some embodiments includes safety curtains (sometimes referred to herein simply as curtains) that are configured to prevent laser light from escaping through material passthrough openings in the housing of the laser CNC machine.

As mentioned above, laser CNC machines according to some embodiments include one or more material passthrough openings in the housing of the laser CNC machine to facilitate processing of material that may be too large to be placed inside the laser CNC machine from the top. For example, some material may be wider than the laser CNC machine such that the material will not fit into the top of the laser CNC machine. To accommodate such material, some embodiments have material passthrough openings on the side of the laser CNC machine that allow the material to be pushed through the material passthrough opening and into the interior space of the laser CNC machine so that the laser head 618 can apply the laser to the material.

FIG. 9A depicts aspects of an example laser CNC machine 900 with a door 902 that opens to reveal a material passthrough opening in one side of the laser CNC machine 900 according to some disclosed embodiments. FIG. 9B depicts aspects of the example laser CNC machine 900 of FIG. 9A with the door 902 opened to reveal the material passthrough opening 904 in the side of the laser CNC machine 900 according to some disclosed embodiments.

Although FIG. 9A and FIG. 9B depict a single door 902 and a single material passthrough opening 904 on one side of the laser CNC machine 900, some embodiments may include one or more additional material passthrough openings on one or more other sides of the laser CNC machine 900. Similarly, while the material passthrough opening in the example embodiment depicted in FIG. 9A is a short and wide material passthrough opening, other embodiments may include material passthrough openings have different dimensions, including material passthrough openings that may be shorter or taller and/or wider or narrower than the material passthrough opening 904 depicted in FIG. 9B.

In the example depicted in FIG. 9B, a first material passthrough opening 904 in the housing is positioned on a first side of the housing of the laser CNC machine 900. In some such embodiments, the first material passthrough opening 904 includes at least a first curtain positioned in or proximate to the first material passthrough opening 904 and arranged to block laser light from exiting through the first material passthrough opening 904, including blocking laser light from exiting through the material passthrough opening 904 while material is inserted through the first material passthrough opening 904.

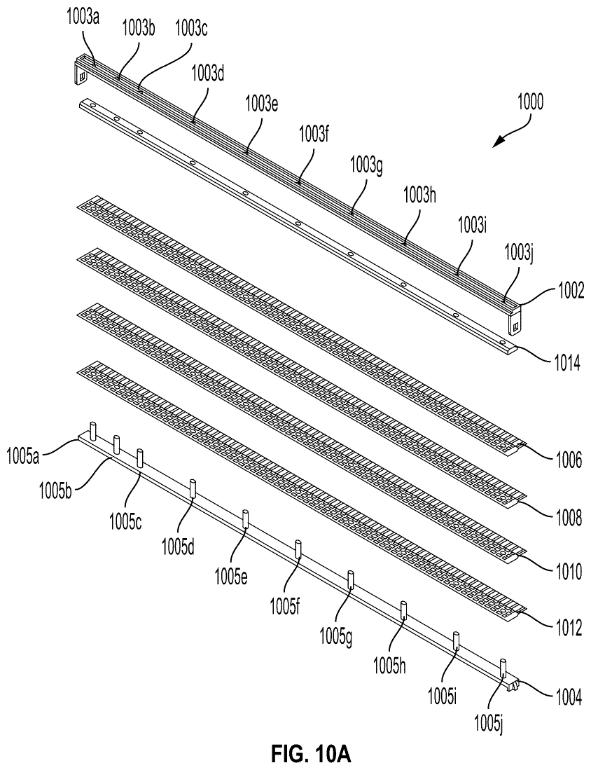

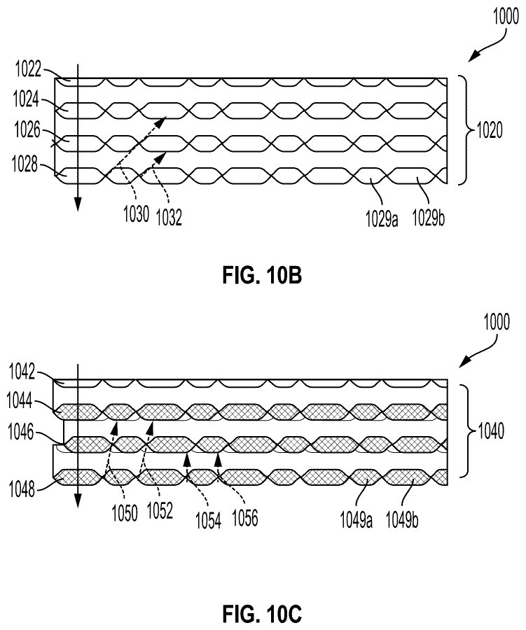

FIG. 10A depicts an exploded view of an example curtain 1000 configured to block laser light from exiting through the example material passthrough opening 904 depicted in FIG. 9B according to some disclosed embodiments.

The example curtain 1000 includes (i) a passthrough curtain frame receiver 1002 with a plurality of receiving holes 1003a-j, (ii) a passthrough curtain frame base with a plurality of pins 1005a-j extending upward therefrom, (iii) a first curtain layer 1006, (iv) a second curtain layer 1008, (v) a third curtain layer 1010, (vi) a fourth curtain layer 1012, and (vi) a curtain spacer 1014. The plurality of pins 1005a-j are configured to extend upward through corresponding holes in the curtain layers 1006-1012 and curtain spacer 1014, and into the receiving holes 1003a-j in the passthrough curtain frame receiver 1002 to hold the example curtain 1000 together. Each of the first curtain layer 1006, second curtain layer 1008, third curtain layer 1010, and fourth curtain layer 1012 include an array of resilient members. In some embodiments, the curtain layers 1006-1012 are color-coded to aid in assembly of the curtain 1000 during manufacturing.

In some embodiments, the resilient members comprise resilient silicone fingers. However, in other embodiments, the resilient members may take other forms that are suitably flexible to allow material to be inserted into the material passthrough opening 904 (FIG. 9B) and suitably resilient to spring back to shape when not in contact with material within the material passthrough opening 904.

FIG. 10B depicts an overhead view of a portion of the example curtain 1000 depicted in FIG. 10A that shows an example array 1020 of resilient members configured to block laser light according to some disclosed embodiments. The example curtain 1000 includes an array 1020 of resilient members formed from four rows 1022, 1024, 1026, and 1028. The four rows 1022-1028 in FIG. 10B are formed from the curtain layers 1006-1012 shown in FIG. 10A. Each of the four rows 1022-1028 comprises a separate row of resilient members. The bold arrow on the left side of FIG. 10B shows the direction of travel of material that is inserted through the curtain 1000 and into the material passthrough opening 904 (FIG. 9B).

In the example embodiment shown in FIG. 10B, each row of resilient members includes resilient members of at least two different dimensions. For example, row 1028 includes resilient members having different sizes, such as resilient member 1029a which is smaller than resilient member 1029b. Although the embodiment shown in FIG. 10B shows row 1028 with two alternating sizes of resilient members, in other embodiments, the resilient members may all be the same (or substantially the same) size. Alternatively, in some embodiments, one or more of the rows may include resilient members having more than two different sizes. Similarly, in some embodiments, one or more rows may include resilient members having many different sizes and arranged in a non-uniform pattern.

In the example shown in FIG. 10B, the resilient members in the rows 1022-1028 are aligned with each other. Light rays 1030 and 1032 illustrate how the arrangement of resilient members in the array 1020 operate to block laser light from escaping the interior of the laser CNC machine. For example, laser light traveling along light rays 1030 and 1032 that enters into the curtain 1000 through small gaps between adjacent resilient members in row 1028 is blocked by resilient members in rows 1026 and 1024.

FIG. 10C depicts an overhead view of a portion of example curtain 1000 depicted in FIG. 10A that shows an example alternative arrangement of resilient members configured to block laser light according to some disclosed embodiments. The example curtain 1000 includes an array 1040 of resilient members configured to block laser light according to some disclosed embodiments. The array 1040 illustrated in FIG. 10C is configured differently than the array 1020 illustrated in FIG. 10B.

The array 1040 of resilient members in FIG. 10C is formed from four rows 1042, 1044, 1046, and 1048. The four rows 1042-1048 in FIG. 10C are formed from the curtain layers 1006-1012 shown in FIG. 10A. Each of the four rows 1042-1048 comprises a separate row of resilient members. The bold arrow on the left side of FIG. 10C shows the direction of travel of material that is inserted through the curtain 1000 and into the material passthrough opening 904 (FIG. 9B).

Similar to the example embodiment shown in FIG. 10B, each row of resilient members in the example embodiment shown in FIG. 10C also includes resilient members of at least two different dimensions. For example, row 1048 includes resilient members having different sizes, such as resilient member 1049a which is smaller than resilient member 1049b. Although the embodiment shown in FIG. 10C shows row 1048 with two sizes of resilient members, in other embodiments, the resilient members may all be the same (or substantially the same) size. Alternatively, in some embodiments, one or more of the rows may include resilient members having more than two different sizes.

But in contrast to the example shown in FIG. 10B, in the example shown in FIG. 10C, the resilient members in the rows 1042-1048 are not aligned (i.e., they are staggered) relative to each other. Light rays 1050, 1052, 1054, and 1056 illustrate how the staggered arrangement of resilient members in the array 1040 operates to block laser light from escaping the interior of the laser CNC machine.

For example, laser light traveling along light rays 1050 and 1052 that enters into the curtain 1000 through small gaps between adjacent resilient members in row 1048 is blocked by resilient members in row 1044, and laser light traveling along light rays 1054 and 1056 that enters into the curtain 1000 through small gaps between other adjacent resilient members in row 1048 is blocked by resilient members in row 1046.

iv. Material Bed Configurations to Reduce Laser Reflections

As mentioned above, some embodiments include a material bed that is arranged allow laser light that penetrates the material positioned on the material bed to pass through the material bed and hit the interior floor of the housing of the laser CNC machine rather than reflecting back towards the laser head or elsewhere in the interior space of the laser CNC machine.

FIG. 8A depicts an interior view of an example laser CNC machine with an example material bed 802 disposed therein according to some disclosed embodiments. FIG. 8B depicts the example material bed 802 of FIG. 8A removed from the laser CNC machine.

In some embodiments, the material bed 802 includes (i) a primary portion 830 (FIG. 8B) and (ii) one or more secondary portions 832a, 832b (FIG. 8B).

In the example shown in FIGS. 8A and 8B, the primary portion 830 comprises a honeycomb structure stamped from ferritic stainless steel. The stainless-steel construction helps prevent the material bed 802 from experiencing corrosion. And the ferritic feature enables the material bed 802 to hold some metal materials in place magnetically, for example, by using magnets to hold material securely in place on the material bed 802.

Each of the secondary portions 832a, 832b include (i) a tab structure sufficient to facilitate alignment and placement of the material bed 802 in the bottom of the laser CNC machine, and (ii) bar structures 834a, 834b to facilitate manual removal and replacement of the material bed 802.

In some examples, the honeycomb structure of the material bed 802 is configured to enable at least some laser light that penetrates material positioned on the material bed 802 to pass through the material bed 802 and hit the interior floor of the housing of the laser CNC machine.

Allowing the laser light to continue through the openings of the material bed 802 rather than reflect off of the material bed 802 helps to prevent laser reflections. Laser light that reflects off of the material bed 802 is undesirable because the reflected laser light can, among other things, (i) cause unwanted burning/scoring of the material, (ii) interfere with control systems, such as the distance measurement and focusing systems described with reference to FIG. 5, and/or (iii) pose risk of damage to other components within interior space of the laser CNC machine.

v. Deactivating the Laser Based on Determining that the Head is not Properly Mounted

As mentioned above, some embodiments include (i) determining whether the laser head is properly mounted before and/or during operation of the laser, and (ii) preventing, halting, or otherwise disabling operation of the laser after determining that the head is not properly mounted.

In some embodiments, the laser head can be attached (e.g., magnetically) to a head carrier, sometimes referred to as a carriage. For example, U.S. application Ser. No. 17/511,000, titled “Mechanical System for High Positional Computer Numerically Controlled Applications,” filed on Oct. 26, 2021, and currently pending, describes scenarios where a laser head can be magnetically attached to a carriage. The entire contents of U.S. application Ser. No. 17/511,000 are incorporated herein by reference.

For example, in some implementations, to facilitate correct alignment of the laser head with the carriage for attachment, detachment, re-attachment, etc. of the laser head to the carriage, the carriage includes (i) a set of guide pins, and (ii) a set of guide holes. In some embodiments, one or more of the guide pins comprise magnetic guide pins, and/or one or more of the guide holes comprise magnetic guide holes. In operation, embodiments with magnetic guide pins and/or magnetic guide holes help to guide the laser head into place during attachment and hold the laser head securely in place during operation. In some embodiments, the laser head may be attachable to/detachable from a carriage via attachment/detachment mechanisms different than magnets.

Regardless of the attachment/detachment mechanisms, the laser CNC machine in some embodiments is configured to use one or more of the lid camera (or perhaps another camera inside the laser CNC machine), an accelerometer, and/or one or more sensors to confirm whether the laser head has been properly attached to the carriage or is otherwise appropriately attached and aligned for safe and effective operation. Embodiments where the laser head is fixed rather than attachable/detachable may also use one or more of a camera, accelerometer, or other sensors to determine whether the laser head is properly aligned.

For example, some embodiments include the laser CNC machine using the lid camera to ensure the fiducial on top and/or side (when oriented at 90 degrees) of the laser head is both visible and oriented properly. In operation, data from one or more images obtained via the lid camera can be compared with data from one or more reference images to determine whether the laser head is properly attached and/or aligned.

Some embodiments additionally or alternatively include using an accelerometer to determine whether the laser head is properly attached and/or aligned. Some such embodiments include (i) sending one or more commands to move the laser head and (ii) verifying that the movement associated with the accelerometer is consistent with the movement of the laser head, and verifying that the laser head is oriented correctly after the movement. Some embodiments include using the accelerometer data with one or more images obtained via the lid camera to verify that the movement of the laser head observed via the lid camera is consistent with the movement measured by the accelerometer and/or that the position of the laser head after the movement is consistent with the expected position after movement measured by the accelerometer.

Some embodiments additionally or alternatively include a sensor to determine whether the laser head is properly attached and/or aligned. Some such embodiments include using a hall sensor on the laser head and/or the carriage to detect whether the laser is properly attached and/or aligned.

In some embodiments, the laser CNC machine is configured to deactivate the laser in response to determining that the laser head is not properly attached to the carriage or is otherwise not appropriately aligned for safe and effective operation. In operation, deactivating the laser may include (i) preventing the laser from starting a fabrication job and/or (ii) halting the operation of the laser during execution of a fabrication job.

### F. External Air Filters and Air Filter Pairing

As mentioned earlier, in some embodiments, the laser CNC machine is additionally configured to pair with an external air filter, such as air filter 250 shown in FIG. 2.

i. Example Air Filter Configurations

Existing laser CNC machines are designed to be passively coupled to an exterior filter that does not have any wireless communication and/or intelligence. Typical air filters are attached to a laser CNC machine and configured to run their fan(s) to pull exhaust (e.g., fumes, particulates, etc.) from the connected laser CNC machine regardless of the operating status of the connected laser CNC machine. Similarly, typical laser CNC machines may be operated to cut material, scan designs, and execute other projects with the laser regardless of the operating status of a connected air filter.

In contrast to existing air filter solutions that passively couple to laser CNC machines, some embodiments disclosed herein include using wireless communications (e.g., Bluetooth or other suitable wireless protocols) to communicate and coordinate operations between the laser CNC machine and the air filter. Further, unlike existing laser CNC machines with connected air filters, some embodiments include the laser CNC machine controlling the operation of the air filter, including causing the connected air filter to operate its fan(s) based on when the laser CNC machine is operating the laser rather than the air filter operating its fan(s) upon being powered on with regard to whether the connected laser CNC machine is operating its laser or not. Some embodiments include the laser CNC machine causing the connected air filter to operate its fan(s) at different speeds based on the type of material (e.g., wood, vinyl, paper, etc.) that is being machined rather than the air filter operating its fan(s) at a fixed speed regardless of the material being machined. Some embodiments include the laser CNC machine causing the connected air filter to operate its fan(s) at different speeds based on the amount of material (dust, exhaust, etc.) in the interior of the laser CNC machine detected by the laser CNC machine rather than the air filter operating its fan(s) at a fixed speed regardless of amount of material detected by the laser CNC machine. Some embodiments include the laser CNC machine causing the connected air filter to operate its fan(s) at different speeds to achieve a target flow rate based on an indication of how full the filter is rather than the air filter operating its fan(s) at a fixed speed regardless of the flow rate.

Thus, in some embodiments, the external air filter is configured to (i) communicate with the laser CNC machine and to be aware of the laser CNC machine's operating state, (ii) evaluate when to start the blower/filtration functionality (either on its own or in cooperation with the connected laser CNC machine), (iii) provide information to the laser CNC machine and/or other control devices regarding the operational status of the air filter (e.g., filter/cartridge capacity, etc.), and/or (iv) receive instructions from the laser CNC machine to modify operations.

In addition to interfacing the laser CNC machine, the air filter is also manageable via the same controller devices (e.g., controllers 210a-c shown in FIG. 2) and control systems as the laser CNC machine.

In some embodiments, the air filter includes one or more network interfaces (e.g., Bluetooth, Bluetooth Low Energy or other suitable wireless interface), at least one fan, one or more processors, and tangible, non-transitory computer-readable media storing program instructions executable by the one or more processors to cause the air filter to perform the air filter features and functions disclosed and described herein. In some embodiments, the air filter may include one or more (or all) of the components of the computing system shown and described previously with reference to FIG. 13.

In some embodiments, the air filter includes an exhaust hose that connects to an exhaust port of the laser CNC machine, such as exhaust port 676 (FIG. 6C). In some embodiments, the air filter includes (i) one or more pressure sensors before/after an internal filter configured to measure pressure drop across the internal filter; (ii) one or more flow rate detectors configured to determine the flow rate; and/or (iii) one or more amperage sensors configured to measure current draw from a fan within the air filter.

Other features of some example air filter embodiments include one or more (or all) of: (i) one or more LED lights to indicate power on/off state, fan activation state, filter status, paired status, and/or other operational information, (ii) one or more switches for powering the air filter on/off, initiating a pairing procedure, initiating an unpairing procedure, and/or other actions, (iii) a quiet-running fan, such as a fan configured to generate less than about a 64 dBa noise level, (iv) a power supply configured to operate at between 110-240 volts at 50-60 Hz and draw less than about 2 amps of power, and/or (v) one or more alarm indications, such as a cartridge/filter “full” alarm once the air filter is no longer able to adequately extract at least a minimum threshold volume of air per unit of time. In some embodiments, the at least one fan is configured to move at least 30 cubic feet per minute of air under normal operational conditions. In some embodiments, the filter is configured to provide about 100 hours of use when the laser CNC machine is processing acrylic and/or about 25-50 hours of use when the laser CNC machine is processing wood and wood-based products.

In some examples, the laser CNC machine is configured to pair with the external air filter via a pairing protocol that includes, among other aspects, the laser CNC machine transmitting an air pressure sequence via an exhaust port connected to the external air filter. For example, FIG. 6A shows an exhaust vent 612 on the rear interior wall of the laser CNC machine. The exhaust vent 612 on the rear interior wall of the laser CNC machine leads to an exhaust compartment 664 (FIG. 6C) that includes an exhaust module 674 (FIG. 6C) including an exhaust fan that moves air through an exhaust port 676 (FIG. 6C) on the rear of the laser CNC machine.

The exhaust module 674 includes an internal exhaust fan that is configured to transmit the air pressure sequence to the external air filter via the exhaust port 676. The internal exhaust fan in the exhaust module 674 pulls air from the interior space of the laser CNC machine (e.g., through the exhaust vent 612) and to the rear exhaust port 676 that can be connected to the external air filter. As described previously with reference to FIG. 6C, the path within the housing from the exhaust vent 612 and the rear exhaust port 676 is sealed off from other compartments (e.g., control compartment 660 and power compartment 662) in the housing of the laser CNC machine (e.g., a compartment housing a power supply for the laser CNC machine, a compartment housing processors and memory for controlling the operation of the laser CNC machine, and/or other compartments) via interior barriers 668a and 668b to avoid exposing the components within those other compartments to contaminated air.

In some examples, the air pressure sequence includes an exhaust fan at the laser CNC machine turning on and off, and/or perhaps blowing air at high and/or low velocities in a pattern that is detectable by an air flow sensor at the external air filter. In operation, using such an air pressure sequence signaling scheme allows the laser CNC machine and the external air filter to confirm, among other states, that (i) the external air filter is properly connected to the laser CNC machine, and/or (ii) the pairing is occurring between a laser CNC machine and an external air filter that are physically connected to each other.

ii. Example Methods Performed by an Air Filter

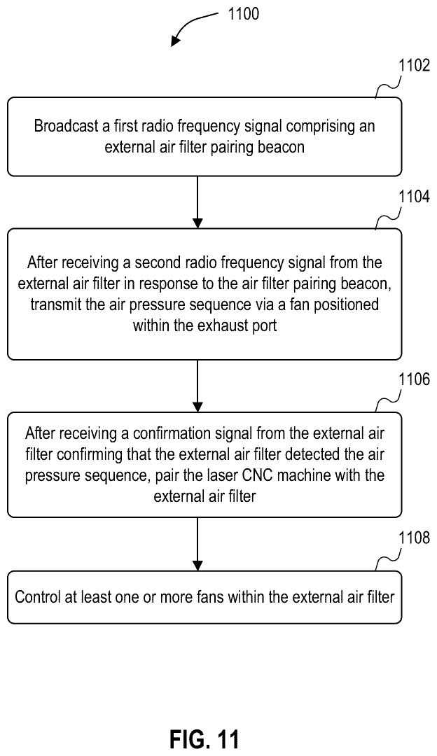

FIG. 11 depicts aspects of an example method 1100 performed by a laser CNC machine for pairing the laser CNC machine with an external air filter according to some disclosed embodiments. The method 1100 may be performed by any of the laser CNC machine embodiments disclosed and described herein and/or variants thereof.

Method 1100 begins at block 1102, which includes the laser CNC machine broadcasting a first radio frequency (RF) signal comprising an air filter query message, also sometimes known as a pairing beacon. The paring beacon indicates that the laser CNC machine is searching for an air filter to pair with. In some embodiments, the laser CNC machine broadcasts the first RF signal after (or perhaps in response to) receiving a user input to initiate the air filter pairing procedure. In other embodiments, the laser CNC machine broadcasts the first RF signal after being powered on and determining that it is not yet paired with an air filter.

In some embodiments, the first RF signal comprises a Bluetooth signal. However, in operation, the first RF signal may be any type of wireless signal suitable for broadcasting a short range (e.g., within less than about 10-15 feet) query message/beacon that can be detected by nearby external air filters.

In some embodiments, the query message includes, among other data, an identification of the laser CNC machine that transmitted the query and perhaps also a message type indication (e.g., indicating that the query message is a pairing beacon). The identification may be and/or at least include a network address of the laser CNC machine, such as a MAC address, Bluetooth address, WiFi/Ethernet address, or other identification of the laser CNC machine. In some embodiments, the query message may include one or more (or all) of (i) a public key for use by an air filter when exchanging encrypted messages with the laser CNC machine, (ii) a wireless protocol, wireless channel to use for communicating with the laser CNC machine, (iii) a network identifier (e.g., an SSID or similar) via which an air filter can communicate with the laser CNC machine. In some embodiments, an air filter that receives the query message that includes the network address can use the network address to respond to the laser CNC machine that broadcasted the pairing beacon/query message.

For example, an air filter that receives the broadcasted query message can use the network address of the laser CNC machine (and the public key, wireless channels, and so on) to transmit a second RF message to the laser CNC machine in response to the query. The second RF message may include, among other information, an identification of the air filter. In some embodiments, the data identifying the air filter may be a unique identifier that is specific to the air filter, a temporary identifier unique to a pairing session, or a combination of the unique and temporary identifiers.

Next, method 1100 advances to block 1104, which includes, after receiving a second RF signal from an air filter in response to the air filter query message broadcasted by the laser CNC machine, the laser CNC machine transmitting an air pressure sequence via a fan positioned within the exhaust port of the laser CNC machine. The air pressure sequence in some examples includes a series of air pressure pulses within a time interval. In some instances, the laser CNC may repeat the air pressure sequence on a regular basis for a period of time. In operation, transmitting the series of air pressure pulses includes turning the fan on and off (to increase and decrease the air pressure) in a particular pattern that can be detected by an air pressure sensor in the air filter.

Some embodiments of method 1100 may additionally include, after receiving the second RF signal from the air filter in response to the air filter query message, the laser CNC machine transmitting a third RF message to the air filter that transmitted the second RF message to the laser CNC machine. In some embodiments, the third RF message includes information describing the air pressure sequence. Transmitting information describing the air pressure sequence to the air filter that transmitted the second RF message to the laser CNC machine enables that particular air filter to confirm whether it is connected to the same laser CNC machine from which it is receiving the air pressure sequence. However, in other embodiments, the laser CNC machine need not send information describing the air pressure sequence, and instead, may just transmit the air pressure sequence.

In some embodiments, after method block 1104, but before method block 1106, method 1100 additionally includes the laser CNC machine sending a message to the air filter indicating that the laser CNC machine is about to send the air pressure sequence. However, this additional notification is not required in all embodiments.

Next, method 1100 advances to block 1106, which includes after receiving a confirmation signal from the air filter confirming that the air filter detected the air pressure sequence, pairing the laser CNC machine with the air filter.

In some embodiments where the laser CNC machine does not send information describing the air pressure sequence and instead just transmits the air pressure sequence, the confirmation signal may include a description of the air pressure sequence that the air filter detected. In such embodiments, the laser CNC machine can determine whether the air filter from which it received the description of the air pressure sequence is properly connected to the laser CNC machine based on whether the description of the air pressure sequence received from the air filter is consistent with the air pressure sequence that the laser CNC machine transmitted at method block 1104.

In some embodiments, the laser CNC machine does not send information describing the air pressure sequence. Instead, the air filter is configured in advance to search for a particular air pressure sequence based on the identification of the laser CNC machine it is pairing with. For example, air pressure sequences could be based on the vendor of the laser CNC machine, which may be known in advance or determined via the air filter query message that is broadcast from the laser CNC machine.

In some embodiments, pairing the laser CNC machine with the air filter includes establishing a secure wireless communication channel between the laser CNC machine and the air filter. In some embodiments, pairing the laser CNC machine with the air filter additionally or alternatively includes the laser CNC machine and the air filter exchanging information that enables the laser CNC machine to control the operation of the air filter.

Next, method 1100 advances to block 1108, which includes the laser CNC machine controlling one or more fans within the air filter.

In some embodiments, the laser CNC machine controlling at least one or more fans within the air filter includes the laser CNC machine causing the at least one or more fans to operate while the laser CNC machine is actively using the laser to machine material that has been positioned within the laser CNC machine.

In some embodiments, the laser CNC machine controlling at least one or more fans within the air filter includes the laser CNC machine causing the at least one or more fans to operate at different speeds based on the type of material being machined by the laser CNC machine. For example, a first type of material (acrylic) may generate less fumes than a second type of material (wood). As a result, it can be advantageous to operate the fan(s) of the air filter at a higher speed (to remove more fumes from the laser CNC machine) when the laser CNC machine is machining the second type of material (e.g., wood) as compared to when the laser CNC machine is machining the first type of material (acrylic). In another example, a first type of material (paper) may move more as a result of the fan than a second type of material (wood), and it may be desirable for the fan speed to be lower when paper is being machined compared to wood or other material.

In some embodiments, the laser CNC machine controlling at least one or more fans within the air filter additionally or alternatively includes the laser CNC machine causing the at least one or more fans to operate in response to a temperature level exceeding a threshold temperature level based on one or more temperature measurements from one or more temperature sensors (e.g., a temperature sensor in the lid camera assembly, a temperature sensor in the exhaust port, or a temperature sensor elsewhere in the interior of the laser CNC machine).

For example, in some embodiments, the laser CNC machine controlling the at least one or more fans within the air filter at block 1108 includes the laser CNC machine causing the at least one or more fans to operate in response to determining that a temperature level measured by one or more temperature sensors has exceed a threshold temperature level for some duration of time.

In some embodiments, the laser CNC machine controlling the at least one or more fans at block 1108 includes the laser CNC machine controlling the at least one or more fans based on a target flow rate (e.g., flow meter, current draw on CNC fan, etc.). For example, in embodiments where a target air flow is required or at least desired, the air flow is monitored (e.g., via a flow meter, current draw on a fan, and so on), and the speed of the fans is controlled to achieve the target air flow.

In some embodiments, the laser CNC machine controlling the at least one or more fans at block 1108 includes the laser CNC machine controlling the at least one or more fans based on information received by the laser CNC machine (e.g., a message received from the air filter or other controller device). For example, the air filter may tell the laser CNC machine that the air filter is getting full, and the laser CNC machine may in turn instruct the air filter to increase its fan speed to get the same flow rate of exhaust from the laser CNC machine to the air filter to help offset any reduction in airflow that might be caused by the nearly full air filter.

In still further embodiments, the laser CNC machine controlling the at least one or more fans at block 1108 includes the laser CNC machine: (i) determining a desired operation for the fan (e.g. increase/decrease fan speed (e.g., increase PWM), set fan speed (e.g., set PWM), start/stop fan, set fan timer, set desired pressure drop across fan, etc.); (ii) sending a message to the air filter that includes an indication of the desired operation; and (iii) in some instances, optionally verifying that the desired operation has been implemented by the air filter (e.g., by comparing before/after measurements, etc.).

iii. Example Methods Performed by an Air Filter

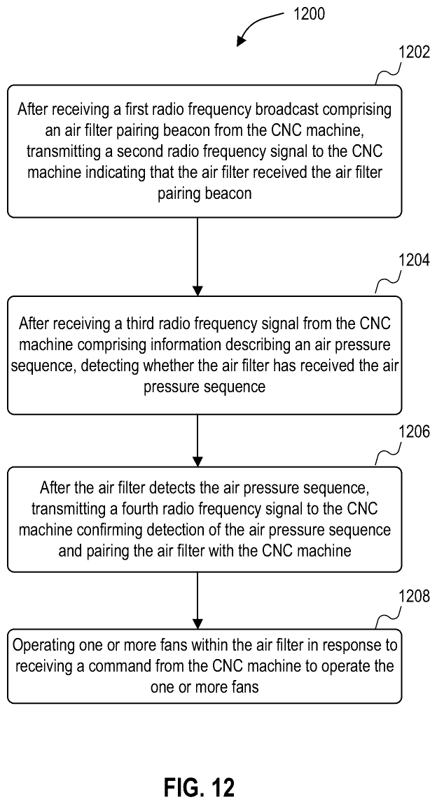

FIG. 12 depicts aspects of an example method 1200 performed by an external air filter for pairing a laser CNC machine with the external air filter according to some disclosed embodiments. In operation, method 1200 is similar to method 1100 (FIG. 11) but from the perspective of the air filter rather than the laser CNC machine. Method 1200 may be performed by any of the air filter embodiments disclosed and described herein and variants thereof.

Method 1200 begins at block 1202, which includes, after the air filter has received a first RF broadcast comprising an air filter query message (e.g., the pairing beacon described above with reference to method 1100) from a CNC machine, the air filter transmitting a second RF signal to the laser CNC machine indicating that the air filter received the air filter query message.

As mentioned previously with reference to method 1100, in some embodiments, the pairing beacon comprises a Bluetooth signal or any other type of wireless signal suitable for broadcasting a short range (e.g., within less than about 10-15 feet) pairing beacon that can be detected by nearby external air filters. In some embodiments, the pairing beacon includes, among other data, an identification of the laser CNC machine that transmitted the pairing beacon and perhaps also a message type indication (e.g., indicating that the message is a pairing beacon). The identification may be and/or at least include a network address of the laser CNC machine that broadcasted the pairing beacon, and in some embodiments, may also include a public key for use by the air filter when exchanging encrypted messages with the laser CNC machine that broadcasted the pairing beacon. In operation, after the air filter has received a pairing beacon that includes the network address (and public key, if applicable), the air filter can use the network address (and the public key, if applicable) to respond to the laser CNC machine that broadcasted the pairing beacon.

In some embodiments, block 1202 additionally includes the air filter listening for the first RF broadcast comprising the air filter query message from the laser CNC machine. In some embodiments, the air filter starts listening for the first RF broadcast after (or perhaps in response to) being powered on. In some embodiments, the air filter starts listening for the first RF broadcast after (or perhaps in response to) being powered on and determining that it is not already paired with a laser CNC machine. In some embodiments, the air filter starts listening for the first RF broadcast after (or perhaps in response to) receiving a user input to start the pairing procedure.

Next, method 1200 advances to block 1204, which includes, after the air filter has received a third RF signal from the laser CNC machine comprising information describing an air pressure sequence, the air filter detecting whether the air filter has received the air pressure sequence from the laser CNC machine.

In some embodiments, block 1204 is optional. For example, rather than receiving the third RF signal from the laser CNC machine comprising information describing the air pressure sequence, in some embodiments, the CNC machine may transmit the air pressure sequence without first informing the air filter about what the air pressure sequence will be. In other embodiments, the CNC machine may transmit the air pressure sequence with the first broadcast message. In other embodiments, the air pressure sequence may be determined by the air filter based on an identification of the CNC machine using a lookup table (e.g., stored locally or on a remote network connected device). As described with reference to method 1100, the air pressure sequence includes a series of air pressure pulses within a time interval. In some instances, the laser CNC machine may repeat the pressure sequence on a regular basis for a period of time. In operation, transmitting the series of air pressure pulses includes turning the fan on and off (to increase and decrease the air pressure) in a particular pattern that can be detected by an air pressure sensor in the air filter.

In some embodiments, block 1204 includes the air filter entering into an “air pressure detection” mode during which it waits to detect the air pressure sequence via one or more air pressure and/or air flow sensors. In some embodiments, the air filter includes air pressure sensors configured to detect the air pressure sequence. In other embodiments, the air filter may include other types of sensors that are configured to detect other stimuli that indicate changes in air pressure. In some embodiments, the air filter enters into an “air pressure detection” mode in block 1202.

Next, method 1200 advances to block 1206, which includes, after the air filter detects the air pressure sequence, the air filter (i) transmitting a fourth RF signal to the laser CNC machine confirming detection of the air pressure sequence, and (ii) pairing the air filter with the laser CNC machine. In some embodiments, pairing the air filter with the laser CNC machine includes establishing a wireless communication session between the laser CNC machine and the air filter via which the laser CNC machine and the air filter can exchange command and control data.

In embodiments where the laser CNC machine transmits the air pressure sequence without first informing the air filter about what the sequence will be, the method block 1206 step of transmitting the fourth RF signal to the laser CNC machine confirming detection of the air pressure sequence may include the air filter transmitting an indication of the detected air pressure sequence to the laser CNC machine. When the air filter transmits information describing the detected air pressure sequence to the laser CNC machine, the laser CNC machine can confirm that the air filter that detected the air pressure sequence is the air filter that is physically connected to the laser CNC machine (rather than a different air filter that is not connected to the laser CNC machine).

Next, method 1200 advances to block 1208, which includes operating one or more fans within the air filter in response to receiving a command from the laser CNC machine to operate the one or more fans. In operation, operating the one or more fans in response to one or more commands received from the laser CNC machine includes, for example, the air filter one or more (or all) of (i) activating the one or more fans while the laser CNC machine is actively using the laser to machine some material within the laser CNC machine, (ii) pausing the one or more fans while the laser CNC machine is not actively using the laser to machine some material within the laser CNC machine, (iii) operating the one or more fans at different fan speeds based on the type of material that is being machined by the laser CNC machine, and/or (iv) operating the one or more fans based on temperature levels measured within the laser CNC machine.

In some embodiments, operating the one or more fans in response to one or more commands received from the laser CNC machine at block 1208 includes the air filter operating the one or more fans based on a target flow rate (e.g., flow meter, current draw on CNC fan, etc.). For example, in embodiments where a target air flow is required or at least desired, the air flow is monitored (e.g., via a flow meter, current draw on a fan, and so on), and the speed of the fans is controlled to achieve the target air flow.

In some embodiments, operating the one or more fans in response to one or more commands received from the laser CNC machine at block 1208 includes the air filter operating the one or more fans based on one or more commands received from the laser CNC machine after the air filter has provided operational and/or status data to the laser CNC machine. For example, the air filter may tell the laser CNC machine that the air filter is getting full, and the laser CNC machine may in turn instruct the air filter to increase its fan speed to get the same flow rate of exhaust from the laser CNC machine to the air filter to help offset any reduction in airflow that might be caused by the nearly full air filter.

Some embodiments of method 1200 may additionally include, when the air filter has failed to detect the air pressure sequence, the air filter transmitting a radio frequency signal to the CNC machine indicating that the air filter did not detect the air pressure sequence. In some embodiments, informing the laser CNC machine that the air filter failed to detect the air pressure signal causes the laser CNC machine to at least one of (i) retransmit the air pressure sequence and/or (ii) restart the pairing procedure. In some embodiments, the laser CNC machine and/or the air filter, individually or in combination, may additionally or alternatively provide one or more indications to a user to verify that the laser CNC machine is properly connected to the air filter. For example, the laser CNC machine and/or the air filter may instruct the user to verify that a hose connecting the laser CNC machine to the air filter is properly attached to both the laser CNC machine and the air filter.

### CONCLUSIONS

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random-access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A computer numerically controlled (CNC) machine comprising:
a laser head comprising a laser;
a housing defining an interior space of the CNC machine, wherein the interior space of the CNC machine is bounded by an interior floor, interior walls, and an openable lid, wherein the openable lid comprises a lid camera assembly comprising a camera arranged to capture images of the interior space of the CNC machine;
a material bed positioned above the interior floor and configured to support material placed within the interior space of the CNC machine;
a first material passthrough opening in the housing positioned on a first side of the housing, wherein the first material passthrough opening comprises a curtain, wherein the curtain is arranged to block laser light from exiting through the first material passthrough opening while material is inserted through the first material passthrough opening; and
an exhaust port configured to route fumes from within the interior space of the CNC machine to an air filter separate from the CNC machine.

2. The CNC machine of claim 1, wherein the laser head comprises:
a laser enclosure housing the laser, wherein the laser enclosure comprises a laser enclosure top, a laser enclosure bottom, and four laser enclosure sides; and
a fan enclosure housing a fan, wherein the fan enclosure is positioned on top of the laser enclosure top, wherein the fan enclosure comprises one or more side openings, and wherein the fan is configured to draw air from the one or more side openings and blow the air downward through the laser enclosure top and into the laser enclosure.

3. The CNC machine of claim 2, wherein at least one of (i) the fan enclosure comprises a solid top, wherein the solid top comprises one or more fiducial markers sufficient for use with computer vision techniques or (ii) the laser head further comprises:
a solid plate on top of the fan enclosure, wherein the solid plate comprises one or more fiducial markers sufficient for use with computer vision techniques.

4. The CNC machine of claim 2, wherein the laser head further comprises:
a circuit board, wherein a first laser enclosure side comprises an opening arranged to receive a cable providing power and control signaling to the circuit board.

5. The CNC machine of claim 4, wherein the cable providing power and control signaling to the circuit board of the laser head comprises a flat flexible cable comprising a metallic outer cover covering at least a portion of the flat flexible cable, and wherein at least a portion of the flat flexible cable is configured to magnetically attach to a magnetic surface on one interior wall of the housing when the laser head moves towards the one interior wall and magnetically detach from the magnetic surface when the laser head moves away from the one interior wall.

6. The CNC machine of claim 2, wherein the laser comprises a laser operating at a wavelength between approximately 400 nm and 500 nm.

7. The CNC machine of claim 2, wherein the laser head further comprises:
a focusing lens positioned between the laser and a material to be machined by the CNC machine;
one or more depth sensors configured to determine a distance between the one or more depth sensors and the material to be machined by the CNC machine; and
a motor configured to move the focusing lens in a manner sufficient to focus laser light emitted from the laser onto the material to be machined by the CNC machine based at least in part on the distance determined by the one or more depth sensors.

8. The CNC machine of claim 2, wherein the laser head further comprises:
a camera arranged to capture images of material placed within the interior space of the CNC machine.

9. The CNC machine of claim 1, wherein the CNC machine is configured to determine whether the openable lid is properly closed based on one or more of:
one or more images of one or more interior wall fiducials captured by the camera of the lid camera assembly, wherein at least one interior wall of the housing comprises the one or more interior wall fiducials;
one or more measurements from one or more hall sensors on the housing, wherein the one or more hall sensors are arranged to detect one or more corresponding magnets on the openable lid;
one or more accelerometer measurements from a three-axis accelerometer within the lid camera assembly; and
wherein the CNC machine is configured to deactivate the laser in response to determining that the openable lid is not properly closed.

10. The CNC machine of claim 1, wherein the openable lid comprises:
a top portion and a side portion extending downward from the top portion, and wherein when the openable lid is closed, the side portion joins at least a portion of one side of the housing to form the interior space of the CNC machine; and
a transparent material that both (i) passes visible light, thereby allowing a user to see inside the interior space of the CNC machine while the openable lid is closed, and (ii) blocks laser light emitted from the laser.

11. The CNC machine of claim 1, wherein the lid camera assembly comprising the camera further comprises:
one or more visible light emitting diodes (LEDs) arranged behind a diffuser, wherein the one or more visible LEDs are configured to emit visible light and illuminate the interior space of the CNC machine; and
one or more infrared sensors outside of the diffuser and configured to detect flames within the interior space of the CNC machine.

12. The CNC machine of claim 11, wherein the one or more visible LEDs are configured to operate in one or more lighting modes comprising one or more of:
a normal intensity mode when the openable lid is closed during operation of the laser; and
a low intensity mode when one or both of (i) the openable lid is opened or (ii) the CNC machine has entered a sleep mode.

13. The CNC machine of claim 1, wherein the lid camera assembly comprising the camera further comprises:
one or more ultraviolet light emitting diodes (UV LEDs) configured to emit ultraviolet light and illuminate UV-printed information on materials placed within the interior space of the CNC machine.

14. The CNC machine of claim 1, wherein:
the lid camera assembly comprising the camera further comprises at least one of (i) one or more temperature sensors, and (ii) one or more light sensors; and
wherein the lid camera assembly is connected to a main processor board of the CNC machine via a flat flex cable assembly incorporated into the openable lid of the CNC machine.

15. The CNC machine of claim 1, wherein the material bed comprises a primary portion and at least one secondary portion, wherein the primary portion comprises a honeycomb structure stamped from ferritic stainless steel, wherein the secondary portion comprises a tab structure sufficient to facilitate manual removal and replacement of the material bed, and wherein the honeycomb structure of the material bed is configured to enable at least some laser light that penetrates material positioned on the material bed to pass through the material bed and hit the interior floor of the housing of the CNC machine.

16. The CNC machine of claim 1, wherein the curtain comprises a first array of resilient elements.

17. The CNC machine of claim 16, wherein the first array of resilient elements comprises a first plurality of rows of silicone fingers, wherein the silicone fingers in one row of the first plurality of rows are staggered relative to the silicone fingers in an adjacent row of the first plurality of rows.

18. The CNC machine of claim 16, wherein the housing comprises a second material passthrough opening in the housing positioned on a second side of the housing opposite the first side of the housing, wherein the second material passthrough opening comprises a curtain, wherein the curtain is arranged to block laser light from exiting through the second material passthrough opening while material is inserted through the second material passthrough opening.

19. The CNC machine of claim 18, wherein the housing further comprises:
a first door on the first side of the housing that is openable to reveal the first material passthrough opening; and
a second door on the second side of the housing that is openable to reveal the second material passthrough opening.

20. The CNC machine of claim 1, wherein the CNC machine is configured to pair with the air filter via a pairing protocol, wherein the pairing protocol comprises the CNC machine:
(i) transmitting a first radio frequency signal comprising an air filter query message;
(ii) after receiving a second radio frequency signal from the air filter in response to the air filter query message, transmitting a third radio frequency signal to the air filter comprising information describing an air pressure sequence;
(iii) transmitting the air pressure sequence via a fan positioned within the exhaust port; and
(iv) after receiving a fourth radio frequency signal from the air filter confirming that the air filter detected the air pressure sequence, pairing the CNC machine with the air filter; and
wherein after the CNC machine is paired with the air filter, the CNC machine is configured to control operation of the air filter, wherein controlling operation of the air filter comprises:
operating one or more fans within the air filter while the laser of the CNC machine is applying laser energy to material within the interior of the CNC machine.
